(19) United States
(12) Patent Application Publication
(10) Pub. No.: US 2017/0023482 A1
(43) Pub. Date: Jan. 26, 2017

(54) SIMULTANEOUS PLURAL COLOR BROADBAND COHERENT ANTI-STOKES RAMAN SCATTERING MICROSCOPE AND IMAGING

(71) Applicant: UNITED STATES OF AMERICA, AS REPRESENTED BY THE SECRETARY OF COMMERCE, Gaithersburg, MD (US)

(72) Inventors: MARCUS T. CICERONE, FREDERICK, MD (US); CHARLES H. CAMP, JR., BETHESDA, MD (US)

(21) Appl. No.: 15/206,965

(22) Filed: Jul. 11, 2016

Related U.S. Application Data
(60) Provisional application No. 62/194,360, filed on Jul. 20, 2015.

(51) Int. Cl. G01N 21/65; G01N 21/27; G02B 21/26; G02B 21/36; G02B 21/00; G02B 21/06

(52) U.S. Cl. CPC G01N 21/65; G02B 21/0004; G02B 21/06; G02B 21/26; G02B 21/365; G01N 21/27; G01N 2021/655; G01N 2201/068; G01N 2201/06113; G01N 2201/0636

(57) ABSTRACT

A plural color broadband coherent anti-Stokes Raman scattering (CARS) microscope includes: a first light source to produce a first light including a narrowband radiation; a second light source to produce a second light including a broadband radiation; a third light source to: receive the first light from the first light source; receive the second light from the second light source; and produce a third light comprising the narrowband radiation and the broadband radiation by combining the first light and the second light such that the first light and second light are spatially overlapped and temporally overlapped; and a primary objective to: receive the third light from the third light source; communicate the third light to a sample; and subject the sample to simultaneous interpulse CARS stimulation and intrapulse CARS stimulation by irradiation with the narrowband radiation and the broadband radiation in the third light.

### CROSS REFERENCE TO RELATED APPLICATIONS

This application claims the benefit of U.S. Provisional Patent Application Ser. No. 62/194,360, filed Jul. 20, 2015, the disclosure of which is incorporated herein by reference in its entirety.

### STATEMENT REGARDING FEDERALLY SPONSORED RESEARCH

This invention was made with United States Government support from the National Institute of Standards and Technology. The Government has certain rights in the invention.

### BRIEF DESCRIPTION

Disclosed is a plural color broadband coherent anti-Stokes Raman scattering (CARS) microscope comprising: a first light source to produce a first light comprising a narrowband radiation; a second light source to produce a second light comprising a broadband radiation; a third light source to: receive the first light from the first light source; receive the second light from the second light source; and produce a third light comprising the narrowband radiation and the broadband radiation by combining the first light and the second light such that the first light and second light are spatially overlapped and temporally overlapped; and a primary objective to: receive the third light from the third light source; communicate the third light to a sample; and subject the sample to simultaneous interpulse CARS stimulation and intrapulse CARS stimulation by irradiation with the narrowband radiation and the broadband radiation in the third light.

Also disclosed is a process for performing plural color broadband coherent anti-Stokes Raman scattering (CARS) microscopy, the process comprising: producing, by a first light source, a first light comprising a narrowband radiation; producing, by a second light source, a second light comprising a broadband radiation; receiving, by a third light source: the first light from the first light source; and the second light from the second light source; combining, by a third light source, the first light and the second light such that the first light and second light are spatially overlapped and temporally overlapped to produce a third light comprising the narrowband radiation and the broadband radiation; and communicating the third light to a sample; subjecting the sample to the third light; producing, by the sample, a fourth light in response to simultaneous interpulse CARS stimulation and intrapulse CARS stimulation by irradiation with the narrowband radiation and the broadband radiation in the third light; and acquiring the fourth light to perform plural color broadband CARS microscopy.

### BRIEF DESCRIPTION OF THE DRAWINGS

The following descriptions should not be considered limiting in any way. With reference to the accompanying drawings, like elements are numbered alike.

FIG. 1 shows a plural color broadband coherent anti-Stokes Raman scattering (CARS) microscope in two geometries: transmissive and reflective;

FIG. 2 shows a graph of intensity versus wavelength for a first light, second light, and fourth light of a plural color broadband (CARS) microscope;

FIG. 3 shows a plural color broadband CARS microscope;

FIG. 4 shows an energy diagram for interpulse CARS stimulation and an energy diagram for intrapulse CARS stimulation;

FIG. 5 shows a graph of BCARS intensity versus frequency; for 99% glycerol at 3.5 millisecond (ms) exposure;

FIG. 6 shows a graph of intensity versus frequency for a Raman spectrum of 99% glycerol produced by subjecting data shown in FIG. 5 to a Kramers-Kronig transform;

FIG. 7 shows a graph of intensity versus concentration for a sample of methanol, wherein a linear dependence of the retrieved Raman spectrum on methanol concentration showed a detection limit of <8 millimole per liter (mmol l⁻¹) using the 2,839 wavenumber (cm⁻¹) peak and <28 mmol l⁻¹ using the 1,037 cm⁻¹ peak with error bars at ±1 standard deviations;

FIG. 8 shows a simulated effect of second light bandwidth on non-resonant background (NRB) generation with a narrowband first light, wherein panel a shows a normalized BCARS spectrum from a nonresonant material with interpulse and intrapulse excitation mechanisms with varying broadband radiation bandwidth and fixed average power; panel b shows resonant component signal from intrapulse excitation; panel c shows a resonant component signal from interpulse excitation; panel d shows BCARS signal frequency response for intrapulse excitation; panel e shows BCARS signal frequency response for interpulse excitation; panel f shows NRB-to-resonant signal component ratio; and panel g shows integrated total signal;

FIG. 9 shows an experimentally measured effect of second light bandwidth on NRB generation, wherein panel a shows a BCARS spectrum of glass slide (primarily NRB) with different second light bandwidths; panel B shows BCARS intensity as a function of second light bandwidth for intrapulse excitation; panel C shows BCARS intensity as a function of second light bandwidth for interpulse excitation; and penalty shows integrated spectral intensity as a function of second light bandwidth, wherein in panels b-d error bars show ±1 standard deviation;

FIG. 10 shows simulated CARS signal generation with first light and second light of equal bandwidths, wherein panel a shows total integrated CARS signal as a function of first light and second light bandwidths, and panel B shows evolution of nonresonant-to-resonant signal component ratio with increasing first light and second light bandwidths;

FIG. 11 shows a signal-to-noise ratio (SNR) improvement with increasing NRB, wherein panel a shows SNR evolution as a function of nonresonant-to-resonant contribution ratio with a low-noise detector (NR=5), and panel b shows same for a high-noise detector (NR=100);

FIG. 12 shows NRB heterodyne amplification of signal spectrum, wherein panel a shows SNR evolution as a function of nonresonant-to-resonant contribution ratio with a high-noise detector (NR=100) with red, green, and blue circles denoting operational conditions for the simulations presented in graphs shows in panels b, c, and d, respectively; panel b shows simulated spectra with |χ_{NR}|/|χ_{R}|≈0, SNR≈0.25; panel c shows simulated spectra with |χ_{NR}|/|χ_{R}|≈8.1, SNR≈2; and panel d shows simulated spectra with |χ_{NR}|/|χ_{R}|≈100, SNR≈4.9;

FIG. 13 shows spontaneous and coherent Raman fingerprint spectra of glycerol for a spontaneous Raman spectrum of 99% glycerol with 3.5 s (blue, top panel) and 200 ms (middle panel, red) integration times, wherein retrieved Raman spectrum using BCARS with 3.5 ms integration time is shown in bottom panel in black;

FIG. 14 shows spontaneous and coherent Raman CH-/OH-stretch spectra of glycerol for a spontaneous Raman spectrum of 99% glycerol with 3.5 s (blue, top panel) and 200 ms (middle panel, red) integration times, wherein retrieved Raman spectrum using BCARS with 3.5 ms integration time is shown in bottom panel in black;

FIG. 15 shows SNR of spontaneous and coherent Raman spectra of glycerol for SNR calculated from 100 spontaneous Raman spectrum of 99% glycerol with 3.5 s (blue, top panel) and 200 ms (middle panel, red) integration times and SNR from 100 retrieved Raman spectra using BCARS with 3.5 ms integration time (bottom panel, black);

FIG. 16 shows results for coherent Raman imaging (CRI), wherein panel a shows a spectral image of a portal triad within murine liver tissue with the nuclei in blue, collagen in orange and protein content in green (A, portal artery; B, bile duct; V, portal vein; Ep, epithelial cell; En, endothelial cell); panel b shows an SHG image highlighting fibrous collagen network; panel c shows an SHG spectrum for a single pixel; panels d-f show spectral images of individual vibrational modes represented by the color channels at 785 cm⁻¹ (panel d); 855 cm⁻¹ (panel e); 1,004 cm⁻¹ (panel f); panel g shows single-pixel spectra from the nucleus (DNA), collagen fiber, arterial wall and a lipid droplet; and panels h-l show additional spectral channels that provide histochemical contrast: 1,302 cm⁻¹ (panel h); 1,665 cm⁻¹ (panel i); 2,884 cm⁻¹ (panel j); 3,228 cm⁻¹ (panel k); elastin (panel l), 1,126 and 1,030 cm⁻¹ but not 677, 817 and 1,302 cm⁻¹, wherein scale bars are 20 μm;

FIG. 17 shows three-dimensional CRI of murine pancreatic ducts, wherein panel a shows a pseudocolor image taken from a single plane of z-stack image collection of exocrine ducts, with nuclei (785 cm⁻¹) highlighted in blue, collagen (855 cm⁻¹) in red and a composite of lipids and proteins in green (1,665 cm⁻¹) (wherein D, exocrine duct; A, acinar cell; Ep, epithelial cell), and two axial planes are also shown to provide histochemical depth information; panel b shows three-dimensional reconstruction of pancreatic ducts from ten z-stack images; and panel c shows single-pixel spectra taken from within an epithelial cell nucleus, within the fibrous collagen and from within the cytosol of an acinar cell, wherein scale bar is 20 μm;

FIG. 18 shows histopathology using broadband CRT, wherein panel a shows a brightfield image of xenograft glioblastoma in mouse brain, with the tumor hard boundary outlined (black, dashed line), wherein the cyan dashed box indicates a region of interest (ROI) with scale bar of 2 mm; panel b shows a phase contrast micrograph of BCARS ROIs with boxes and associated subfigure labels with a scale bar of 200 μm; panel c shows a pseudocolor BCARS image of tumor and normal brain tissue, with nuclei highlighted in blue, lipid content in red and red blood cells in green; panel d shows a BCARS image and axial scan with nuclei highlighted in blue and lipid content in red; panel b shows a BCARS image with nuclei highlighted in blue, lipid content in red and CH₃ stretch-CH₂stretch in green. NB, normal brain (wherein T, tumor cells; RBC, red blood cells; L, lipid bodies; WM, white matter); panel f shows single-pixel spectra; panel g shows a spectrally segmented image of internuclear (blue) and extranuclear (red) tumoral spaces; panel h shows histogram analysis of phenylalanine content; and panel i shows mean spectra from within a tumor mass, wherein in panels c-e, and g include scale bar of 20 μm;

FIG. 19 shows simulated nonlinear susceptibilities and CARS spectra, wherein panel a shows Raman (χ_{R}) and nonresonant nonlinear susceptibilities of a sample (χ_{NR}) and a reference (χref); and panel b shows simulated CARS spectra of the sample (I_{CARS,}_{_{χ}}=χ_{R}+χ_{NR}), the sample in the absence of Raman components (INRB), and of the reference material (I_{ref}).

FIG. 20 shows a comparison of retrieved spectra using a Kramers-Kronig (KK) relation under ideal conditions and with use of an NRB reference, wherein panel a shows a retrieved spectrum (Iᵣₑₜᵣ) when the NRB is exactly known (Ideal) and when a reference is utilized (Ref); panel b shows a difference between the ideal and reference retrieval showing remnants of the original Raman peaks; panel c shows the KK-retrieved phase when the NRB is known (φ_{CARS/NRB}) and when using a reference (φ_{CARS/ref}); and panel d shows that a phase difference between the ideal and reference retrieval provided a smooth baseline without Raman peak information;

FIG. 21 shows residual error and their correction using phase detrending and scaling in comparison with tradition amplitude detrending, wherein panel a shows KK-retrieved spectra when the NRB is known (Ideal) and using a reference material with phase detrending (Ph. Det.) and amplitude detrending (Amp. Det.); panel b shows a difference between the ideal and corrected spectra such that amplitude detrending created asymmetric peak distortion not present with phase detrending; panel c shows using a mean trend of a real component of the retrieved spectrum provided correction of edge effects and scaling ambiguity; and panel d shows a phase-detrended and scaled spectrum (Ph. Det.+Scaling, imaginary portion) is identical to the ideal retrieval (Ideal), with (panel e) no difference;

FIG. 22 shows spectral correction of neat glycerol, wherein panel a shows KK-retrieved Raman-like spectra using NRB reference materials with traditional amplitude detrending, highlighting the inability of baseline detrending to remove amplitude and phase error, and panel b shows corrected spectra with phase detrending and scaling (imaginary portion), showing close agreement with residual differences primarily arising from reference material Raman peaks;

FIG. 23 shows spectral retrieval and correction of hyperspectral data for a murine pancreatic artery tissue section, wherein panel a shows that a traditional method of preparing pseudocolor imagery shows distinct differences when using a glass coverslip or water as the NRB reference, which is not simply corrected with normalization; panel b shows single-pixel spectra (white ‘x’ in (panel a)) show intra-spectral deviations that are reference dependent with additional errors due to Raman peaks emanating from the reference NRB materials (‘*’ and dashed lines); panel c shows pseudocolor imagery using the presented phase retrieval does not show a difference between halves processed with different NRB references; panel d shows that single-pixel spectra show close agreement with residual error due to Raman peaks emanating from the reference NRB materials (‘*’ and dashed lines); and panel e shows histogram analysis of the relative difference between spectral peak intensities used in the creation of panel a, wherein there is a <4% difference (mean) between peak amplitudes;

FIG. 24 shows a window edge effect produces linear, additive error, wherein panel a shows simulated χ_{R} and χ_{NR} such that the simulation window captures the Raman peaks; panel b shows phase retrieved via the windowed Hilbert transform over varying spectral windows, showing good agreement in peak amplitudes and shapes but with varying baselines; panel c shows exact phase of χ_{R}+χ_{NR}; and panel d shows difference of the retrieved (panel b) and exact (panel c) phases, showing a smooth baseline, wherein this indicates that the window edge effect is (or approximately) additive;

FIG. 25 shows a flow chart for a method of extracting quantitatively reliable Raman-like spectra from BCARS;

FIG. 26 shows a dark signal and residual subtraction for (panel a) BCARS and dark spectra where an acquired spectral window extended beyond boundaries set by an optical filter set; and panel b shows data after dark signal subtraction;

FIG. 27 shows a simulated variance stabilization via an Anscombe transformation in which panel a shows a distribution of simulated signal over 1000 simulations with additive white Gaussian (AWGN) and mixed noise; panel b shows standard deviation and an intensity dependence of mixed noise; panel c show distribution of Anscombe transformed mixed noise signals; and panel d shows standard deviation showing normally distributed noise;

FIG. 28 shows an effect of mixed noise on single value decomposition (SVD) in which panel a shows a content fraction of each basis spectrum with and without the Anscombe transformation; panels b-g show spatial distributions of selected singular values (SVs); panel h shows that the 14th basis function shows spectral features and spectrally narrow noise (due to Poisson noise; and panel i shows that the 100th basis function shows some spectral features and confined noise;

FIG. 29 shows SVD of Anscombe transformed spectra in which panels a-f show spatial distributions of selected SVs (Ansc SV); panel G shows that the 24th spectral basis function shows clear features as would be indicated by spatial content in panel e; panel e shows that the 25th SV appears to only contain noise (as does the corresponding panel f); and by the 50th (panel i) and 100th (panel j) SVs, no noticeable remnants of signal were present;

FIG. 30 shows Raman-like spectral distortions from improper singular value selection in which panel a shows mean spectra of 10 pixels within the elastic lamina of the murine pancreas tissue for which using only the first 3 SVs resulted in significant errors, and using the first 100 SVs showed significant improvement; and panel b shows single-pixel spectra from within the elastic lamina showing similar distortions with too few SVs incorporated;

FIG. 31 shows automated selection of SVs based on spatial content in which panels a and b show that a spatial content converted into the Fourier-domain from which signal and noise regions are defined, and panel c shows a spatial signal fraction is proportional to the total intensity ratio of the signal and noise regions, wherein a cut-off is selected based on a selected multiplier of the standard deviation of the spatial signal ratio at the highest SVs;

FIG. 32 shows automated selection of SVs based on spectral content in which panels a and b show that spectral basis functions are converted into the time-domain from which signal and noise regions are defined, and panel c shows a spectral signal fraction is proportional to the ratio of the signal and noise regions, wherein a cut-off is selected based on a selected multiplier of the standard deviation of the spectral signal ratio at the highest SVs;

FIG. 33 shows automated selection of SVs based on spatial content without use of the Anscombe transformation, wherein these results show spatial contributions are spread over several hundred SVs, such as 117 and 177 (inset);

FIG. 34 shows automated selection of SVs based on spectral content without use of the Anscombe transformation, wherein these results show spectral contributions are spread over several hundred SVs, such as 149 and 229 (inset);

FIG. 35 shows phase detrending and scaling applied to the maximum entropy method (MEM) in which panel a shows a comparison of extraction of Raman signatures using the KK and MEM methods with a known NRB (“ideal”) and with a reference NRB (“Ref”), wherein both methods produce distorted spectra due to phase and amplitude errors when using a reference NRB; and panel b shows applying a phase error corrections technique produces respective spectra for the MEM and KK that are identical;

FIG. 36 shows extraction of Raman-like spectra of glycerol using difference NRB references and difference BCARS platforms in which panel a shows raw BCARS spectra collected using “System 1” and “System 2”, showing significantly difference system responses; panel b shows raw BCARS spectra of 3 common NRB reference materials: a glass coverslip, glass microscope slide, and water, wherein a raw spectrum from glass coverslip was collected on System 2; and panel c shows Raman-like spectra extracted from panel a using spectra in panel b without amplitude or phase error correction, showing different shapes and amplitudes for corresponding peaks;

FIG. 37 shows time-window self-referencing (TWSR) to retrieve the approximate NRB of a sample in which panel a shows a temporal response of the material calculated from the fast Fourier transform (FFT) of the nonlinear susceptibility; panel b shows that under normal operation, a delay time for a probe source (multiplicative in the time-domain) is set to acquire an entire temporal evolution of the Raman/CARS signal; and panel c shows acquisition of a spectrum that is predominantly NRB by setting the probe delay to an early time point;

FIG. 38 shows use of temporal dynamics of the CARS generation process to improve the utility of NRB reference measurements in which panel a shows a retrieved Raman-like spectra of glycerol (with the use of reference NRB measurements and corrected via phase detrending and scaling); panel b shows Raman-like spectra extracted from common reference NRB materials using TWSR to collect an approximate NRB spectrum of each material, wherein peaks in panel b correlate with the differences between spectra in panel a; and panel c shows extracted Raman-like glycerol spectra using NRB reference spectra that were collected under early-time conditions to reduce the Raman contributions; and

FIG. 39 shows a histogram analysis of spectral peaks amplitudes using amplitude detrending and phase detrending methods in which panels a-c show pixel-by-pixel comparison of Raman-like peak intensities using different NRB surrogate materials and traditional amplitude detrending, and panels d-f show pixel-by-pixel comparison of Raman-like peak intensities using different NRB surrogate materials and the phase detrending and scaling method, wherein histogram bins are the same width bar widths adjusted for visual clarity.

### DETAILED DESCRIPTION

A detailed description of one or more embodiments is presented herein by way of exemplification and not limitation.

It has been discovered that a plural color broadband coherent anti-Stokes Raman scattering (CARS) microscope herein provides high sensitivity at high-speed for imaging and spectroscopy of samples that include a biological sample, composite material, chemical composition, and the like. The plural color broadband CARS microscope probes intrinsic (Raman) vibrational energy levels of a molecule and produces blue-shifted anti-Stokes radiation. Advantageously, the plural color broadband CARS microscope images the sample in an absence of background fluorescence and is vibrationally specific for the sample even though the sample ca be label-free, i.e., does not include a spectroscopically active label added to the sample for spectroscopic detection of the sample. Further, the plural color broadband CARS microscope includes broadband radiation to excite a plurality of Raman transitions and acquires an anti-Stokes radiation spectrally.

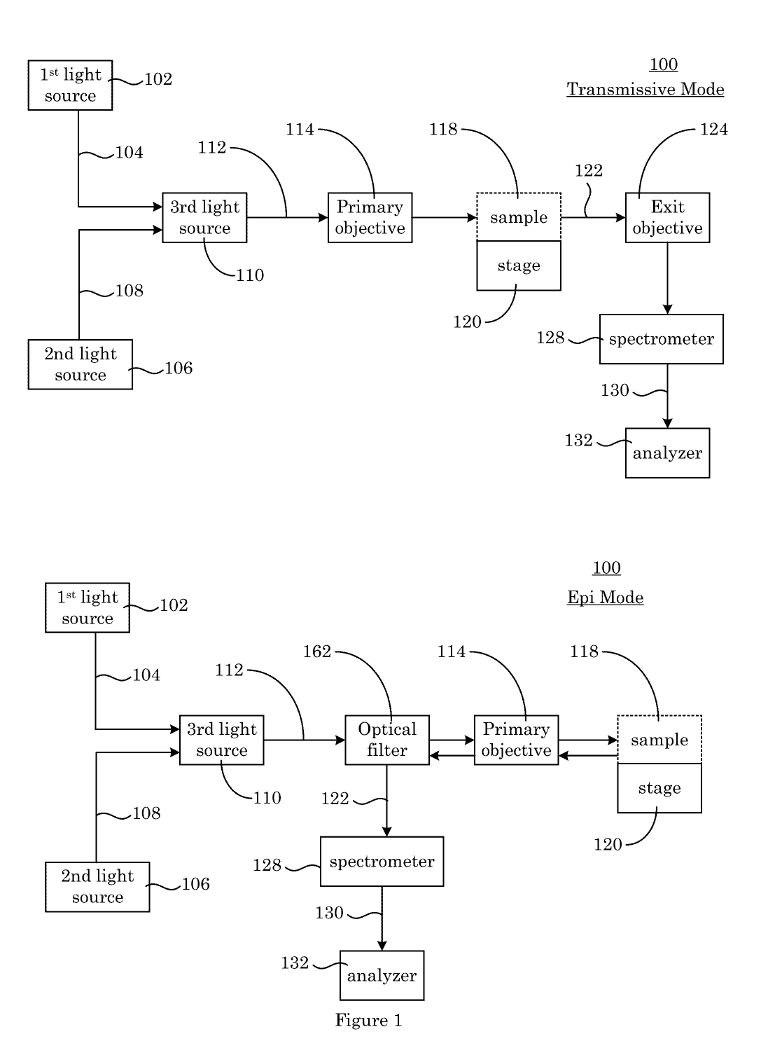

In an embodiment, with reference to FIG. 1, plural color broadband CARS microscope 100 includes first light source 102 to produce first light 104 that includes a narrowband radiation, second light source 106 to produce second light 108 including a broadband radiation, third light source 110 to receive first light 104 from first light source 102, to receive second light 108 from second light source 106, and to produce third light 112 including the narrowband radiation and the broadband radiation by combining first light 104 and second light 108 such that first light 104 and second light 108 are spatially overlapped and temporally overlapped; and primary objective 114 to receive third light 112 from third light source 110, to communicate third light 112 to sample; and to subject the sample to simultaneous interpulse CARS stimulation and intrapulse CARS stimulation by irradiation with the narrowband radiation and the broadband radiation in third light 112.

Plural color broadband CARS Microscope 100 also can include spectrometer 128 to receive fourth light 122 emitted from 118 sample in response to being subjected to the simultaneous interpulse CARS stimulation and intrapulse CARS stimulation by irradiation with the narrowband radiation and the broadband radiation in third light 112. Fourth light 122 includes anti-Stokes radiation emitted by sample 118. In plural color broadband CARS microscope 100, exit objective 124 is disposed opposing primary objective 114 and interposed between primary objective 114 and spectrometer 128 to receive fourth light 122 emitted from sample 118 and to communicate fourth light 122 to spectrometer 128.

As shown in FIG. 1, plural color broadband CARS microscope 100 can be arranged in a transmissive mode or epi mode (lower panel, depending on fourth light 122 being transmitted to exit objective 124 (top panel, transmissive mode) or fourth light 122 being emitted from sample 118 and directed through primary objective 114 and optical filter 162 to spectrometer 128 (bottom panel, epi mode).

First light source 102 can include a delay line to delay a time of arrival of first light 104 at third light source 110. Additionally, second light source 106 can include a pulse compressor to provide chirp control of second light 108. Plural color broadband CARS microscope 100 can include stage 120 to receive sample 118 and to position sample 118 relative to primary objective 114. In some embodiments, stage 120 positions and maintains a position of sample 118 in three dimensions with respect to primary objective 114.

Spectrometer 128 produces microscopy data from conversion of fourth light 122, and plural color broadband CARS microscope 100 further can include analyzer 132 to receive pre-process data comprising the microscopy data, a frequency of the broadband radiation, and a frequency of the narrowband radiation, to subject the pre-process data to a time-domain transform (e.g., phase retrieval) to acquire a Raman spectrum of sample 118; and to acquire a coherent Raman image from the pre-process data. In a certain embodiment, spectrometer 128 includes a two-dimensional imaging detector.

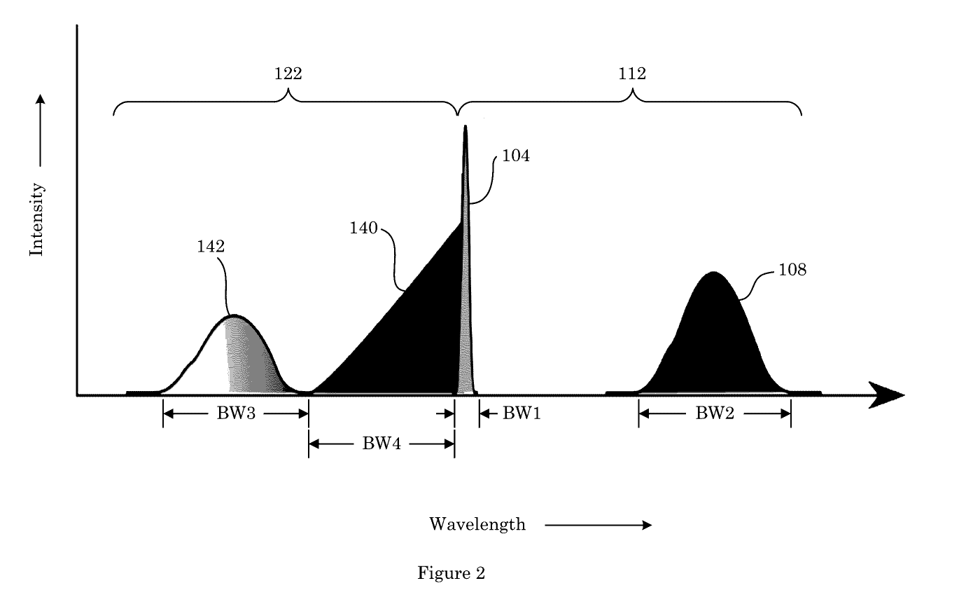

With reference to FIG. 2, first light 104 has first bandwidth BW1, and second light 108 has second bandwidth BW2. First bandwidth BW1 corresponds to the narrowband radiation and is at a shorter wavelength than a wavelength of second light 102 that corresponds to the broadband radiation. In some embodiments, a wavelength range of first light 104 does not overlap with a wavelength range of second light 108. In a certain embodiment, a portion of the wavelength range of first light 104 overlaps with a portion of the wavelength range of second light 108 (not shown in FIG. 2). Third light source 110 temporally and spatially overlaps first light 104 and second light 108 to produce third light 112 that includes the narrowband radiation having first bandwidth BW1 and the broadband radiation having second bandwidth BW2. That is, third light 112 includes the spatial and temporal overlap and wavelength ranges and bandwidth (BW1 and BW2) of first light 104 and second light 108. In response to being subjected by third light 104, sample 118 emits fourth light 122, which is anti-Stokes radiation. Fourth light 122 includes emission 140 from intrapulse excitation and emission 142 from interpulse excitation, and fourth light 122 occurs at a shorter wavelength than third light 112. Emission 140 due to intrapulse excitation and emission 142 due to interpulse excitatation of fourth light 122 include emission from a coherent Raman fingerprint region (through intra-pulse excitation) and non-resonant background (NRB) of sample 118.

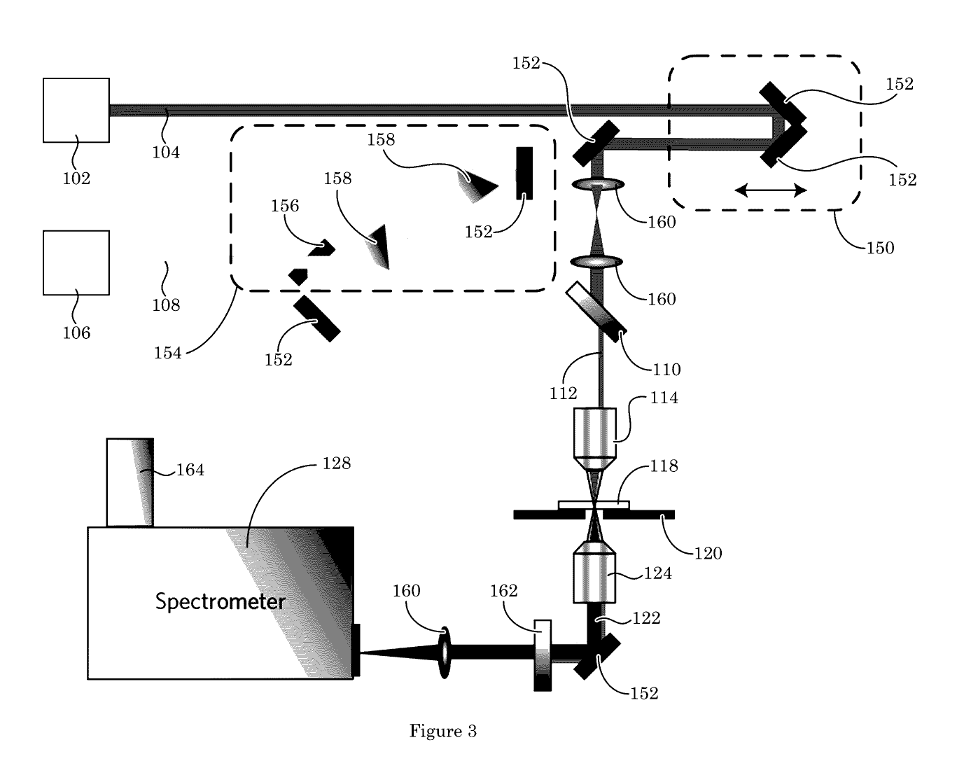

In an embodiment, as shown in FIG. 3, plural color broadband CARS microscope 100 includes first light source 102 that provides first light 104 that is communicated from first light source 102 to delay line 150. Second light source 106 provides second light 108 that is communicated from second light source 106 to pulse compressor 154. First light 104 from delay line 150 and second light 108 from pulse compressor 154 are communicated to third light source 110, which spatially overlaps and temporally overlaps first light 104 and second light 108 to produce third light 112 that is communicated to primary objective 114. Entry objective 114 focuses third light 112 onto sample 118 disposed on stage 120. Sample 118 emits fourth light 122 that is communicated to exit objective 124 that transmits and communicates fourth light 122 two spectrometer 128 that includes detector 164 to detect light in response to receipt of fourth light 122 by spectrometer 128. Mirrors 152 reflect and direct various light (e.g., first light 104, second light 106, and the like) in plural color broadband CARS microscope 100. Also, lenses 160 focus or collimate the light in plural color broadband CARS microscope 100. Filter 162 is interposed between sample 118 and spectrometer 128 to transmit fourth light 122 and to substantially eliminate third light 122 from being communicated to spectrometer 128.

First light source 102 that produces first light 104 can include a coherent light source such as a laser. Exemplary lasers include titatanium:sapphire, ytterbium, erbium, thulium, microstructured and doped fiber lasers. First light source 102 can produce first light 104 having a wavelength 400 nanometers (nm) to 2000 nm, operating as pulsed or continuous-wave (CW), typically longer than 100 femtosecond (fs). An average power of first light 104 can be from 1 microwatt (μW) to multiple Watts. First bandwidth BW1 of first light 104 can be from <1 nm to 50 nm.

Delay line 150 includes mirror 152 to adjust a time of arrival of first light 104 at third light source 110 so that third light source 110 can temporally overlapped first light 104 and second light 108. Mirrors 152 of delay line 150 can be moved relative to first light source 102 so that a time delay, e.g., from 0 to 50 nanoseconds (ns) can be added to the propagation of first light 104 en route to third light source 110. First light 104 can pass through a plurality of lenses 162 to adjust the spatial overlap of first light 104 and second light 108 at third light source 110.

Second light source 106 that produces second light 108 can include a coherent light source such as a laser. Exemplary lasers include titatanium:sapphire, ytterbium, ebrbium, thulium, microstructured and doped fiber lasers. Second light source 106 can include a pulse-broadening medium such as a nonlinear fiber. Second light source 106 can produce second light 108 having a wavelength from 400 nanometers (nm) to 2000 nm with a pulse width less than 100 femtoseconds (fs). An average power of first light 104 can be from 1 microwatt (μW) to multiple Watts. First bandwidth BW1 of first light 104 can be from 1 nm to >4000 nm.

Pulse compressor 154 compresses the temporal duration of second light 108 and mitigates the influence of chromatic-temporal dispersion within second light 108. The compressor operates by spatially dispersing different frequencies of light with a prism (dispersive element), and the different frequencies of light travel different distances before recombination at a second dispersive element. In this respect, pulse compressor 154 can include a plurality of prisms 158 positioned and mutually arranged so that the temporal dispersion between different frequency components within second light 108 is such that the temporal-chromatic dispersion of the second light 108 component of third light 112 is minimized at the sample 118. Alternatively, in some embodiments, pulse compressor 154 includes gratings, prisms, or a combination thereof. Pulse compression of second light 108 advantageously provides strong intrapulse stimulation of sample 118 when second light 108 is combined with first light 104 at third light source 112.

Third light source 110 can include a dichroic mirror to transmit first light 104 and reflect second light 108. Optionally, the dichroic mirror can reflect first light 104 in transmit second light 108 to combine first light 104 and second light 108 into third light 112. As a result, first light 104 and second light 108 are spatially overlapped and temporally overlapped into third light 112 by third light source 110.

The wavelength, bandwidth, duration, and dispersion of first light 104 and second light 108 as combined in third source 112 at sample 118 can determine the spectral characteristic of fourth light 122. Excluding the effects of primary objective 114 or any other optical elements between third light 112 and sample 118, the bandwidth of intrapulse stimulation is the bandwidth of the frequency-domain autocorrelation of second light 108 at sample 118. The bandwidth of interpulse stimulation is the bandwidth of the frequency-domain cross-correlation of first light 104 and second light 108 at sample 118. The bandwidth of intrapulse stimulated CARS emission BW4 is proportional to the bandwidth of the modulus-squared autocorrelation of second light 108 convolved with the first light 104. The amplitude of intrapulse stimulated CARS emission 140 is proportional to the amplitude of the modulus-squared autocorrelation of second light 108 convolved with the first light 104. The bandwidth of interpulse stimulated CARS emission BW3 is proportional to the bandwidth of the modulus-squared cross-correlation of first light 104 with second light 108 convolved with the first light 104. The amplitude of intrapulse stimulated CARS emission 140 is proportional to the amplitude of the modulus-squared cross-correlation of first light 104 with second light 108 convolved with the first light 104. The intrapulse stimulated CARS signal portion of fourth light 122 spans from the center wavelength of first light 104 to bandwidth BW4 shorter wavelength. The interpulse stimulated CARS signal portion of fourth light 122 spans a bandwidth BW3 that is centered at a frequency that is higher that first light 104 by the same frequency that second light 108 is shorter than first light 104. As such, first light 104 and second light 108 are not collectively constrained to specific wavelength ranges, but the relative frequencies (i.e., energy) and wavelength determine bandwidths BW3 and BW4. Second light 108 need be at a center wavelength equal-to or longer than first light 104.

Primary objective 114 and exit objective 124 can be a microscope objective in which primary objective 114 transmits third light 112 to sample 118. Exit objective 124 can selectively transmit fourth light 122 to spectrometer 128 or can transmit third light 112 and fourth light 122, depending on a material of optical components of exit objective 124. Primary objective 114 and exit objective 124 can independently have a magnification from 1 to 100 (no units); the numerical aperture from 0.01 to 1.4 (no units); or a working distance from 0 to 5 centimeters.

Filter 162 can selectively transmit fourth light 122 and block transmission of third light 112 to spectrometer 128. Exemplary filters 162 include shortpass, bandpass, and notch dichroic filters. It is contemplated that filter 162 can transmit shorter wavelengths than that of first light 104.

Spectrometer 128 is included in plural color broadband CARS microscope 100 to receive fourth light 122 emitted by sample 118 in response to being subjected to third light 112. Here, spectrometer 128 can include a plurality of elements to process fourth light 122. Such elements include, e.g., a grating to chromatically disperse fourth light 122 and the like. Fourth light 122 subjected to chromatic dispersion can be detected by detector 164. Detector 164 can be, e.g., photomultiplier, photodiode, charge-coupled (CCD) element or array, complimentary metal-oxide semiconductor (CMOS) element or array, and the like to detect a presence of fourth light 122. Detector 164 also can be a multi-dimensional detector such as camera (e.g., a charge coupled device (CCD)) or other position sensitive detector to detect a two-dimensional image of fourth light 122 emitted from sample 118 and transmitted through spectrometer 128.

Analyzer 132 receives data from spectrometer 128, e.g., detector 164. The analyzer can include a microprocessor to analyze the data such as pre-process data including the microscopy data, a frequency of the broadband radiation, and a frequency of the narrowband radiation, and the like. Analyzer 132 subjects the pre-process data to a time-domain transform (e.g., phase retrieval described below) to acquire a Raman spectrum of sample 118; and to acquire a coherent Raman image from the pre-process data. In a certain embodiment, spectrometer 128 includes a two-dimensional imaging detector. The analyzer can store information in an internal data storage or communicate with an external data storage as well as receive retrieve stored information internally or from an external source.

Plural color broadband CARS microscope 100 has numerous beneficial uses including performing microscopy. In an embodiment, a process for performing plural color broadband CARS microscopy includes producing, by first light source 102, first light 104 including the narrowband radiation; producing, by second light source 106, second light 108 including the broadband radiation; receiving, by third light source 112, first light 104 from first light source 102 and second light 108 from second light source 106; combining, by third light source 110, first light 104 and second light 108 such that first light 104 and second light 108 are spatially overlapped and temporally overlapped to produce third light 112 including the narrowband radiation and the broadband radiation; communicating third light 112 to sample 118; subjecting the sample to the third light; producing, by sample 118, fourth light 122 in response to simultaneous interpulse CARS stimulation and intrapulse CARS stimulation by irradiation with the narrowband radiation and the broadband radiation in third light 112; and acquiring fourth light 122 to perform plural color broadband CARS microscopy. The process further can include producing microscopy data from conversion of fourth light 122; receiving pre-process data comprising the microscopy data, a frequency of the broadband radiation, and a frequency of the narrowband radiation; subjecting the pre-process data to a time-domain transform to acquire a Raman spectrum of the sample; and acquiring a coherent Raman image from the pre-process data. It is contemplated that the time-domain transform includes phase retrieval. Moreover, phase retrieval can include a Kramers-Kronig analysis or a maximum entropy analysis.

Raman spectroscopy is a powerful label-free technique for analyzing chemical species within biological samples, providing a high level of sensitivity and specificity. Multiple peaks within the weakly scattering Raman fingerprint region (<1,800 cm⁻¹) are used to discriminate subtly different states of cells and tissues. Unexpectedly, plural color broadband CARS microscope 100 provides fingerprint spectra with collection times less than 0.2 seconds in Raman spectroscopy for high-resolution imaging for widespread adoption in biological research and clinical practice. Further, to bolster the inherently weak Raman scattering process, coherent Raman imaging (CRI) using plural color broadband CARS microscope 100 have been developed that coherently populate selected vibrational states of molecules in sample 118 through their nonlinear response to multiple laser fields of third light 112.

Plural color broadband CARS microscope 100 is a broadband CARS (BCARS) system that efficiently stimulates Raman transitions, especially within the weak fingerprint region, using intrapulse excitation, and exploits the strong NRB to amplify inherently weak fingerprint signal. The combination of these two features provides acquisition of spectra that is one to two orders of magnitude faster than previous methods and with high spectral clarity to enable CRI integration into widespread biological and clinical use.

Plural color broadband CARS microscope 100 was constructed as shown in FIG. 3 in which first light source 102 and second light source 106 were tailored co-seeded fiber lasers to generate first light 104 that had a narrowband flat-top probe and second light 108 that was a supercontinuum with negligible jitter. Here, first light 104 had a wavelength of 770 nm with ˜16 mW power and 3.4 ps pulses on-sample. Second light 108 had a wavelength from ˜900 nm to 1,350 nm with ˜9.5 mW power and ˜16 fs pulses on-sample. Plural color broadband CARS microscope 100 provided an independent, robust probe source (first light 104) for high-resolution spectra (<10 cm⁻¹), stimulated the fingerprint region using intrapulse excitation, which was particularly strong, efficient and maximal at the lowest energy levels, and stimulated higher-energy transitions using interpulse excitation, thus accessing the entire biologically relevant Raman window (˜500-3,500 cm⁻¹). NRB-reduction schemes were not used to maximally generate fourth light 122 with resonant signal and non-resonant signal from sample 118 for heterodyne amplification.

Plural color broadband CARS microscope 100 used two different excitation mechanisms that were performed simultaneously as different permutations of the same two pulses of first light 104 and second light 108 combined as third light 112, but their properties differed. To illustrate this, an expression for the frequency-domain CARS signal intensity, I_{CARS}(ω) is provided as

I_{CARS}(ω)∝|{χ⁽³⁾(ω)[E_{S}(ω)*Eₚ(ω)]}*Eₚᵣ(ω)|² (1)

wherein ω is frequency; χ⁽³⁾ is the third-order nonlinear susceptibility; E_{P}, E_{S}, and Eₚᵣ are the pump field (of first light 104 or second light 106 depending on the mechanism, e.g., interpulse or intrapulse stimulation, Stokes field (second light 106) and probe field (first light 104), respectively; and * and * are the cross-correlation and convolution operators, respectively. The term in square brackets is the frequency-domain coherence generation profile, which will maximize at the frequency difference between the peaks of the pump and Stokes fields. Assuming real, Gaussian fields, the integrated spectral intensity over all frequencies is given as formula 2

$$〈 {I}_{CARS} 〉 ∝ {𝒫}_{p} {𝒫}_{S} {𝒫}_{pr} \frac{{σ}_{p} {σ}_{S} {σ}_{pr}}{\sqrt{{σ}_{p}^{2} + {σ}_{S}^{2} + {σ}_{pr}^{2}}} \qquad ( 2 )$$

wherein [symbol] ₚ, [symbol] _{S}, and [symbol] ₚᵣ are respectively the pump (of first light 104 or second light 106 depending on the mechanism, e.g., interpulse or intrapulse stimulation, Stokes (second light 106), and probe (first light 104) spectrally integrated modulus-squared field (proportional to the average power), such that [symbol] [symbol] |E|² [symbol] =|E₀|²\sqrt{π}σ, where E₀ is the field envelope amplitude with 1/e half-width σ.

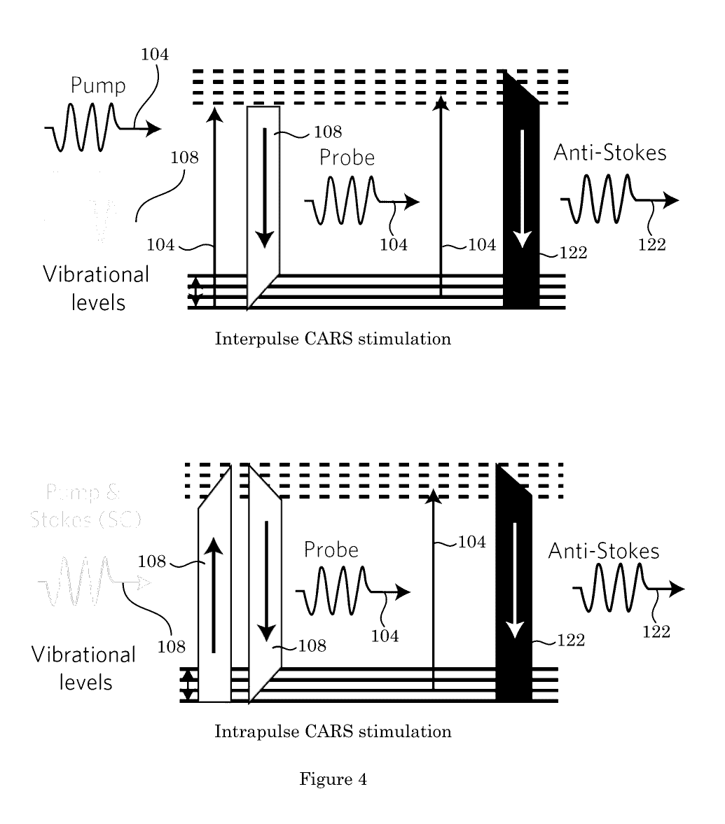

With reference to FIG. 4, under interpulse excitation (top panel of FIG. 4) ( [symbol] _{p,pr}≡ [symbol] ₚ≡ [symbol] ₚᵣ;σ_{p,pr}≡σₚ=σₚᵣ), the BCARS signal resolution of fourth light 122 is provided by the narrowband pump-probe source of first light 104, and a spectral breadth was provided by the Stokes source from second light 108. From formula (2),

$$〈 {I}_{2 C} 〉 ∝ {𝒫}_{p , pr}^{2} {𝒫}_{S} \frac{{σ}_{p , pr}^{2} {σ}_{S}}{\sqrt{2 {σ}_{p , pr}^{2} + {σ}_{S}^{2}}} \approx {𝒫}_{p , pr}^{2} {𝒫}_{S} {σ}_{p , pr}^{2} . \qquad ( 3 )$$

For intrapulse excitation shown in the bottom panel of FIG. 4, the probe (first light 104) was independent and second light 108 provided the pump and Stokes photons ( [symbol] _{p,S}≡ [symbol] ₚ= [symbol] _{S};σ_{p,S}≡σ_{P}=σ_{S}) with average intensity <I3C> in formula 4

$$〈 {I}_{3 C} 〉 ∝ {𝒫}_{p , S}^{2} {𝒫}_{pr} \frac{{σ}_{p , S}^{2} {σ}_{pr}}{\sqrt{2 {σ}_{p , S}^{2} + {σ}_{pr}^{2}}} \approx {𝒫}_{p , S}^{2} {𝒫}_{pr} {σ}_{p , S} {σ}_{pr} . \qquad ( 4 )$$

At least two differences exist between the 2C and 3C coherence generation mechanisms. One is that the interpulse mechanism has a peak excitation profile at the difference frequency between the narrowband and broadband pulses (e.g., near 2,800 cm⁻¹), whereas the intrapulse mechanism has a peak excitation frequency at 0 cm⁻¹ because the pump and Stokes fields were degenerate. Thus, the former excites the CH/OH stretch region, which presents an intrinsically stronger response, whereas the latter excites the fingerprint region, with a weaker intrinsic response. Another difference between these mechanisms is their efficiency over a broad bandwidth. With interpulse excitation, as provided in formula (3), the total CARS signal from fourth light 122 is independent of the Stokes source (second light 108) bandwidth σ_{S}. Thus, with increasing σ_{S}, the total integrated CARS signal remains constant, but the signal at each spectral increment will decrease. In contrast, as described in formula (4), the total intrapulse stimulation CARS signal rises with increasing bandwidth σ_{S}. The signal at each spectral increment also increases with increasing σ_{S}. Without wishing to be bound by theory, it is believed that the intrapulse mechanism is more efficient than the interpulse mechanism. The relative efficiency of 2C and 3C is [symbol] I_{3C} [symbol] / [symbol] I_{2C} [symbol] ∝σ_{S}/σₚᵣ≈100. Accordingly, plural color broadband CARS microscope 100 provides strong and efficient excitation within the fingerprint region.

With regard to the interpulse and intrapulse excitation, plural color broadband CARS microscope 100 uses a hybrid interpulse/intrapulse approach to excite Raman transitions spanning from the Raman fingerprint region (<1,800 cm⁻¹) to beyond 3,600 cm⁻¹. Raman energies above≈2,100 cm⁻¹ are excited with a interpulse mechanism in which the pump and probe are degenerate (both are first light 104 in third light 112) as shown in the top panel of FIG. 4. The fingerprint region, on the other hand, is excited with intra-pulse intrapulse excitation in which the pump and Stokes sources are degenerate (intra-pulse excitation from second light 108 in third light 112) and the excitation profile is determined by permutations of available frequencies (energies) of light. Because the highest number of permutations is for closely spaced frequencies, the intrapulse excitation profile increases with decreasing wavenumber. Intra-pulse intrapulse excitation is particularly well suited for stimulating Raman transitions within the vibrational fingerprint region. Additionally, the excitation profile of the intrapulse mechanism decreases with increasing wavenumber so that as the intrapulse excitation profile drops off within the Raman quiescent region (≈1,800 cm⁻¹ to 2,600 cm⁻¹), the interpulse excitation profile emerges, exciting Raman transitions ranging from≈2,100 cm⁻¹ to 3,600 cm⁻¹. With plural color broadband CARS microscope 100 using two distinct excitation schemes, analysis of differences between interpulse and intrapulse excitation provides insight into effects on resonant (Raman) and nonresonant signal generation. It is contemplated that with increasing pump and Stokes source bandwidths and fixed average power, the intensity of intrapulse excited components rises and interpulse excited components falls; that the resonant-to-nonresonant signal ratio is tied to probe source excitation parameters, not the pump and Stokes sources, under typical operating conditions; and the probe source spectral characteristics can determine the spectral resolution of CARS instruments.

For the CARS process, the output intensity, I_{CARS}(ωₐₛ), at anti-Stokes frequency ωₐₛ is proportional to the squared-modulus of the 3^{rd}-order nonlinear polarization P⁽³⁾ (ωₐₛ)

I_{CARS}(ωₐₛ)∝|P⁽³⁾(ωₐₛ)|² (5)

wherein

P⁽³⁾(ωₐₛ)∝∫∫∫χ⁽³⁾(ωₐₛ;ωₚ,−ωₛ,ωₚᵣ)×Eₚ(ωₚ)Eₛ*(ωₛ)Eₚᵣ(ωₚᵣ)δ(ωₐₛ−ωₚ+ωₛ−ωₚᵣ)dωₚdωₛdωₚᵣ (6),

wherein χ⁽³⁾(ωₐₛ;ωₚ,−ωₛ,ωₚᵣ) is the nonlinear susceptibility; Eₚ(ωₚ) is the pump electric field; Eₛ(ωₛ) is the Stokes electric field; Eₚᵣ(ωₚᵣ) is the probe electric field; and ω_{P}, ωₛ, and ωₚᵣ are the pump, Stokes, and probe frequencies, respectively. We will describe the nonlinear susceptibility as an addition of chemically-nonspecific and chemically-specific terms:

$${χ}^{( 3 )} ( {ω}_{as} ; {ω}_{p} , - {ω}_{s} , {ω}_{pr} ) = {χ}_{NR} + {χ}_{R} ( {ω}_{as} ) = {χ}_{NR} + {\sum }_{m} \frac{A}{{Ω}_{m} - ( {ω}_{p} - {ω}_{s} ) - i {Γ}_{m}} , \qquad ( 7 )$$

wherein χ_{R}(ωₐₛ) is the nonlinear susceptibility for the resonant components and χ_{NR} is the nonlinear susceptibility for the nonresonant component that generates the nonresonant background (NRB). It will be appreciated that the nonresonant component, under near-infrared excitation, is typically assumed to be real and slowly varying in frequency (although not necessarily constant). Within the expansion of χ_{R}(ωₐₛ), Aₘ, Ωₘ, Γₘ describe the Lorentzian profile of the m^{th} Raman peak at frequency Ωₘ with half-width Γₘ. It should be noted that (to a first approximation) the imaginary component of the nonlinear susceptibility, [symbol] {χ⁽³⁾}, is proportional to spontaneous Raman response (spectra). For notational clarity, we will abbreviate the form of the nonlinear susceptibility to χ⁽³⁾(ωₚ−ωₛ). Applying this to equation (6) and integrating over the pump frequencies simplifies the description of the nonlinear polarization:

P⁽³⁾(ωₐₛ)∝∫χ⁽³⁾(ωₐₛ−ωₚᵣ)└∫Eₛ*(ωₛ)Eₚ(ωₐₛ+ωₛ−ωₚᵣ)dωₛ┘Eₚᵣ(ωₚᵣ)dωₚᵣ, (8)

which may be written in a more tractable form:

P⁽³⁾(ωₐₛ)∝{χ⁽³⁾(ωₐₛ)[Eₛ(ωₐₛ)åEₚᵣ(ωₐₛ)]}*Eₚᵣ(ωₐₛ), (9)

wherein * and * are the cross-correlation and convolution operations, respectively. From equation (9), in view of the relation in equation (4), we can establish some intuitive insights about the CARS generation process. Firstly, the cross-correlation term describes the energy (frequency) profile available for material excitation. As the cross-correlation term spectrally broadens, so too will the range of Raman transitions that can be stimulated. Secondly, if the cross-correlation term is sufficiently broad (larger than a Raman lineshape), the probe source bandwidth will determine the spectral resolution of the system, i.e., the narrower the probe bandwidth, the narrower the recorded CARS lineshape-converging to a full-width at half-maximum (FWHM) of 2Γₘ for the m^{th} peak. Finally, if the cross-correlation term becomes an autocorrelation, as in the case of intra-pulse intrapulse excitation, the material excitation profile will be necessarily centered at ωₐₛ=0 and symmetric about this point although actual measurements correspond to ωₐₛ>0.

If we assume all sources have Gaussian spectral profiles and real envelopes, i.e., are transform limited and temporally centered, we may write the cross-correlation term:

$$\begin{matrix}{E}_{s} ( ω ) å {E}_{p} ( ω ) = \int {E}_{s}^{*} ( {ω}^{′} ) {E}_{p} ( ω + {ω}^{′} ) d {ω}^{′} & ( 10 ) \\ = \frac{{E}_{s 0} {E}_{p 0} {σ}_{p} {σ}_{s} \sqrt{2 π}}{\sqrt{{σ}_{p}^{2} + {σ}_{s}^{2}}} {e}^{- \frac{{( ω - {ω}_{p 0} + {ω}_{s 0} )}^{2}}{2 ( {σ}_{p}^{2} + {σ}_{s}^{2} )}} , & ( 11 )\end{matrix}$$

wherein Eₛ(ω) and Eₚ(ω) are the Stokes and pump fields with amplitudes Eₛ₀ and Eₚ₀, center frequencies ωₛ₀ and ωₚ₀, and 1/e-intensity half-widths of σₛ and σₚ, respectively. For the special case of intrapulse excitation, in which the pump and Stoke sources are degenerate, the cross-correlation is an autocorrelation:

$${E}_{p , s} ( ω ) \mathring{a} {E}_{p , s} ( ω ) = \vert {E}_{p 0 , s 0} {\vert}^{2} {σ}_{p , s} \sqrt{π} {e}^{- \frac{{ω}^{2}}{4 {σ}_{p , s}^{2}}} , \qquad ( 12 )$$

where we have noted the degeneracy of the pump and Stokes fields by using E_{p,s}(ω), with amplitude E_{s0,p0}, 1/e-intensity half-width σ_{p,s}, and frequency offset ω_{p0,s0} (although all offset-frequency terms cancel out). For a Gaussian field, A(ω), of the form A₀ exp{−ω²/2σ²}, the average power, P_{A}, is proportional to |A₀|²σ\sqrt{π}; therefore, from equations (11) and (12):

$$\begin{matrix}{E}_{s} ( ω ) \mathring{a} {E}_{p} ( ω ) ∝ \sqrt{{P}_{p} {P}_{s}} \frac{\sqrt{2 {σ}_{s} {σ}_{p}}}{\sqrt{( {σ}_{p}^{2} + {σ}_{s}^{2} )}} {e}^{- \frac{{( ω - {ω}_{p 0} + {ω}_{s 0} )}^{2}}{2 ( {σ}_{p}^{2} + {σ}_{s}^{2} )}} & ( 13 ) \\ {E}_{p , s} ( ω ) \mathring{a} {E}_{p , s} ( ω ) ∝ {P}_{p 0 , s 0} {e}^{- \frac{{ω}^{2}}{4 {σ}_{p , s}^{2}}} . & ( 14 )\end{matrix}$$

For equation (14), the material excitation from intrapulse stimulation, the maximum amplitude occurs at ω=0. Additionally, this maximum amplitude is constant regardless of source bandwidth with fixed average power. At spectral positions shifted from the origin, the material response will increase with source bandwidth. The case for interpulse excitation differs in that the maximum material response will occur at ω=ωₚ₀−ωₛ₀, and will decrease with increasing source bandwidth. For the scenario representative of most multispectral CARS experiments, in which the Stoke source is significantly broader than the pump source, σₛ>>σₚ, equation (13) simplifies:

$${E}_{s} ( ω ) \mathring{a} {E}_{p} ( ω ) {\vert}_{{σ}_{s} >> {σ}_{p}} ∝ \sqrt{{P}_{p} {P}_{s}} \sqrt{\frac{2 {σ}_{p}}{{σ}_{s}}} {e}^{- \frac{{( ω - {ω}_{p 0} + {ω}_{s 0} )}^{2}}{2 ( {σ}_{p}^{2} + {σ}_{s}^{2} )}} . \qquad ( 15 )$$

Under these conditions, with fixed average power, the interpulse material excitation maximum amplitude will drop a ∝1/\sqrt{σₛ}.

To evaluate these findings and their effects on the total output signal, we evaluate equation (5) for the case of a non-resonant material (with the simplification of a real, constant-valued χ_{NR}):

I_{CARS}(ω)∝|{χ_{NR}[Eₛ(ω)åEₚ(ω)]}*Eₚᵣ(ω)|₂. (16)

Using the cross-correlation and autocorrelation terms in equations (20) and (21) and applying a Gaussian field probe, the interpulse, I_{2C}(ω), and intrapulse, I_{3C}(ω), CARS signals may be written:

$$\begin{matrix}{I}_{2 C} ( ω ) ∝ \vert \frac{2 {πχ}_{NR} {E}_{s 0}^{*} {E}_{p 0 , pr 0}^{2} {σ}_{p , pr}^{2} {σ}_{s}}{\sqrt{2 {σ}_{p , pr}^{2} + {σ}_{s}^{2}}} {e}^{- \frac{{( ω - 2 {ω}_{p 0 , pr 0} + {ω}_{s 0} )}^{2}}{2 ( 2 {σ}_{p , pr}^{2} + {σ}_{s}^{2} )}} {\vert}^{2} & ( 17 ) \\ = \frac{4 {π}^{2} {χ}_{NR}^{2} \vert {E}_{s 0} {\vert}^{2} \vert {E}_{p 0 , pr 0} {\vert}^{4} {σ}_{p , pr}^{2} {σ}_{s}^{2}}{2 {σ}_{p , pr}^{2} + {σ}_{s}^{2}} {e}^{- \frac{{( ω - 2 {ω}_{p 0 , pr 0} + {ω}_{s 0} )}^{2}}{( 2 {σ}_{p , pr}^{2} + {σ}_{s}^{2} )}} & ( 18 ) \\ ∝ \frac{4 \sqrt{π} {χ}_{NR}^{2} {P}_{s} {P}_{p , pr}^{2} {σ}_{p , pr}^{2} {σ}_{s}}{2 {σ}_{p , pr}^{2} + {σ}_{s}^{2}} {e}^{- \frac{{( ω - 2 {ω}_{p 0 , pr 0} + {ω}_{s 0} )}^{2}}{( 2 {σ}_{p , pr}^{2} + {σ}_{s}^{2} )}} & ( 19 ) \\ {I}_{3 C} ( ω ) ∝ \frac{4 {π}^{2} {χ}_{NR}^{2} \vert {E}_{p 0 , s 0} {\vert}^{4} \vert {E}_{pr 0} {\vert}^{2} {σ}_{p , s}^{4} {σ}_{pr}^{2}}{2 {σ}_{p , s}^{2} + {σ}_{pr}^{2}} {e}^{- \frac{{( ω - {ω}_{pr 0} )}^{2}}{( 2 {σ}_{p , s}^{2} + {σ}_{pr}^{2} )}} & ( 20 ) \\ ∝ \frac{4 \sqrt{π} {χ}_{NR}^{2} {P}_{p , s}^{2} {P}_{pr} {σ}_{p , s}^{2} {σ}_{pr}}{2 {σ}_{p , s}^{2} + {σ}_{pr}^{2}} {e}^{- \frac{{( ω - {ω}_{pr 0} )}^{2}}{( 2 {σ}_{p , s}^{2} + {σ}_{pr}^{2} )}} . & ( 21 )\end{matrix}$$

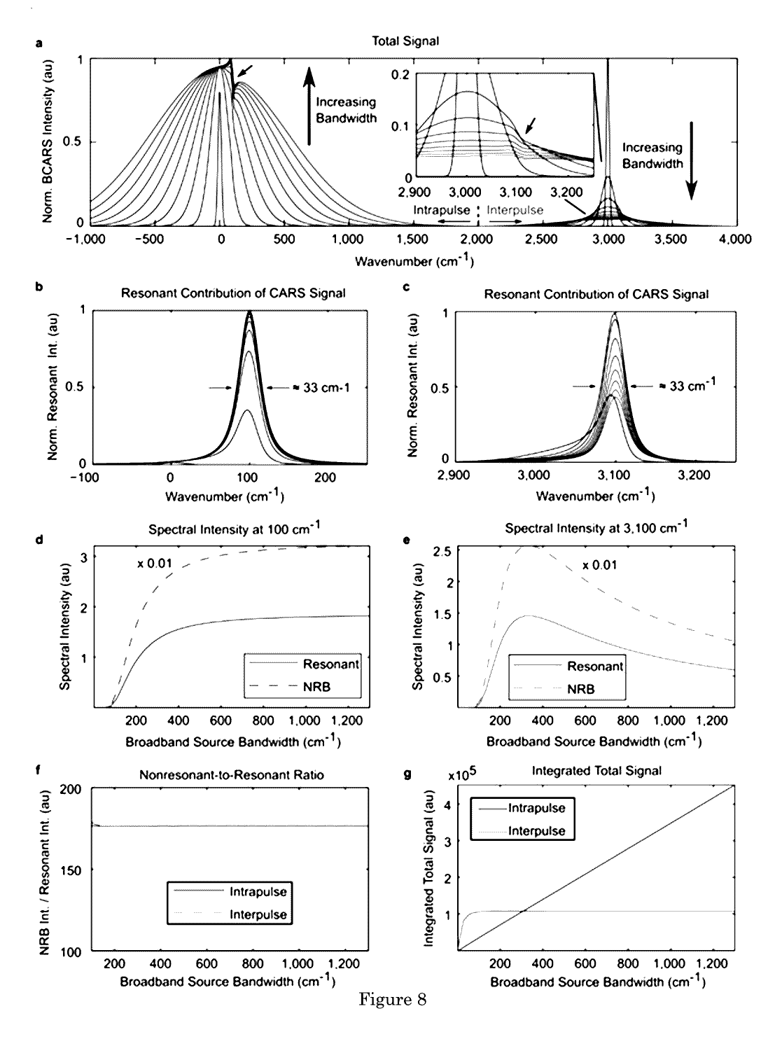

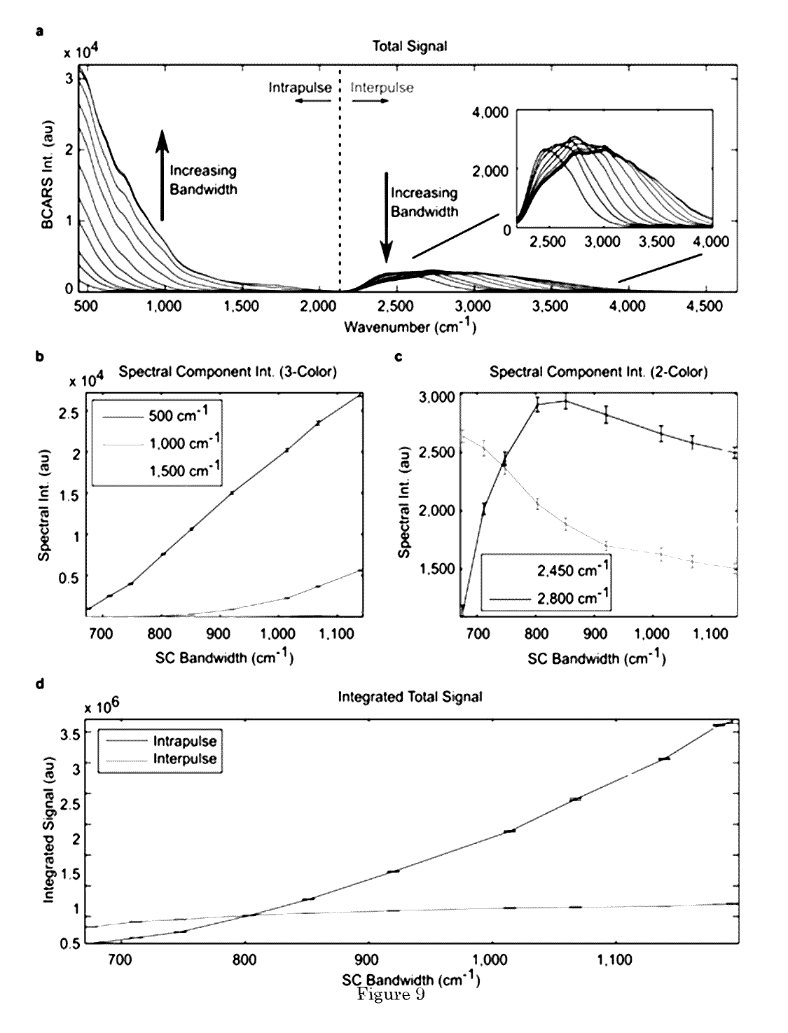

Comparing these equations, the interpulse maximum signal generation occurs at ω=ωₚ₀+ωₚᵣ₀−ωₛ₀ and under the condition of a significantly broader Stokes source than pump-probe, the maximum CARS signal will fall ∝1/σₛ. For the intrapulse excitation case, the maximum signal occurs at frequency ω=ωₚᵣ, and, also, under the case of a relatively narrow probe source and fixed average source powers, the maximum CARS signal will remain constant with increasing pump-Stokes bandwidth. Away from this maximum, with increasing pump-Stokes bandwidth, the CARS signal will rise ∝exp{−(ω−ωₚᵣ₀)²/(2σ_{p,s}²+σₚᵣ²)}. To demonstrate these findings and to apply equation (9) to the more general case of a material with resonant and nonresonant components, we simulated the CARS signal generation process. In particular, the pump, Stokes, and probe source average powers were held fixed, and the probe intensity FWHM was set to 12 cm⁻¹. For each simulation a single Raman peak (A=1, 2Γ=20) was simulated+100 cm⁻¹ offset from the maximum excitation wavenumber, which for the intrapulse case is 0 cm⁻¹ and for interpulse stimulation is 3,100 cm⁻¹. The nonresonant susceptibility was set to a constant value of 1 (max [symbol] {ω⁽³⁾}/χ_{NR}=0.1). FIG. 8, panel a shows the normalized intensity of the CARS spectrum (interpulse and intrapulse normalized to peak intensity independently) and a variable broadband source. As the theory suggests, with increasing bandwidth, the intrapulse regime continues to gain spectral breadth with the response at each spectral component continually rising. Conversely, the interpulse component dramatically decreases in intensity. Panels b and c of FIG. 8 show the evolution of the resonant component with increasing bandwidth. In the intrapulse excitation case, the resonant stimulation rises with increasing bandwidth, as detailed in panel d of FIG. 8. In the interpulse case, the peak intensity at 3,100 cm⁻¹ rises as the excitation profile broadens to encompass the entire Raman lineshape. As the excitation profile surpasses this width, the intensity begins to fall, as plotted in panel e of FIG. 8. In both interpulse and intrapulse excitation, the spectral resolution, a convolution of the probe source and the Raman nonlinear susceptibility, is the same: ≈33 cm⁻¹. In addition to the resonant signal, panels d and e of FIG. 8 describe the strong NRB generation that is >100× more intense than the resonant case. In both interpulse and intrapulse excitation regimes, the NRB and resonant signal generation follow similar evolution as a function of pump-Stokes source bandwidth. In fact, as shown in panel f of FIG. 8, the nonresonant-to-resonant signal ratios are fixed (standard deviation ±0.03%) with sufficiently broad excitation sources (>160 cm⁻¹). It should be noted, however, that this ratio can be modulated by changing the probe bandwidth. Finally, if we look at the integrated total signal (resonant and nonresonant contributions), which is proportional to total signal power generated, as shown in FIG. 1g, the interpulse CARS signal is relatively constant with source bandwidths approximately >160 cm⁻¹. intrapulse excitation, on the other hand, generates a linearly increasing total signal with increasing source bandwidth. Although it is unexpected that there is an increase in signal with increased bandwidth and that energy is not conserved; in actuality there is just an increase in efficiency. This occurs only in the limit of no excitation source depletion and no vibrational and electronic state saturation.

To experimentally evaluate some of these simulated and theoretical points, including the unexpected and surprising behavior of the intrapulse signal increase with increased continuum bandwidth, we experimentally measured the BCARS spectrum from a glass microscope slide, which is predominantly NRB. To adjust the bandwidth, a slit was inserted into pulse compressor 154 of second light source 106 and adjusted to reduce or increase available bandwidth (the slit was inserted on the red-side of the second light supercontinuum (SC) spectrum; thus, as bandwidth changes, so too does ωₛₒ). A thin-film metal-on-glass attenuator was used to adjust the average power of second light 108 to maintain constant average power (6.7 mW), regardless of bandwidth. Panel a of FIG. 9 shows the recorded BCARS spectra at various SC bandwidths (FWHM) of second light 108. As predicted, with increasing bandwidth, the Raman spectral region excited with intrapulse excitation increases universally with increasing source bandwidth. Panel b of FIG. 9 shows the evolution of signal intensity as a function of source bandwidth at 3 particular wavenumbers. The measured response qualitatively agrees with the simulated results in panel d of FIG. 8. Within the interpulse region, the signal evolves with many similarities to the previously presented simulations. Panel c of FIG. 9 shows the signal generation at 2 individual frequencies. For 2,450 cm⁻¹, which is stimulated under all bandwidth settings, the signal decays with increasing bandwidth. The 2,800 cm⁻¹ signal, on the other hand, is not stimulated under narrow source bandwidth conditions of first light 104; thus, as the slit is opened, the signal rises, plateaus, then decays. Panel d of FIG. 9 shows the total integrated signal as a function of bandwidth. The interpulse signal is relatively flat and is similar to the findings in panel g of FIG. 8, but does show some increase with increasing bandwidth. Possible explanations are SC source chirp and higher-order dispersion of second light 108 or source spectral profiles being other than Gaussian. The intrapulse signal, conversely, shows a dramatic increase with increasing bandwidth, which also agrees with theoretical and simulated findings. The exact shape of the rise deviates from predictions, and may, too, be partially accounted for by unsimulated SC dispersion and non-Gaussian source spectral envelope shapes of second light 108. Overall, the experimental results qualitatively agree with the simulations and clearly demonstrate the theoretically predicted trends.

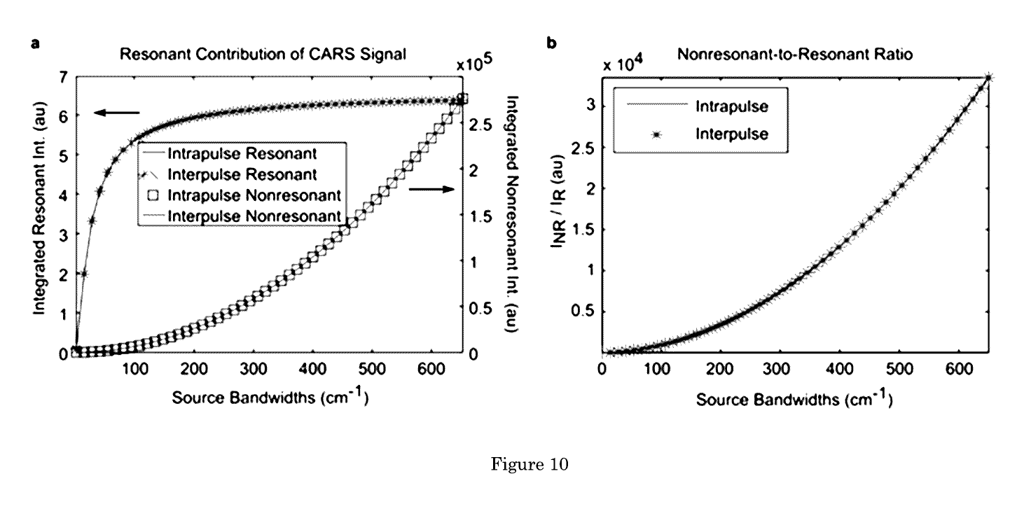

With regard to similarities and differences between interpulse and intrapulse excitation, with increasing bandwidth (under the condition of a fixed probe source bandwidth (first light 104), and fixed average source powers (first light 104 and second light 108)), intrapulse excitation response rises, and interpulse excitation signal eventually decays. Additionally, the theory and simulated results indicated that for excitation sources (first light 104 and second light 108 in third light 112) with stimulation profiles fully encompassing a particular Raman band, the probe source (first light 104) determines the spectral resolution, with the use of an infinitely narrow probe source (first light 104) generating a resonant signal with the same bandwidth as the Raman lineshape. In view of these two characteristics, if the probe source bandwidth (that of first light 104), however, were not fixed but varied with the pump (either first 104 or second light 108) and Stokes source (second light 108) bandwidths, the resonant and nonresonant signals in fourth light 122 would evolve differently. Panel a of FIG. 10 the total interpulse and intrapulse generated signal contained in fourth light 122 as a function of source bandwidths when the pump (first light 104 or second light 108), Stokes (second light 108), and probe (first light 104) sources have the same bandwidth under fixed average source powers. Under these conditions with increasing bandwidths, the resonant signal of fourth light 122 increases but at a decreasing rate, whereas the nonresonant signal in fourth light 122 increases at an increasing rate. Additionally, if one compares the nonresonant-to-resonant signal ratio, as shown in panel b of FIG. 10, the ratio is continually increasing with source bandwidths. Increasing probe (first light 104) bandwidth can deteriorate spectral resolution of fourth light 122, smearing out the Raman Lorentzian lineshapes.

Using intrapulse generation is necessary, but not sufficient, to achieve the required signal levels within the fingerprint region. Prior to plural color broadband CARS microscope 100, CARS imaging with intrapulse excitation was limited to fingerprint imaging of only strongly scattering systems such as neat liquids and polymer films. Advantageously, plural color broadband CARS microscope 100 leverages the strong intrapulse stimulation to use fully the NRB. Without heterodyne amplification provided by NRB, signal-to-noise ratio (SNR) at high-speed acquisition would be less than 1 for most Raman fingerprint peaks. NRB provides a robust local oscillator for heterodyne amplification of the resonant signal in fourth light 122 when spectral phase retrieval is applied numerically after fourth light 122 is collected. Heterodyne amplification brings weaker Raman peaks above the noise floor and increases their effective SNR by over an order of magnitude.

In this regard, a description of nonresonant background as heterodyne amplifier is provided. Contrary to commonly accepted belief that NRB is an impediment to acquiring resonant CARS signals, we describe and demonstrate that NRB benefits resonant components of the CARS signal in fourth light 122 by heterodyne amplification of weak resonant signals above the noise floor of a detector, e.g., spectrometer 128.

For a BCARS system probing a single complex Lorentzian peak:

$$\begin{matrix}{I}_{CARS} ( ω ) = \vert {χ}_{R} ( ω ) {\vert}^{2} + \vert {χ}_{NR} ( ω ) {\vert}^{2} + 2 {χ}_{NR} ( ω ) ℛ \{ {χ}_{R} ( ω ) \} & ( 22 ) \\ {χ}_{R} ( ω ) = \frac{A}{ω - Ω - i Γ} & ( 23 ) \\ {χ}_{NR} ( ω ) \approx {χ}_{NR} ∈ R . & ( 24 )\end{matrix}$$

The CARS signal intensity in fourth light 122, I_{CARS}, is proportional to the squared modulus of the total third-order nonlinear susceptibility convolved with the probe source field, but for simplicity we have assumed a delta function-like probe source and a real, constant value for the cross-correlation of the pump (first light 104 or second light 108) and Stokes (second light 108) sources so that we can encapsulate the pump and Stokes source intensities into the nonlinear susceptibility amplitudes. With these assumptions, we define the signal-to-noise ratio (SNR) as:

$$\begin{matrix}SNR ( ω ) = \frac{\vert {χ}_{R} ( ω ) {\vert}^{2} + 2 {χ}_{NR} ( ω ) ℛ \{ {χ}_{R} ( ω ) \}}{\sqrt{\begin{matrix}\vert {χ}_{R} ( ω ) {\vert}^{2} + \vert {χ}_{NR} ( ω ) {\vert}^{2} + \\ 2 {χ}_{NR} ( ωℛ \{ {χ}_{R} ( ω ) \} + {N}_{R}^{2}\end{matrix}}} \\ = \frac{[ {A}^{2} + 2 {χ}_{NR} A ( ω - Ω ) ] \text{/} [ {( ω - Ω )}^{2} + {Γ}^{2} ]}{\sqrt{\begin{matrix}[ {A}^{2} + 2 {χ}_{NR} A ( ω - Ω ) ] \text{/} \\ [ {( ω - Ω )}^{2} + {Γ}^{2} ] + {χ}_{NR}^{2} + {N}_{R}^{2}\end{matrix}}} ,\end{matrix} \qquad ( 25 )$$

where N_{R} is the read-out noise of the detector (which includes all non-time, non-signal dependent noises, such as read noise), and the dark noise is assumed negligible as it is orders of magnitude smaller than readout noise and shot noise with detector 164, e.g., cooled-CCD cameras over short acquisition times.

The relative amplitude of the resonant and nonresonant components in fourth light 122 strongly influences the role that the NRB has on the SNR. Under the condition that the resonant component of fourth light 122 is significantly larger than the nonresonant component, the maximum SNR is:

$$\begin{matrix}SNR ( ω = Ω ) = \frac{{A}^{2} \text{/} {Γ}^{2}}{\sqrt{[ {A}^{2} \text{/} {Γ}^{2} + {χ}_{NR}^{2} + {N}_{R}^{2}}} & ( 26 ) \\ {lim}_{{A}^{2} \text{/} {Γ}^{2} \to ∞} SNR ( ω = Γ ) = \frac{A}{Γ} ; & ( 27 )\end{matrix}$$

Thus, the nonresonant component only contributes noise to fourth light 122 (i.e., the SNR falls with increasing nonresonant contribution). Practically, this condition may be met in spectral regions of high oscillator density such as within the CH-stretch region of the Raman spectrum, where the resonant component is extremely strong. In other spectral regions, the nonresonant component has a different effect on SNR. For |χ_{R}|²<<χ_{NR}² and at the maximum of the dispersed Raman lineshape (ω=Γ+Ω), the SNR is given as:

$$\begin{matrix}SNR ( ω = Γ + Ω ) = \frac{2 {χ}_{NR} A Γ \text{/} 2 {Γ}^{2}}{\sqrt{2 {χ}_{NR} A Γ \text{/} 2 {Γ}^{2} + {χ}_{NR}^{2} + {N}_{R}^{2}}} = \frac{{χ}_{NR} A \text{/} Γ}{\sqrt{{χ}_{NR} A \text{/} Γ + {χ}_{NR}^{2} + {N}_{R}^{2}}} & ( 28 ) \\ {lim}_{{χ}_{NR}^{2} \to ∞} SNR ( ω = Γ + Ω ) = \frac{A}{Γ} . & ( 29 )\end{matrix}$$

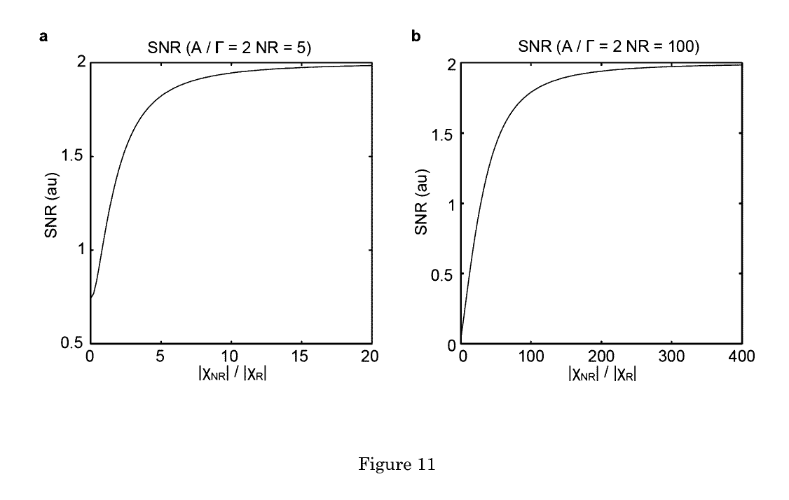

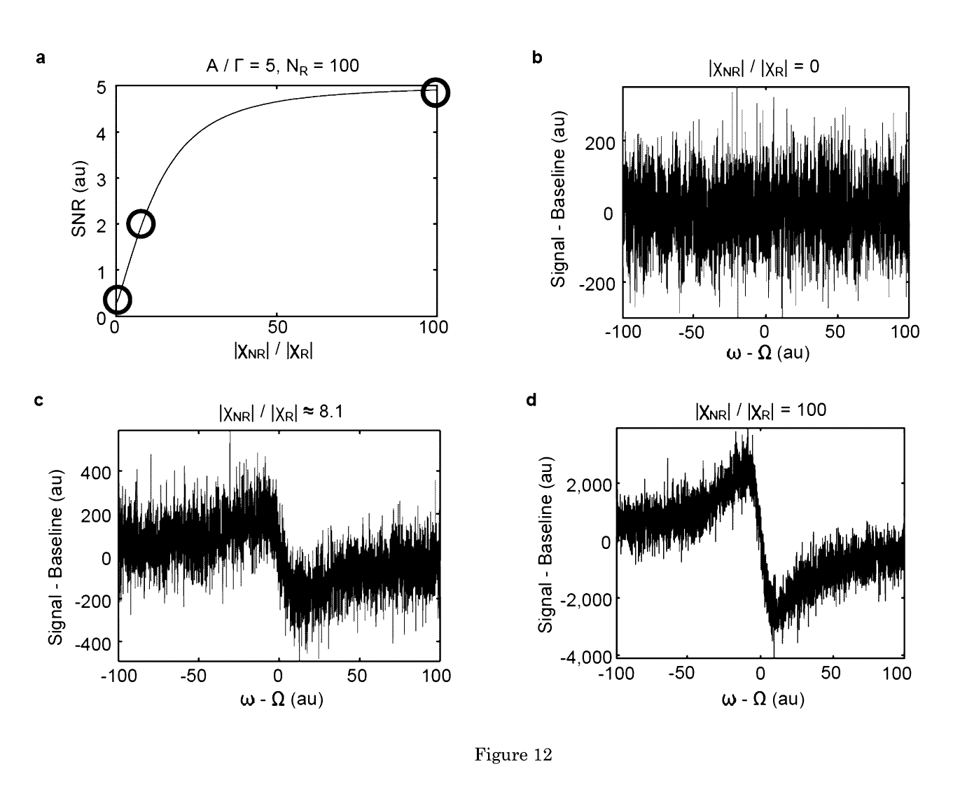

This relationship demonstrates that a large NRB may amplify fourth light 122 above the readout noise level when necessary. Additionally, in both the large resonant signal limit and the small resonant signal limit, the SNR asymptotically approaches A/Γ FIG. 11 shows the calculated SNR for plural color broadband CARS microscope 100 with A/Γ=2 for (a) a low-noise detector (similar to many cooled scientific CCD cameras) and (b) a higher-noise detector. In both cases, the SNR with no nonresonant contribution is below one, but with an increasing nonresonant-to-resonant ratio, the maximum SNR approaches A/Γ; ergo, the NRB does not affect signal quality. Under these conditions, capturing the CARS signal of fourth light 122 can include a relatively large NRB. This is further demonstrated in FIG. 12 for plural color broadband CARS microscope 100 with A/Γ=5 with a noisy detector. Panel a of FIG. 12 shows the calculated SNR plot beginning with an SNR below 1 but increasing towards 5. Panels b-d of FIG. 12 show the CARS spectrum for a single simulated peak with noise contributions from the shot noise (both resonant and nonresonant contributions in fourth light 122) and readout noise. In panel b of FIG. 12, the embodiment of no NRB, the SNR is ≈0.25; thus, the signal in fourth light 122 is masked. In the other extreme with the NRB being 100 times larger than the maximum resonant contribution in fourth light 122, the SNR approaches 5 and the signal of fourth light 122 is easily discernible.

With regard to plural color broadband CARS microscope 100, spectra generated by the combination of interpulse and intrapulse excitation are collected with spectrometer 128 that can include detector 164 such as a thermoelectrically cooled charge-coupled device (CCD) camera to provide acquisition times down to 3.5 ms per spectrum. Spectrometer 128 has a detection range that is sufficiently broad (>250 nm) to acquire fourth light 122 that can include BCARS as well as other nonlinear processes such as second-harmonic generation (SHG) or two-photon excited fluorescence (TPEF), providing an additional information for BCARS spectral interpretation.

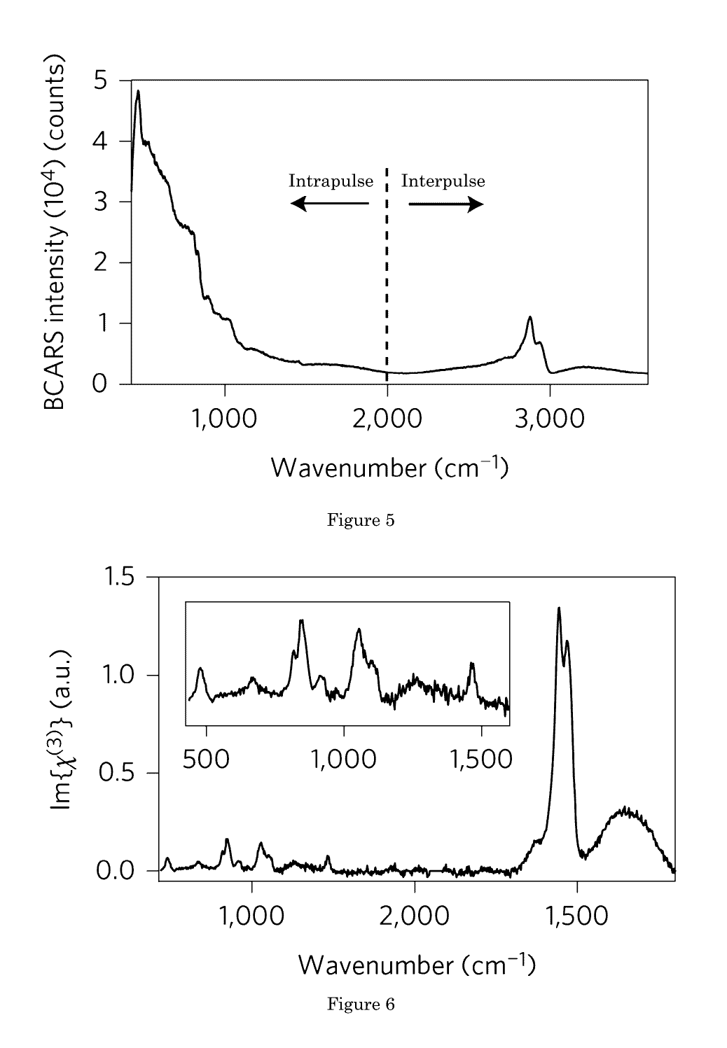

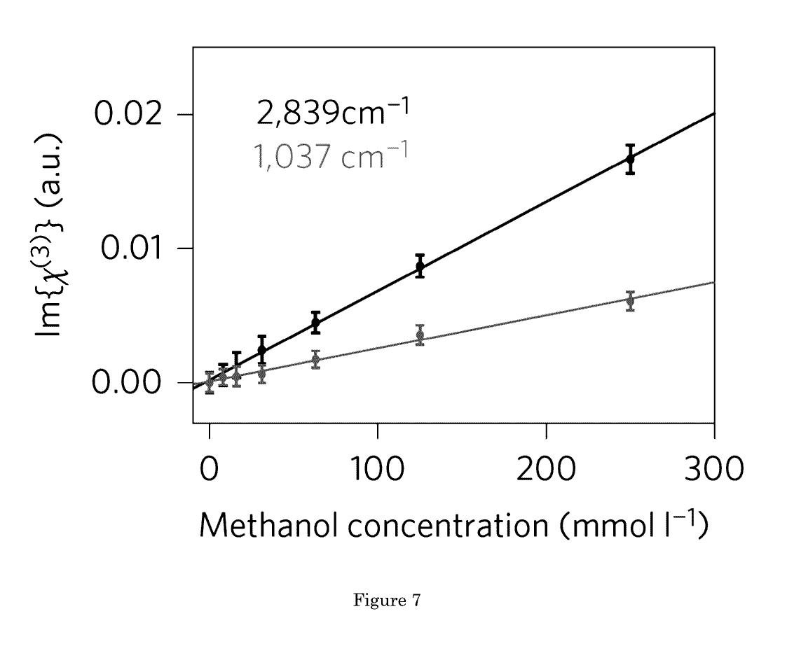

FIG. 5 shows a raw BCARS spectrum of 99% glycerol (acquisition time, 3.5 ms; SNR, 15-23 dB), which shows intense intrapulse response in frequencies from ˜425 cm⁻¹ to 2,000 cm⁻¹, which dwarfs the interpulse response of ˜2,000 cm⁻¹ to 3,600 cm⁻¹. Although the raw BCARS spectrum is distorted due to coherent mixing between the resonant CARS signal and the NRB of fourth light 122, FIG. 6 demonstrates the use of a time-domain Kramers-Kronig (TDKK) transform to retrieve the imaginary component of the nonlinear susceptibility, Im{χ⁽³⁾}, convolved with the probe source (first light 104 or second light 108) spectral profile, which is proportional to the (spontaneous) Raman response of the molecule. TDKK provides a speed advantage over competing techniques. To examine the detection limit of the BCARS provided by plural color broadband CARS microscope 100 and to demonstrate its molecular response linearity, spectra were recorded from a methanol-water dilution series that was time-averaged over 1 second. As shown in FIG. 7, the response of the retrieved Im{χ⁽³⁾} was linear with respect to methanol concentration (starting from 1 mol l⁻¹; zoomed-in for clarity), and the detection limit of plural color broadband CARS microscope 100 was determined to be <23 mmol l⁻¹ in this configuration using the C—O stretch peak at ˜1,037 cm⁻¹ and <8 mmol l⁻¹ using the C—H stretch peak at ˜2,839 cm⁻¹.

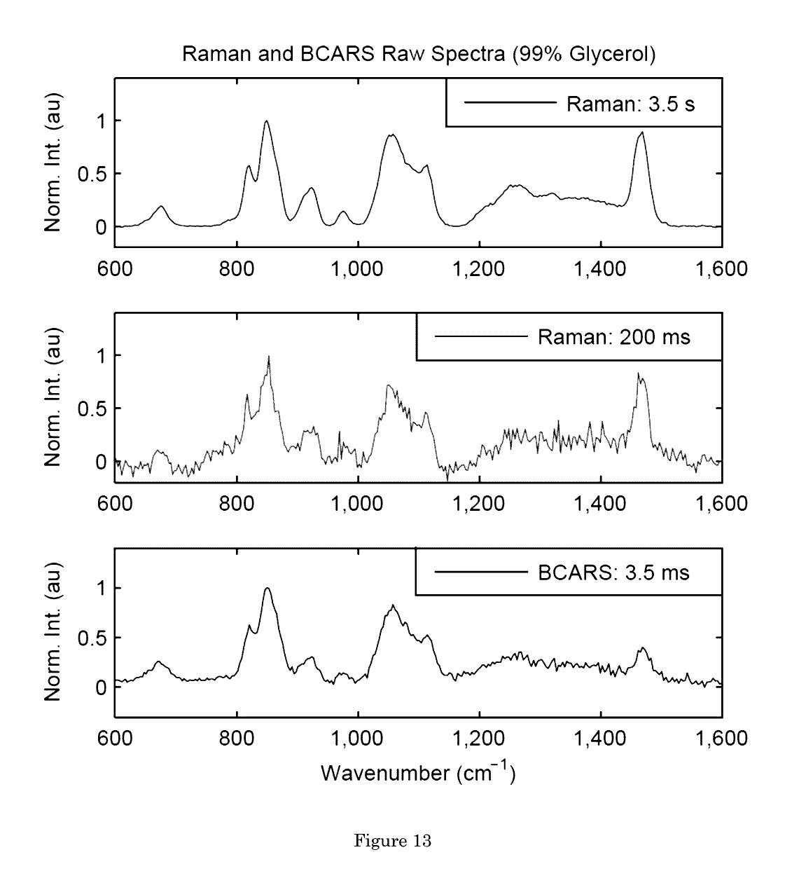

Plural color broadband CARS microscope 100 provides spontaneous and coherent Raman spectroscopy of glycerol with significant speed enhancement over conventional CARS spectroscopic techniques. To compare the speed and sensitivity of plural color broadband CARS microscope 100 to traditional spontaneous Raman spectroscopy, we recorded spectra of 99% glycerol using a Renshaw inVia confocal Raman microscope and plural color broadband CARS microscope 100. Although this demonstration is qualitatively instructive, a quantitative, thorough comparison between coherent and spontaneous Raman systems included detailed calibration and spectral measurement of both instruments. For spontaneous Raman acquisition, a large drop of glycerol was placed on a silicon wafer to reduce autofluorescence, and the sample was illuminated with 36 mW (on-sample) with 785 nm light from a photodiode. The Stokes photons were epi-detected (reflection mode) and recorded by the built-in CCD-equipped spectrometer (CCD: 40-60% quantum efficiency [QE] within fingerprint region; :5-20% QE within CH-/OH-stretch region). Spectra were recorded with 200 ms (the minimum available on the system) or 3.5 s integration times. For BCARS spectroscopy, the glycerol was mounted using typical histological preparation, with the sample sealed between a glass coverslip and a glass slide. Spectra were captured with 3.5 ms integration times by the CCD-spectrometer (QE 45% across the spectrum), and the Raman spectrum was retrieved using the time-domain Kramers-Kronig (TDKK) transform. FIG. 13 shows the fingerprint spectra collected with spontaneous Raman and coherent Raman techniques. Visual comparison indicates that most of the BCARS spectrum (<1,2000 cm⁻¹) shows similar noise performance to that of spontaneous Raman with 3.5 s integration times (a speed factor of 1000×). As plural color broadband CARS microscope 100 response diminishes at higher energies, the signal quality degrades, but not to the levels seen with spontaneous Raman at 200 ms integration times. It should be noted that the spontaneous Raman system was incapable of recording fingerprint spectra from a glycerol sample mounted in glass (i.e., the sample used for BCARS analysis) due to the autofluorescence from the glass.

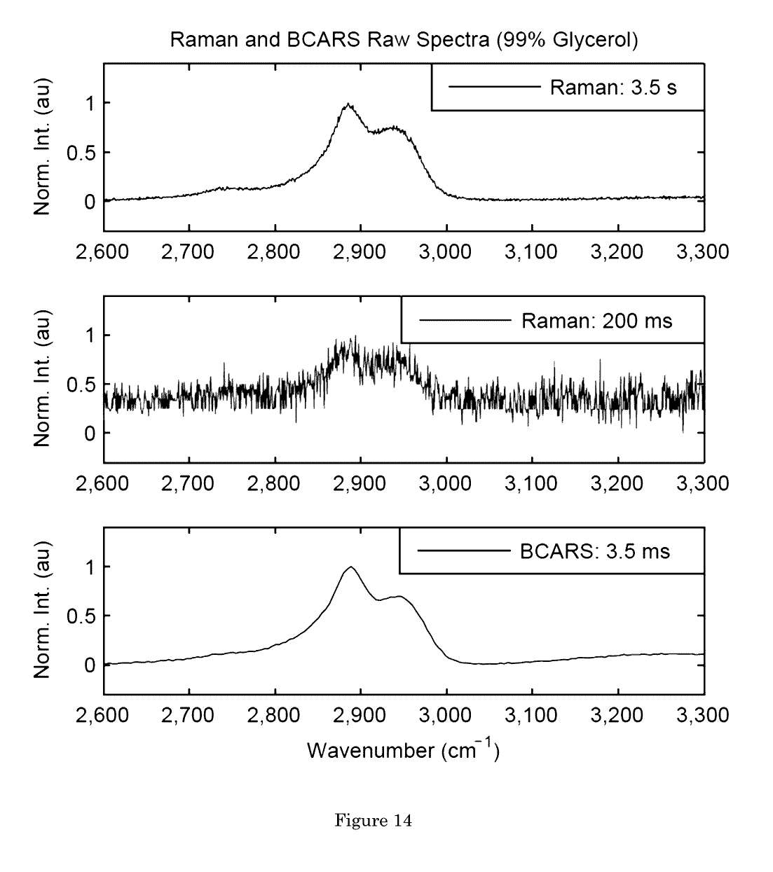

Performing the same experiment within the longer CH-/OH-stretch Raman region shows an even more dramatic separation between the techniques (FIG. 14): the sample studied by plural color broadband CARS microscope 100 contains clearly less noise than the spontaneous Raman spectra—even at 3.5 s dwell times. A contributing factor to this is the low QE of the silicon CCD detector at longer wavelengths of the inVia system. Additionally, as the raw BCARS signal intensity of fourth light 122 is proportional to the molecular concentration, N, as N²+N, there is a tremendous response from strong, dense molecular oscillators, such as those found within the CH-/OH-stretch region.

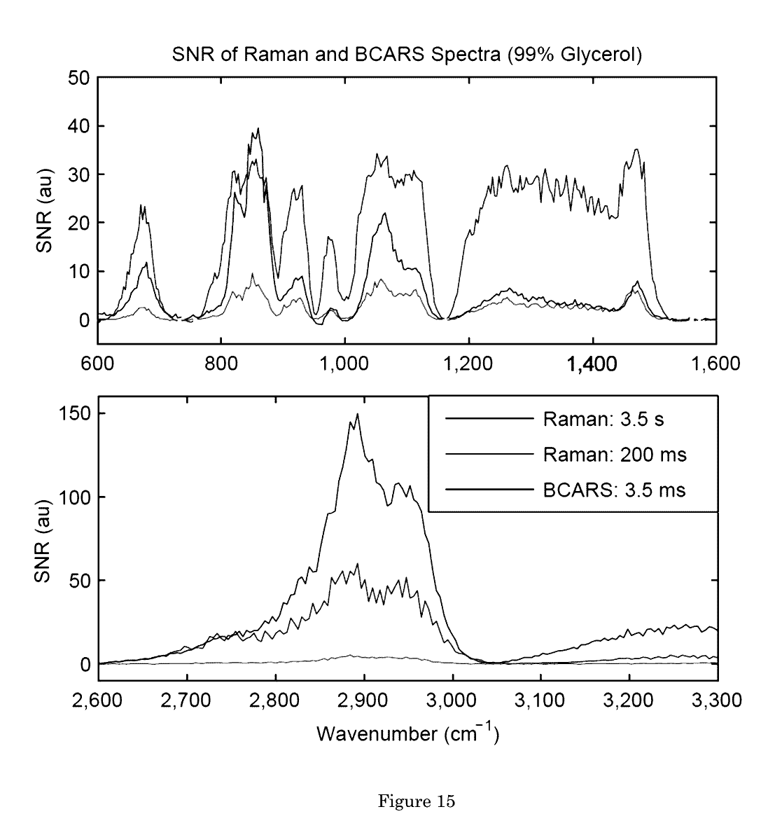

From 100 collected spectra under each experimental condition, we calculated the signal-to-noise ratio (SNR) at each Raman energy level as shown in FIG. 15. Across the fingerprint region, plural color broadband CARS microscope 100 provides an SNR greater than that collected with spontaneous Raman at 200 ms (a speed factor of 57×). These results indicate that plural color broadband CARS microscope 100 provides high-speed acquisition with high SNR.

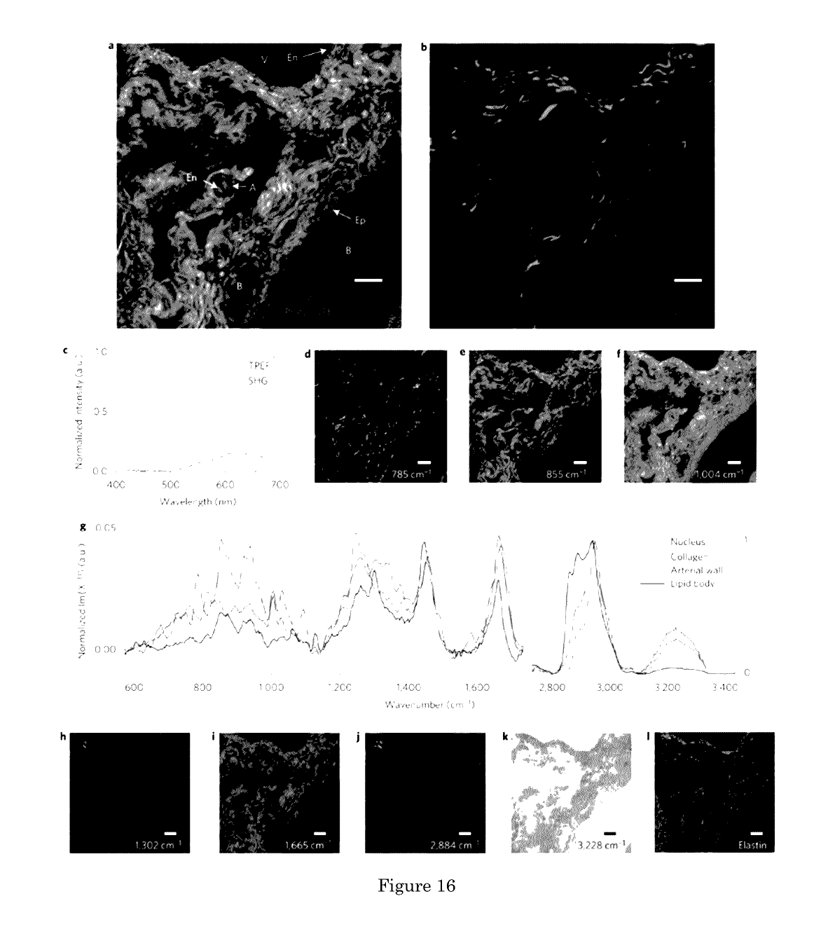

Plural color broadband CARS microscope 100 has numerous beneficial uses including analysis of biological samples, including biological tissue. To date, much histological analysis of tissues using CRI relied on limited spectral information, primarily in the strong CH/OH stretch region of the Raman spectrum (˜2,700-3,500 cm⁻¹), which plural color broadband CARS microscope 100 has overcome. Plural color broadband CARS microscope 100 can spectrally identify cellular features such as nuclei and cytoplasmic structures such as organelles. To demonstrate the sensitivity of plural color broadband CARS microscope 100 using molecular fingerprint signatures, murine liver tissue sections were imaged by plural color broadband CARS microscope 100. Panel a of FIG. 16 shows a pseudocolor image of liver tissue near a portal triad (hepatic artery, hepatic portal vein and bile duct), which was collected with 3.5 ms dwell times over a 200 μm×200 μm area (300 pixels×300 pixels). This image shows nuclei contrasted in blue, based on the Raman band at ˜785 cm⁻¹, which emanates from DNA/RNA pyrimidine ring breathing and the phosphodiester stretch. For further chemical contrast or specificity, one could use other nucleotide peaks at 668, 678, 728, 750, 829, 1,093, 1,488 or 1,580 cm⁻¹. Additionally, the peak at 830 cm⁻¹ could be used to gauge the amount of DNA in the B-conformation relative to the total genetic content, thereby providing information about the functional state of the cells. As a general protein contrast, the ring breathing contribution of phenylalanine at 1,004 cm⁻¹ is presented in green. The collagen is highlighted in red using the 855 cm⁻¹ C—C stretch from the pyrrolidine ring of proline (the C—C stretch at 938 cm⁻¹ also provides similar contrast). Prior CRI investigations of tissue have incorporated SHG and TPEF imaging to identify collagen and elastin, respectively, as shown in panel b of FIG. 16, with examples of spectra in panel c of FIG. 16. It should be noted, however, that SHG and TPEF provide uncertain chemical specificity, as other biologically relevant molecular species are also known to generate a response. Additionally, we note that Raman spectroscopy and SHG present differing contrasts for collagen, as Raman (and by extension, BCARS) is sensitive to molecular structure, but SHG is sensitive to supermolecular crystalline structure.

With this level of spatial resolution and chemical contrast, several hepatic structures are identifiable by their histology: the hepatic artery (with its circular protein-rich, collagen-poor band (e.g., smooth muscle) surrounding a thin endothelial layer and lumen), the bile ducts (lined by tightly packed cuboidal epithelial cells) and the relatively large portal vein (with its sparse endothelial layer). One can also see the connective tissue septa (primarily collagen) that enmesh the portal triad.

Although the pseudocolor image in panel a of FIG. 16 is limited to three colors, which are presented in high-contrast greyscale in panels d-f of FIG. 16, one can identify significant spectral complexity in the sample, as illustrated by the single-pixel spectra in panel g of FIG. 16. Using isolated peaks, one could create dozens of unique images based on vibrational susceptibilities, such as those shown in panels h-k of FIG. 16: 1,302 cm⁻¹(CH₂ deformation), 1,665 cm⁻¹ (amide I/C═C stretch), 2,884 cm⁻¹ (CH₂ stretch), 3,228 cm⁻¹ (O—H stretch), respectively. Additionally, a multivariate analysis of contributions from several peaks—their locations, intensities and shapes-presents significant avenues of chemical contrast. For example, panel l of FIG. 16 highlights elastin by segmenting the chemical species that have vibrations at 1,126 and 1,030 cm⁻¹ but lack vibrations at 677, 817 and 1,302 cm⁻¹, which isolates elastin from collagen and other proteins, lipids and nucleotides. Similarities and differences between the image from fourth light 122 of plural color broadband CARS microscope 100 and the TPEF image in panel b of FIG. 16, indicate that although elastin is the most abundant fluorescent molecule, multiple chemical species contribute to the TPEF signal.

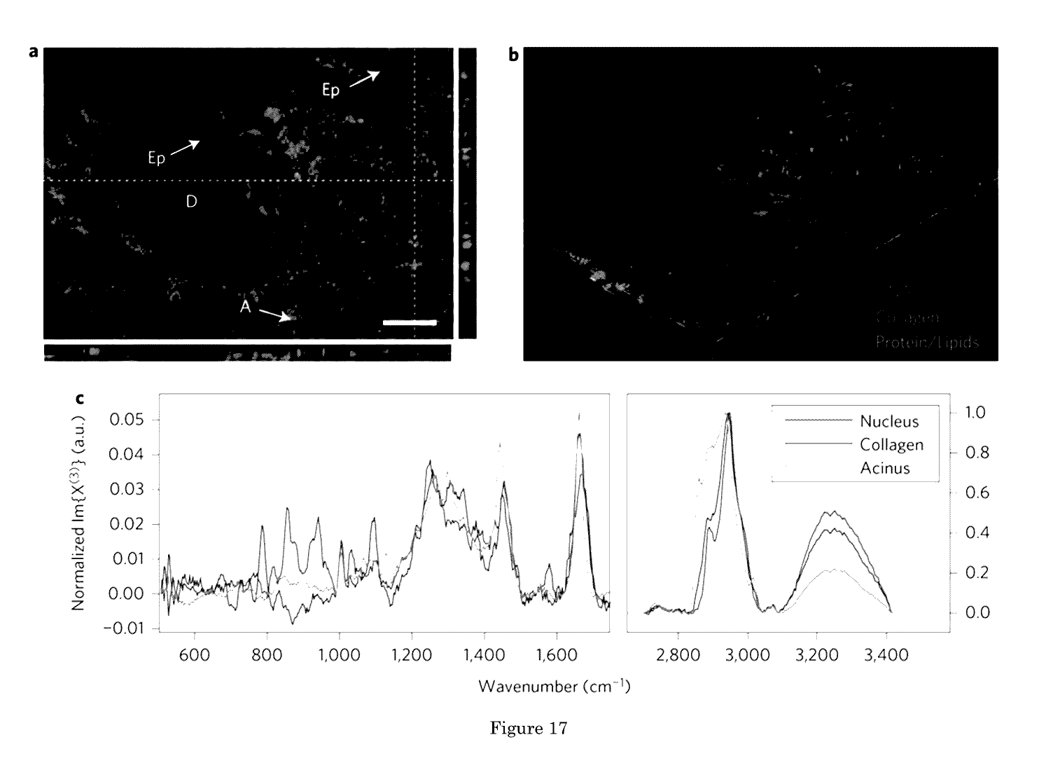

Beyond histochemical imaging in two dimensions, plural color broadband CARS microscope 100 provides nonlinear excitation in CARS for sectioning microscopy, providing generation of ‘z-stack’ images in three dimensions. Plural color broadband CARS microscope 100 provides three-dimensional microspectroscopy with BCARS with short acquisition times. Panel a of FIG. 17 is a BCARS image of murine pancreas acquired by plural color broadband CARS microscope 100, with the nuclei highlighted in blue (785 cm⁻¹), collagen in red (855 cm⁻¹), and a general contrast for lipids and protein in green (1,665 cm⁻¹: lipids, C═C stretch; proteins, amide I). This image shows a single plane from a ten-stack collection with each plane covering 150 μm×100 μm (0.667 μm lateral, 1 μm axial step size; <2 min per image). Two reconstructed axial planes are also shown. This image shows an interlobular exocrine duct surrounded by epithelial cells, the edge of a larger interlobular exocrine duct (as identified by the columnar epithelial cells), a collagen matrix and acinar cells (and the lumen separating the acini). Panel b of FIG. 17 shows the reconstructed three-dimensional image, which more clearly shows the shape, size and orientation of the individual cells and tissue constituents. Panel c of FIG. 17 shows single-pixel spectra from the nucleus of an epithelial cell, collagen and from the cytosol of an acinar cell.

For histopathological analysis, plural color broadband CARS microscope 100 provides short integration times and high spatial resolution for accurate tumor-boundary identification and early-stage tumor detection. Here, plural color broadband CARS microscope 100 provide high-speed, high-spatial-resolution imaging of normal and diseased brain tissue not limited to single or few Raman peaks. We present images of orthotopic xenograft brain tumors within a murine brain. Here, fresh murine liver and pancreas tissues were commercially procured and pre-mounted on charged glass slides. The samples were shipped on dry ice and stored at −80° C. Before imaging, the samples were thawed for 10 min, washed twice in PBS to remove debris and residual cutting media. The tissues were kept wet with PBS and a glass coverslip was placed over the sample and sealed with nail polish.

Glioblastoma cells (GCs) were isolated from primary surgical GBM biopsy specimens in accordance with protocols approved by the Duke University Medical Center or Cleveland Clinic Foundation Institutional Review Boards. In vivo tumor initiation studies were carried out with BALB/c nu/nu mice under a Cleveland Clinic Foundation Institutional Animal Care and Use Committee-approved protocol. All transplanted mice were maintained for 100 days or until development of neurological signs, at which point they were killed by CO₂ asphyxiation. Brains were removed and fixed in 4% paraformaldehyde for 24 h. Following fixation, brains were submerged in 30% sucrose as cryoprotectant for an additional 24 h. Samples were then frozen in optimal cutting temperature compound (OCT) and sectioned on a cryomicrotome to a nominal thickness of 10 μm. Before imaging, samples were thawed, washed with PBS to remove OCT and debris, then covered with a glass coverslip and sealed with nail polish.

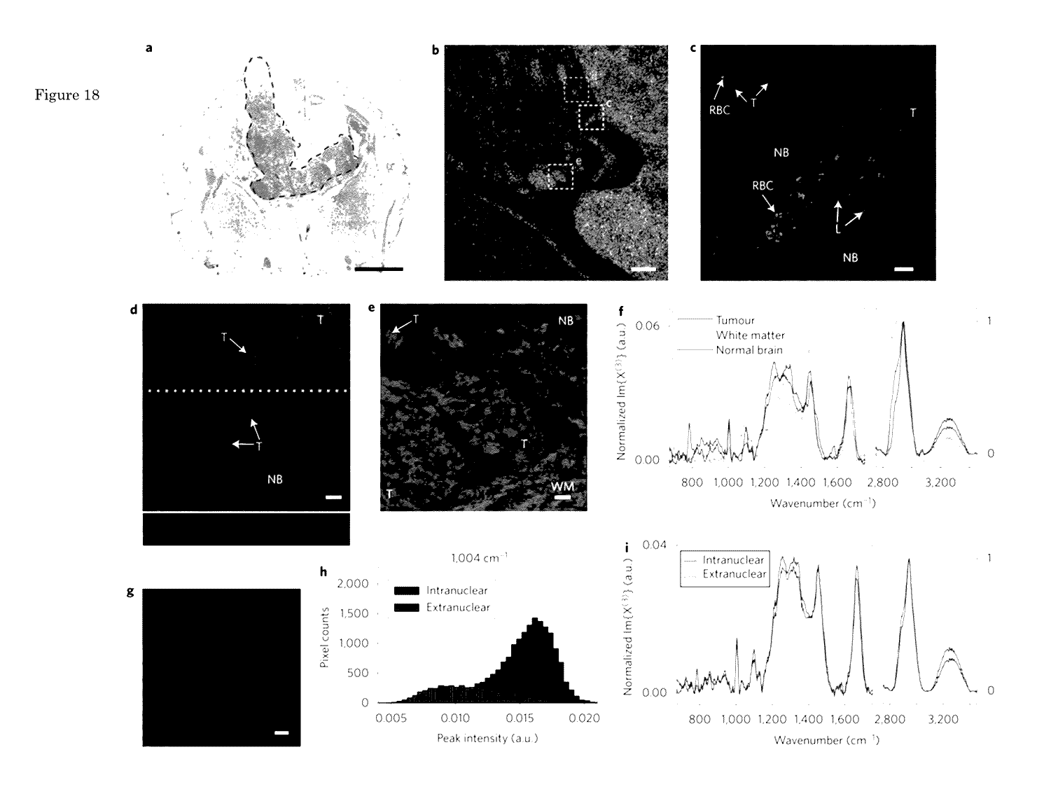

Panel a of FIG. 18 shows a brightfield image of a brain slice (10 μm nominal thickness) with an identifiable tumor mass, from which we imaged several areas (FIG. 18, panel b shows a close-up polarization micrograph of the specific imaging sites). Panel c of FIG. 18 shows a CRI image with nuclei in blue (730 cm⁻¹), lipid content in red (2,850 cm⁻¹) and red blood cells in green (1,548 cm⁻¹+1,565 cm⁻¹: C—C stretch from hemoglobin). This image clearly shows the large tumor mass and a projection of neoplastic cells within healthy tissue. Additionally, smaller tumor bodies are identifiable by their high density of distorted nuclei with high nuclear-to-cytoplasmic ratio. Panel 4d of FIG. 18 shows several small extensions of the main tumor mass invading healthy brain matter. The mesh-like appearance of the healthy tissue is probably an artefact of sectioning and the freeze-thaw cycle due to tissue density differences (see the axial scan in FIG. 18, panel d). Panel e of FIG. 18 shows the boundary between normal brain tissue (probably grey matter), white matter and tumor masses, which contrasts lipids in red (2,850 cm⁻¹); CH₃ stretch-CH₂ stretch (2,944-2,850 cm⁻¹), a general contrast; and nuclei in blue (785 cm⁻¹). The image shows the fibrous texture of the white matter and strands of myelination around cancer cell clusters. Panel f of FIG. 18 shows single-pixel spectra from an intratumoural nucleus, the white matter and normal brain. The spectra indicate lipids are most concentrated in the white matter and least in the tumor. Additionally, one sees an increase in response from phenylalanine (1,004 cm⁻¹) and an overall reduction in the lipid-protein ratio in tumor cells relative to healthy brain tissues. For further analysis, we spectrally segmented the tumor masses between intracellular regions and extracellular regions as shown in FIG. 18, panel g. Panel h of FIG. 18 shows a histogram analysis of each pixel within the tumors, indicating that the phenylalanine content is more concentrated within the nuclei, which is also indicated in the spectra in FIG. 18, panel i. Additionally, the lipid-protein ratio (2,850 cm⁻¹/1,004 cm⁻¹) is largest in normal brain matter (14.5), weakest in the intranuclear tumoral space (6.9) and intermediate in the extranuclear tumoral space (12.8).

Results from plural color broadband CARS microscope 100 had a surprising and unexpected combination of speed, sensitivity, and spectral breadth, which provides Raman imaging for widespread adoption in biological research and clinical use. Through the use of intrapulse stimulation from third light 112 in conjunction with heterodyne amplification of the small Raman signal with the strong NRB in fourth light 122, plural color broadband CARS microscope 100 provides a level of signal clarity throughout the fingerprint region at high speed of acquisition.

Further, plural color broadband CARS microscope 100 can be used for CARS microspectroscopy for biological and materials imaging with pseudocolor imagery or hyperspectral data. Furthermore, fourth light 122 acquired by plural color broadband CARS microscope 100 can be subjected to spectral processing for quantitative sample-to-sample comparability. Here, extracting Raman spectral features from fourth light 122 significantly suppresses errors through phase detrending and scaling. Justification is presented via a Kramers-Kronig relation, and these results are applicable to maximum entropy method-based phase retrieval. In an embodiment, this error-correction approach is experimentally applied to glycerol spectra and tissue images, demonstrating marked consistency between spectra obtained using different NRB estimates and spectra obtained on different instruments.

Without wishing to be bound by theory, CARS is a nonlinear scattering phenomenon in which two photons, ‘pump’ and ‘Stokes’ that are a combination of first light 104 and second light 108, coherently excite a molecular vibration. From the excited mode, a ‘probe’ photon from first light 104 inelastically scatters off as fourth light 122 with an energy increase equal to that of the vibrational state. Plural color broadband CARS microscopy provided by plural color broadband CARS microscope 100 is an optical process that is label-free and is a molecularly sensitive investigation of samples without autofluorescence competition and at significantly higher speeds than offered by traditional spontaneous Raman spectroscopy.

Plural color broadband CARS microscopy provides extraction of chemically specific Raman signal from nonresonant background NRB. NRB is predominantly composed of electronic signal contributions from other nonlinear optical phenomena that are less chemically specific. Although it is sometimes viewed as an interference, NRB amplifies the weak Raman signal, enabling high-sensitivity detection. Two classes of numerical methods can be used to remove a distortion of NRB: one based on maximizing entropy and the other using the Kramers-Kronig (KK) relation. Plural color broadband CARS microscope 100 conveniently and accurately measures NRB through acquisition of fourth light 122.

Plural color broadband CARS microscopy includes a process for processing CARS spectra that suppresses errors resulting from use of an inexact reference NRB spectra, removing baseline fluctuations and generating spectra that are agnostic to the reference material used. Use of KK presents analytical expressions for correcting these errors, and these results are also applicable to a maximum entropy method (MEM). Plural color broadband CARS microscopy provides extraction of pre-processed spectra that are universally comparable in amplitude and shape for dissemination as a currency for coherent Raman imaging data.

Classically, CARS spectral intensity I_{CARS} is provided as:

I_{CARS}(ω)∝|∫∫∫χ⁽³⁾(ω)Eₚ(ωₚ)E_{S}*(ω_{S})Eₚᵣ(ωₚᵣ)×δ(ω−ωₚ+ω_{S}−ωₚᵣ)dωₚdω_{S}dωₚᵣ)|² (30)

where χ⁽³⁾ is the nonlinear susceptibility of the sample; Ep, ES, and Epr are the pump (corresponding to first light 104 or second light 108, depending on interpulse or intrapulse stimulation), Stokes (corresponding to second light 108), and probe (corresponding to first light 104) field amplitudes, within the frequency spaces, ωp, ωS, and ωpr, respectively; and the delta function ensures energy conservation. This equation is re-written as:

$$\begin{matrix}{I}_{CARS} ( ω ) ∝ \vert \{ {[ {E}_{S} ( ω ) * {E}_{p} ( ω ) ]}_{\begin{matrix}⏟ \\ {C}_{M} ( ω )\end{matrix}} {χ}^{( 3 )} ( ω ) \} * {E}_{pr} ( ω ) {\vert}^{2} & ( 31 ) \\ \underline{\approx } \vert {\tilde{C}}_{st} ( ω ) {\vert}^{2} \vert {\tilde{X}}^{( 3 )} ( ω ) {\vert}^{2} & ( 32 )\end{matrix}$$

where * and * are the cross-correlation and convolution operations, respectively, and Cst is the coherent stimulation profile. Equations 30 and 31 are mathematically equivalent. If we assume a spectrally narrow probe source, we can introduce an ‘effective’ stimulation profile, \tilde{C}ₛₜ, and nonlinear susceptibility, \hat{χ}⁽³⁾, as presented in Eqn 32, where Ċₛₜ(ω)≡[Cₛₜ(ω)*Eₚᵣ(ω)]/∫Eₚᵣ(ω)dω and \hat{ψ}⁽³⁾(ω)≡χ⁽³⁾(ω)*Eₚᵣ(ω).

The nonlinear susceptibility describes signal contributions to fourth light 122 from Raman vibrationally resonant, χ_{R}, and vibrationally nonresonant, χ_{NR}, sources: χ⁽³⁾(ω)=χ_{R}(ω)+χ_{NR}(ω). To a first degree approximation, spontaneous Raman spectra, I_{Raman}, are related to the vibrationally resonant component of the CARS spectra as I_{Raman}(ω)∝Im{ω_{R}(ω)}, where ‘Im’ indicates the imaginary component. The purpose of phase retrieval is to ascertain a phase, φ(ω), that isolates the Raman resonant components from the total nonlinear susceptibility.

With regard to phase retrieval using the Kramers-Kronig relation, the KK relation states that there is an explicit relationship between the real and imaginary components of a function, ƒ(ω), that is causal (analytic); thus, if only the real (or imaginary) part is known, the imaginary (or real) part can be calculated. In CARS and other spectroscopies, neither the real nor imaginary portion of χ⁽³⁾ is accessible (n.b.: \tilde{C}ₛₜ in Eqn 32 is not a causal function). If the function is square integrable, there also exists an explicit relationship between the complex norm of the function and the phase:

ln|ƒ(ω)|=− [symbol] {φ(ω)} (33)

φ(ω)= [symbol] (ln|ƒ(ω)|) (34)

where [symbol] is the Hilbert transform. The CARS spectral recording window can be limited so introduce a windowed Hilbert transform, [symbol] w, as follows:

$$\begin{matrix}{\tilde{ℋ}}_{W} \{ f ( x ) ; {ω}_{a} , {ω}_{b} \} = \frac{𝒫}{π} {\int }_{{ω}_{a}}^{{ω}_{b}} \frac{𝒻 ( {x}^{′} )}{x - {x}^{′}} d {x}^{′} & ( 35 ) \\ {lim}_{\begin{matrix}{ω}_{a} \to - ∞ \\ {ω}_{b} \to ∞ \end{matrix}} {\tilde{ℋ}}_{W} \{ f ( x ) ; {ω}_{a} , {ω}_{b} \} = \tilde{ℋ} \{ f ( x ) \} & ( 36 )\end{matrix}$$

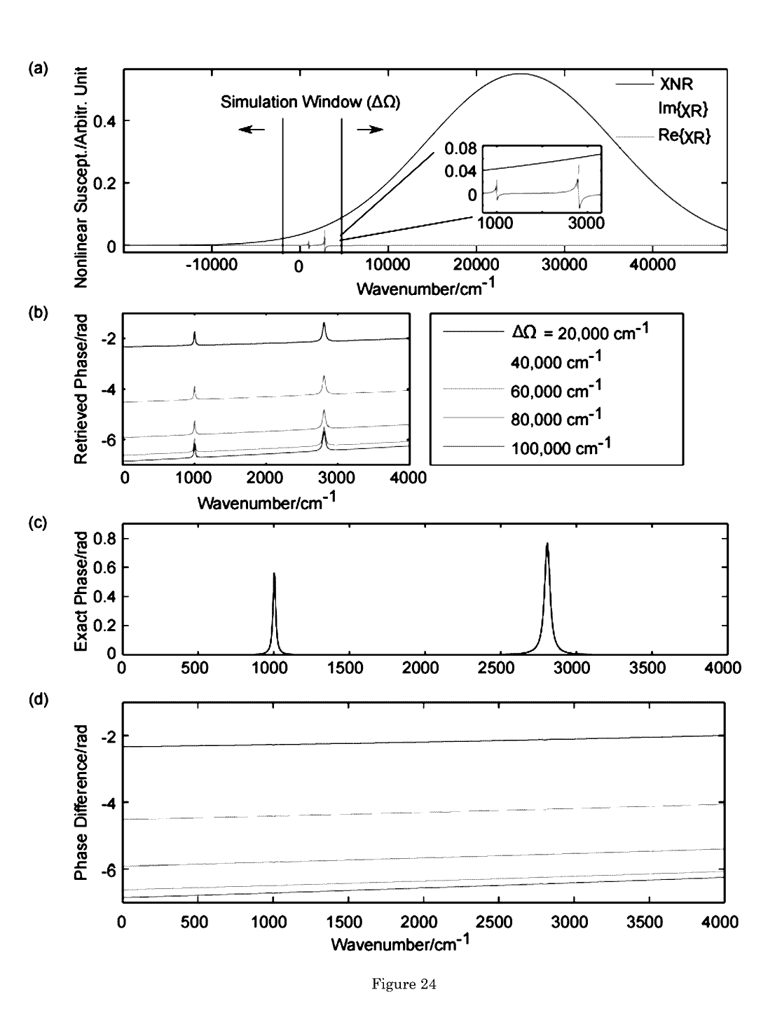

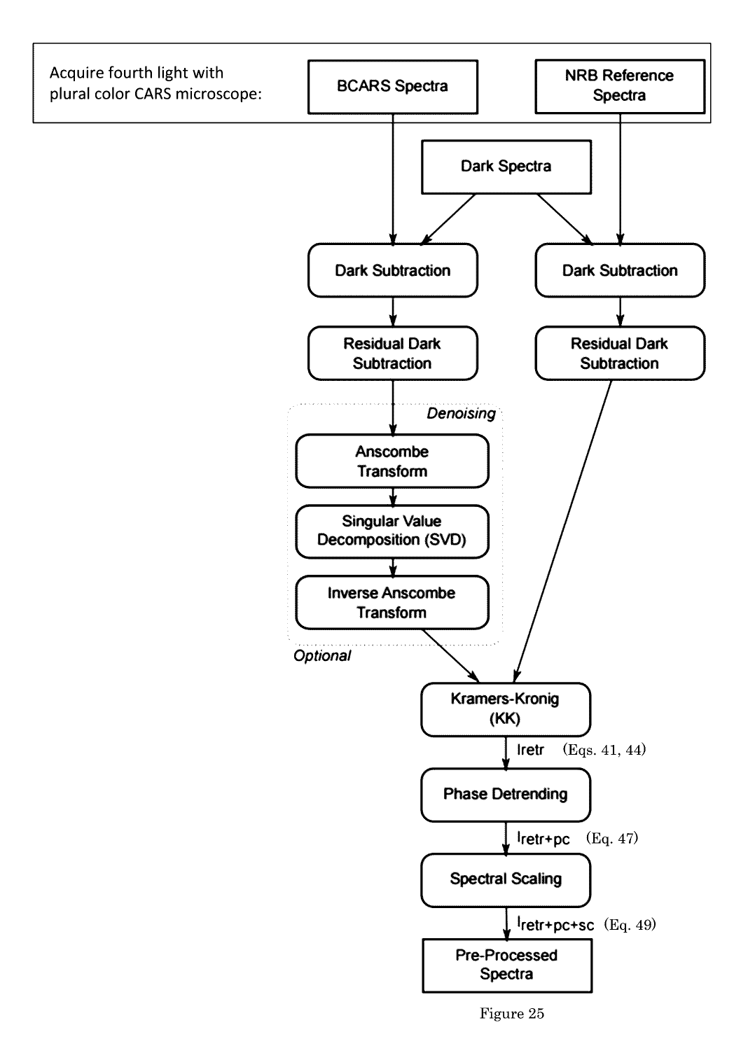

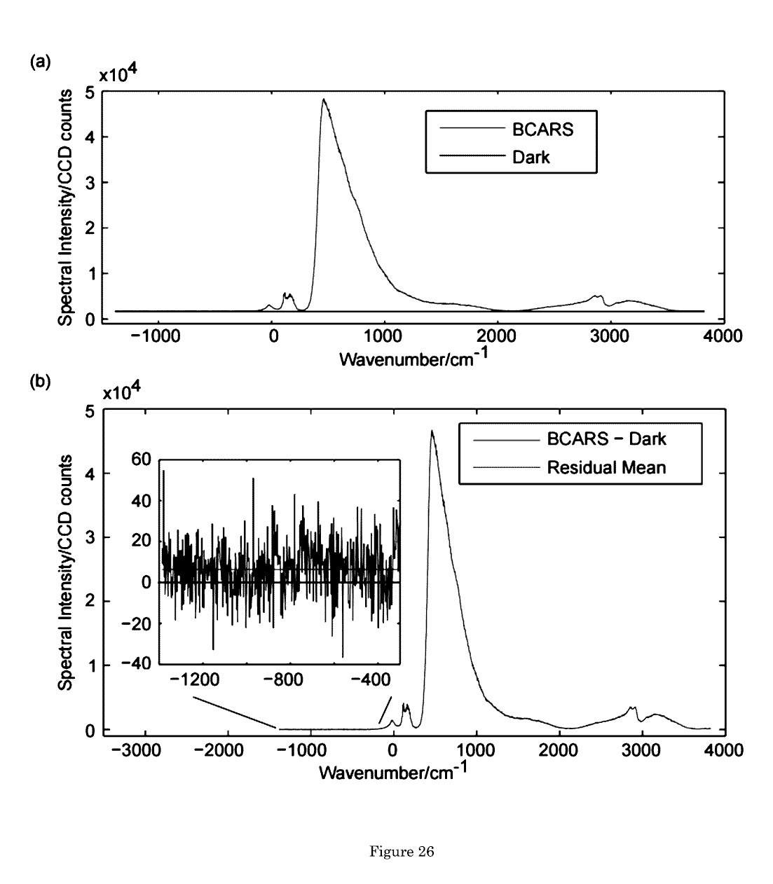

which is limited to the spectral range ωₐ to ω_{b} (for compactness, these parameters will be neglected from the operator form). [symbol] is the Cauchy principle value. Under the conditions that (1) the Raman peaks encompassed within this window are not affected by those outside of the window and (2) any resonances of χ_{NR} are far removed from those of χ_{R}, the windowed and analytic Hilbert transform is related as

$${\tilde{ℋ}}_{W} \{ \frac{1}{2} ln \vert {\tilde{χ}}^{( 3 )} ( ω ) {\vert}^{2} \} \approx \tilde{ℋ} \{ \frac{1}{2} ln \vert {\tilde{χ}}^{( 3 )} ( ω ) {\vert}^{2} \} + ɛ ( ω ) \qquad ( 37 )$$

where ε(ω) is an additive error term (see FIG. 24 demonstrating the additive nature). Applying Eqns 34 and 37 to Eqn 32, the retrieved phase from the raw CARS spectrum, φCARS, may be described as

$$\begin{matrix}{φ}_{CARS} ( ω ) = {\hat{ℋ}}_{W} \{ \frac{1}{2} ln {I}_{CARS} ( ω ) \} \approx ɛ ( ω ) + {\hat{ℋ}}_{W} \{ \frac{1}{2} ln \vert {\tilde{C}}_{st} ( ω ) {\vert}^{2} \} + \hat{ℋ} \{ \frac{1}{2} \vert {\tilde{χ}}^{( 3 )} ( ω ) {\vert}^{2} \} & ( 38 ) \\ = ɛ ( ω ) + {\hat{ℋ}}_{W} \{ \frac{1}{2} ln \vert {\tilde{C}}_{st} ( ω ) {\vert}^{2} \} + ∠ [ {χ}_{R} ( ω ) + {χ}_{NR} ( ω ) ] & ( 39 )\end{matrix}$$

where ∠ denotes the angle (phase). The retrieved phase is not simply that of the nonlinear susceptibility but also contains contributions from the windowing error and the effective stimulation profile (\tilde{C}ₛₜ). In measuring the NRB spectrum, INRB, without Raman components and assuming that the spectrum is far removed from electronic resonances such that χ_{NR} is approximately real, the following phase retrieval can be used in lieu of Eqn 39:

$${φ}_{CARS \text{/} NRB} ( ω ) = {\hat{ℋ}}_{W} \{ \frac{1}{2} ln \frac{{I}_{CARS} ( ω )}{{I}_{NRB} ( ω )} \} \approx ɛ ( ω ) + {\hat{ℋ}}_{W} \{ \frac{1}{2} ln \vert {\tilde{C}}_{st} ( ω ) {\vert}^{2} \} - [ ɛ ( ω ) + {\hat{ℋ}}_{W} \{ \frac{1}{2} ln \vert {\tilde{C}}_{st} ( ω ) {\vert}^{2} \} ] + ∠ [ {χ}_{R} ( ω ) + {χ}_{NR} ( ω ) ] - {∠χ}_{NR} ( ω ) \approx ∠ [ {χ}_{R} ( ω ) + {χ}_{NR} ( ω ) ] \qquad ( 40 )$$

which is analogous to applying the KK relation to I_{CARS}/I_{NRB}. Using this ratio as our signal, the retrieved complex spectrum, Iᵣₑₜᵣ, is

$${I}_{retr} ( ω ) = \sqrt{\frac{{I}_{CARS} ( ω )}{{I}_{NRB} ( ω )}} exp {iφ}_{CARS \text{/} NRB} \approx \frac{\vert {\tilde{χ}}^{( 3 )} ( ω ) \vert}{\vert {\tilde{χ}}_{NR} ( ω ) \vert} exp i ∠ [ {χ}_{R} ( ω ) + {χ}_{NR} ( ω ) ] \qquad ( 41 )$$

and the Raman-like spectrum, i.e., Im.{Iretr}, is

$$Im \{ {I}_{retr} ( ω ) \} \approx \frac{Im \{ {χ}_{R} ( ω ) \}}{\vert {χ}_{NR} \vert} \qquad ( 42 )$$

thus, the Raman-like spectrum is proportional to the spontaneous Raman spectrum scaled by the nonresonant component. KK relation results using \sqrt{I_{CARS}} sin_{φCARS/NRB} are directly proportional to the spontaneous Raman spectrum but implicitly assume that \tilde{C}ₛₜ(ω) is constant and do not account for ε(ω). The following paragraphs present ramifications of when NRB of the sample is not directly measurable, and the analysis, in view of the derivations in Eqns 37 through 42, provide a direct method for analyzing fourth light 122 from plural color broadband CARS microscope 100 to account and correct for these errors.

With regard to errors from inaccurate NRB measurement, measuring the NRB is technically challenging, and the difference between the NRB and a reference measurement does not lead to an additive error but rather a multiplicative complex error. Here, reference measurement, I_{ref}, is acquired as a surrogate for a proper NRB measurement. Here, I_{ref}(ω)=ξ(ω)I_{NRB}(ω), and ξ(ω) is assumed to be real and positive. By applying Eqn 40,

$${φ}_{CARS \text{/} ref} ( ω ) = {φ}_{CARS \text{/} NRB} ( ω ) + {{\hat{ℋ}}_{W} \{ \frac{1}{2} ln \frac{1}{ξ ( ω )} \}}_{\begin{matrix}⏟ \\ {φ}_{err} ( ω )\end{matrix}} \qquad ( 43 )$$

the Raman-like spectrum (Eqn 42) is

$$Im \{ {I}_{retr} ( ω ) \} = {\sqrt{\frac{1}{ξ ( ω )}}}_{\begin{matrix}⏟ \\ {A}_{err} ( ω )\end{matrix}} \sqrt{\frac{{I}_{CARS} ( ω )}{{I}_{NRB} ( ω )}} sin [ {φ}_{CARS \text{/} NRB} ( ω ) + {φ}_{err} ( ω ) ] \qquad ( 44 )$$

From Eqns 43 and 44, the use of a reference measurement leads to both amplitude (Aₑᵣᵣ) and phase (φₑᵣᵣ) distortions. Accordingly, removing these errors is not simply a matter of subtraction. The phase error, however, is additive in nature and connected to the amplitude error via the KK relation:

ln Aₑᵣᵣ(ω)=− [symbol] [φₑᵣᵣ(ω)] (45)

φₑᵣᵣ(ω)= [symbol] [ln Aₑᵣᵣ(ω] (46)

There is, however, an ambiguity in this relationship. If ξ(ω) is multiplied by a constant, Ξ:φₑᵣᵣ(ω)= [symbol] {ln 1/Ξξ(ω)}= [symbol] {ln 1/ξ(ω)}, because the Hilbert transform of a constant is zero.

With regard to correcting phase error and scale, a purpose of correcting for Raman signature extraction errors is to generate qualitatively accurate spectra that are quantitatively reliable, facilitating direct comparison and analysis of spectra collected of different samples with potentially different reference materials and on various spectroscopic systems having different excitation profiles. The use of a reference NRB that only approximates the nonresonant response of the material induces amplitude and phase distortions. Additionally, commonly used methods of subtracting baseline fluctuations do not remove the errors because the nature of the error is complex valued, and the amplitude error is multiplicative.

Properly correcting for signal extraction error from fourth light 122 includes: removing phase error via phase detrending; correcting for part of the amplitude error via the KK relation; and correcting scaling error (involving Ξ) and the error from the windowed Hilbert transform (of φₑᵣᵣ) via unity centering of the real component of the retrieved (phase corrected) spectrum.

As displayed in Eqn 43, the difference between the ideal phase retrieval (in which the NRB of the sample is exactly known) and that using a model material is φₑᵣᵣ, which is additive. The retrieved phase (ideal) is qualitatively similar to Raman-like spectra in that the spectral features are peaks that extend positively from a zero baseline. A slowly varying phase error will cause a slowly varying deviation from the zero baseline. Finding φₑᵣᵣ, therefore, is a matter of isolating the erroneous baseline. From this extracted φₑᵣᵣ, using Eqn 45, one can find the amplitude error. With these variables in hand, one can multiply the retrieved complex spectrum by a complex phase-correction multiplier, generating a phase-corrected (complex) retrieved spectrum, I_{retr+pc}:

$${I}_{retr + pc} ( ω ) = \sqrt{\frac{{I}_{CARS} ( ω )}{{I}_{ref} ( ω )}} exp [ i {φ}_{CARS \text{/} ref} ( ω ) ] \{ \frac{1}{exp [ - \hat{ℋ} \{ {φ}_{err} ( ω ) \} ]} exp [ - i {φ}_{err} ( ω ) ] \} \qquad ( 47 )$$

The calculated Aₑᵣᵣ is accurate to within a constant multiplier. Additionally, the Hilbert transform in Eqn 47 is a windowed Hilbert transform; thus, [symbol] {φₑᵣᵣ(ω)}= [symbol] W{φₑᵣᵣ(ω)}+εₑᵣᵣ(ω), where εₑᵣᵣ is a window-effect error term similar to that introduced in Eqn 37.

To finalize the error correction, one needs to account for the Aₑᵣᵣ ambiguity and εₑᵣᵣ. Both of these quantities are discoverable by analyzing the real component of the phase-corrected spectrum in Eqn 47 because the real component of Eqn 41 is unity centered, i.e., (|\hat{ψ}⁽³⁾|/∥\hat{ψ}_{NR}|cos_{φCARS/NRB})=1. The existence of Ξ, however, will alter the mean; thus, one could calculate the mean of the real component of the retrieved spectrum and normalize the real and imaginary components by this value. εₑᵣᵣ, however, may impart a frequency-dependent component to this mean. Using numerical means, though, one can find a slowly varying centerline and normalize the phase-corrected spectrum, thus removing Ξ and εₑᵣᵣ in one step (we refer to this process as ‘scaling’). Assuming that this centerline can be found, a scaled, phase-corrected, complex retrieved spectrum I_{retr+pc+sc}(ω) may be calculated:

$$\begin{matrix}{I}_{retr + pc + sc} ( ω ) = \frac{{I}_{retr + pc} ( ω )}{〈 Re \{ {I}_{retr + pc} ( ω ) \} 〉 ( ω )} & ( 48 ) \\ = \frac{\vert {\tilde{χ}}^{( 3 )} ( ω ) \vert}{\vert {\tilde{χ}}_{NR} ( ω ) \vert} exp i {φ}_{CARS \text{/} NRB} ( ω ) & ( 49 )\end{matrix}$$

where we have noted the frequency dependence of the mean line in the denominator of Eqn 48. Comparison of Eqns 41 and 49 shows that using the prescribed steps, one can retrieve the same spectrum using a reference NRB as if the NRB were measurable, i.e., a fully corrected spectrum.

In an embodiment, CARS microspectroscopy using plural color broadband CARS microscope 100 was performed to acquire and CARS spectra. In order to demonstrate that properly retrieved spectra can be essentially identical, irrespective of instrumentation, some spectra were collected on a comparative instrument. Plural color broadband CARS microscope 100 excites molecular vibrations more efficiently with the highest response at the lowest wavenumbers, whereas traditional systems excite most Raman transitions with relatively uniform response. For plural color broadband CARS microscope 100 used here, a total average incident power was <25 mW (3.5 ms integration time) and for the traditional system, <6 0 mW (7.8 ms integration time).

With regard to CARS simulations, CARS simulation software was developed and numerically implemented Eqn 31 directly. Excitation sources (e.g., first light 104 and second light 108 in third light 112) were simulated as real Gaussian functions, and the Raman response (in fourth light 122) a complex Lorentzian (damped harmonic oscillator) as

$${χ}_{R} ( ω ) = {\sum }_{m} \frac{{A}_{m}}{{Ω}_{M} - ω - {∠Γ}_{m}} \qquad ( 50 )$$

where Aₘ, Ωₘ, and Γₘ are the amplitude (multiplier), wavenumber, and half-width of the m^{th} Raman peak.

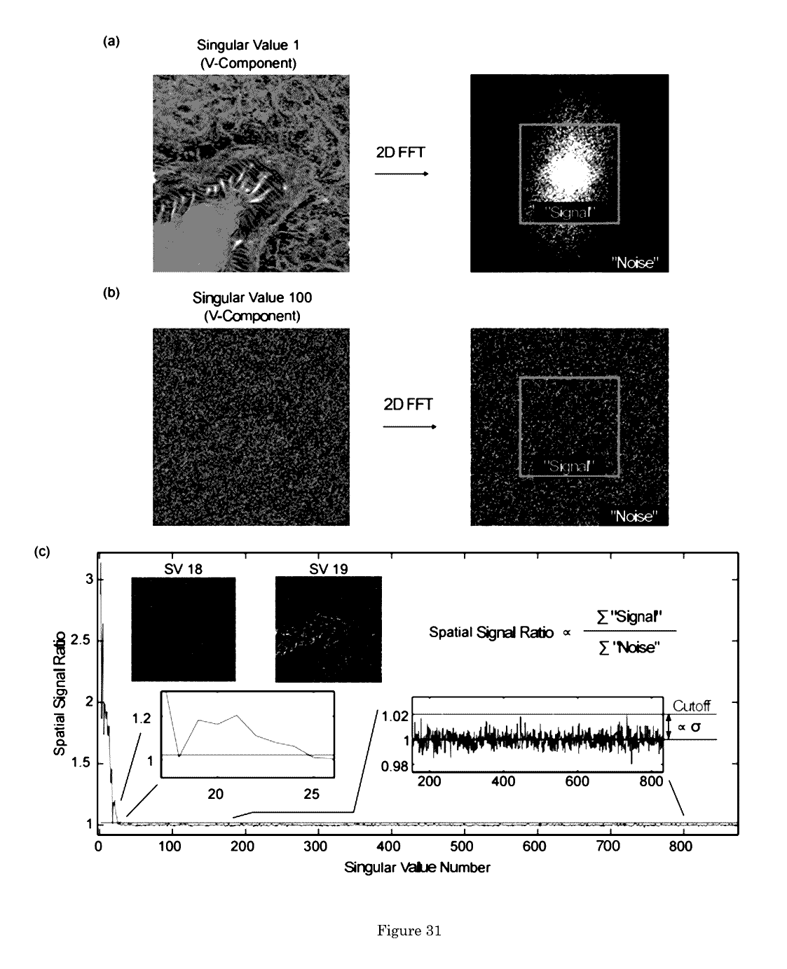

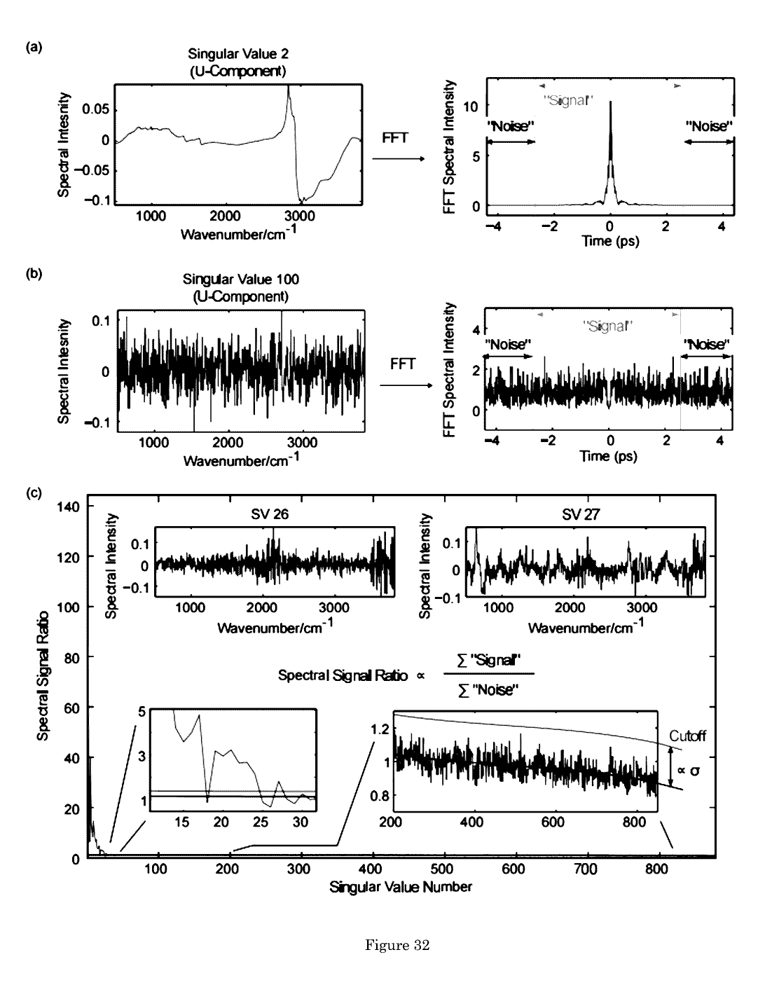

With regard to signal pre-processing, image and spectral processing was performed, wherein dark spectra were collected as were NRB spectra from reference materials (e.g., a glass coverslip, glass microscope slide, or water). Singular value decomposition (SVD) was used for noise reduction of BCARS hyperspectral data on Anscombe transformed spectra. The Anscombe transform normalizes the noise variance, accounting for mixed Poisson-Gaussian noise. Pertinent singular values are selected by noise analysis in the spectral and spatial domains in an automated or semi-automated fashion (FIG. 31 and FIG. 32). Once SVD is performed, the variance-stabilized, noise-reduced spectra are returned to their normal mixed-noise state using an optimized, generalized inverse Anscombe transformation.

Raman-like spectra are retrieved using the Hilbert transform implementation of the KK relation (described later). The erroneous component of the retrieved phase is found in an automated fashion using an asymmetric least squares technique with a Whittaker smoother. Phase and partial amplitude correction is performed as described in Eqn 47. To determine the mean trend line for final spectral correction (Eqn 48), a Savitzky-Golay filter is utilized.

With regard to phase retrieval using the Hilbert transform, the Hilbert transform (Eqn 35) is implemented in the time domain (t):

[symbol]

w[ƒ(ω)]= [symbol] {i sgn(t) [symbol] ⁻¹[ƒ(ω)]} (51)

where [symbol] and [symbol] ⁻¹ are the Fourier and inverse Fourier transforms, respectively, sgn(t) is the signum (‘sign’) function, and ƒ(ω) is a spectrally dependent function (e.g., I_{CARS}/I_{ref}). Additionally, we implement a spectral padding procedure to extend the window range, reducing numerical edge effects. This method efficiently retrieves phase with two Fourier transforms and can use parallel processing. One hundred parallel solutions, e.g., with each spectrum containing 1000 spectral points require ˜200 μs per spectrum on a personal computer (16-GB RAM, 3.4-GHz quad-core processor).

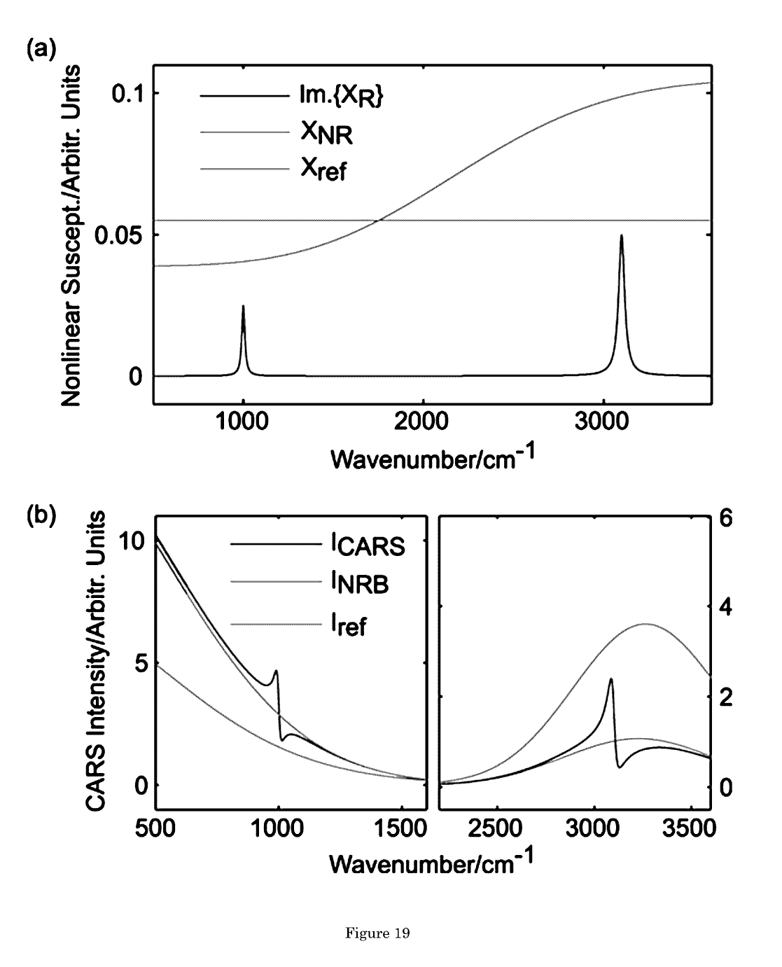

Simulated spectra were made. To validate the presented theory on phase retrieval and error correction, begin with the simplified case of a two-peak Raman system with parameters (Eqn 50): A₁=0.25, Ω₁=1000 cm⁻¹, Γ₁=10 cm⁻¹, A₂=1, Ω₂=3100 cm⁻¹, and Γ₂=20 cm⁻¹). χ_{NR}=0.55, and χ_{ref} is χ_{NR} multiplied by a Gaussian function. The simulated nonlinear susceptibilities are presented in FIG. 19, panel a. The CARS spectra that result from these susceptibilities are shown in FIG. 19, panel b.

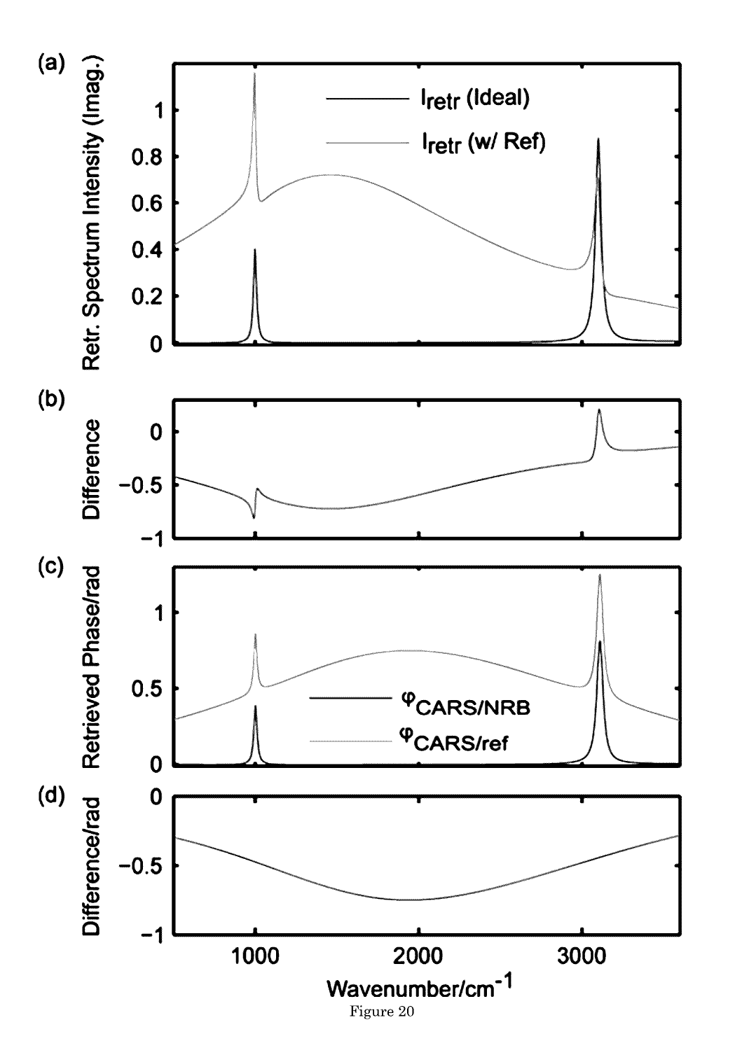

FIG. 20 (panel a) shows the retrieved spectra from fourth light 122 using a reference or the actual NRB (‘ideal’). The reference-retrieved spectrum shows a clear, large baseline and distorted (asymmetric) peak shapes. Additionally, the peak amplitudes are sufficiently perturbed that the 1000 cm⁻¹ peak appears ˜50% larger than the 3100 cm⁻¹, although the latter should be the larger of the two. FIG. 20 (panel b) shows the difference between the ideal and nonideal retrieved spectra. From this, one can gather that the traditional tactic of baseline detrending will resolve the slowly varying baseline, but the underlying peak errors (amplitude and phase) will remain. FIG. 20 (panel c) shows the phase retrieved under ideal and nonideal conditions, which does not display any obvious peak distortions. As clearly presented from the difference of the retrieved phases (FIG. 20, panel d), there is no spectral distortion of the Raman peaks but the slowly varying baseline (φₑᵣᵣ in Eqn 43).

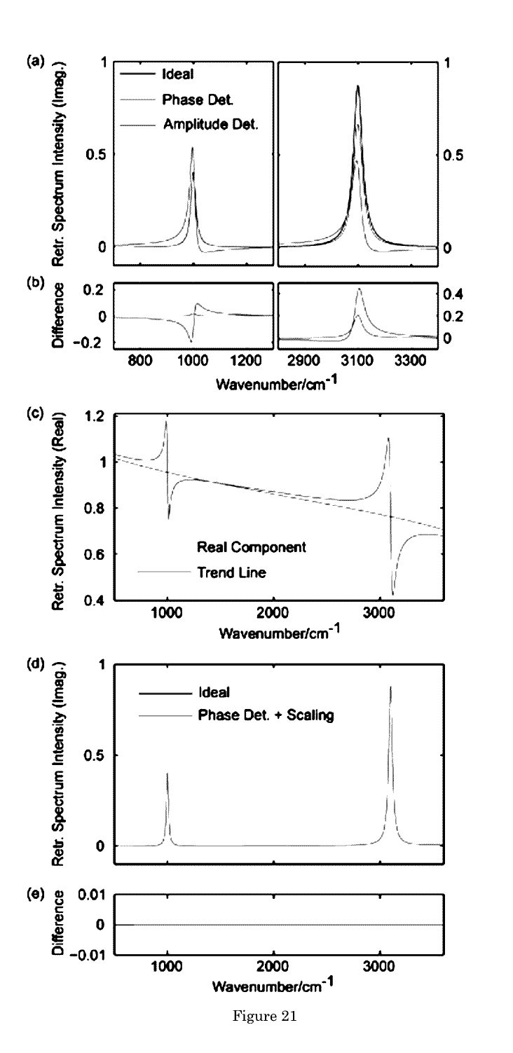

Using this phase error and applying a calculated amplitude correction (Eqn 47), the baseline and asymmetric spectral distortions are removed entirely, as shown in FIG. 21 (panel a) (differences shown in FIG. 21, panel b). For reference, a traditional amplitude detrending is also displayed, showing the remaining distortions clearly. Although the phase-corrected spectrum is qualitatively similar to the ideal, the relative amplitudes of the two peaks are still incorrect, owing to εₑᵣᵣ and the amplitude ambiguity described previously. FIG. 21 (panel c) shows the real part of the phase-corrected spectrum and the mean trend line that deviates from unity. Using this trend as a scaling factor (Eqn 48), FIG. 21 (panel d) demonstrates that the phase-corrected spectrum is now identical to the ideal retrieval (difference shown in FIG. 21 (panel e).

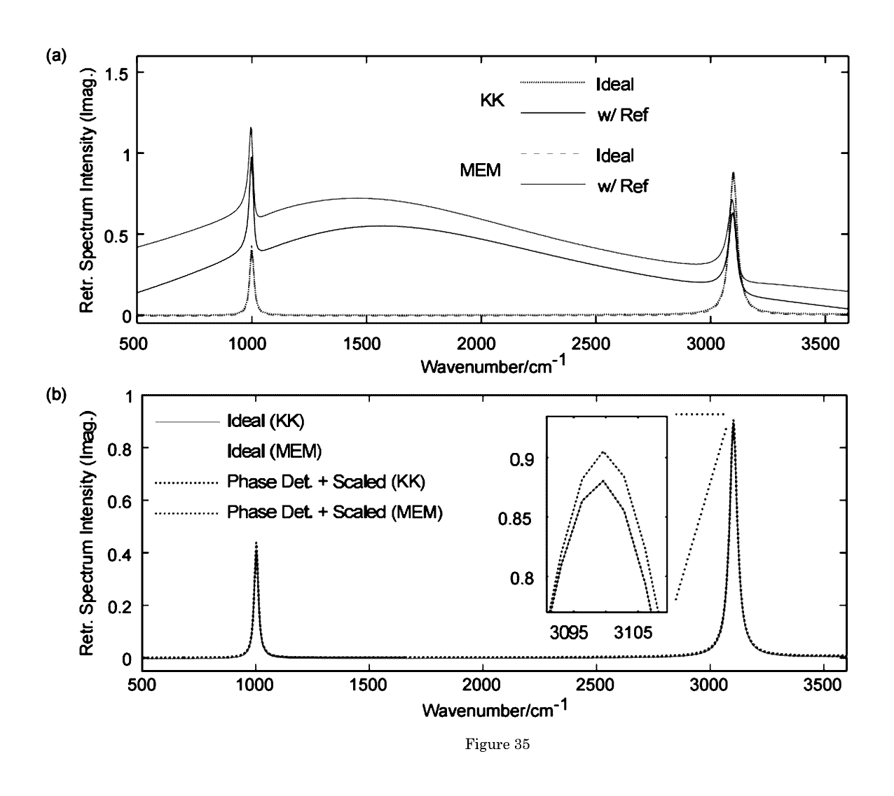

The KK and MEM phase retrieval methods are functionally equivalent, and FIG. 35 demonstrates the applicability of the presented phase error correction method to Raman-like spectra extracted from simulated BCARS spectra via the MEM method. Like the aforementioned KK demonstration, the prescribed method enables a reference NRB spectrum to be utilized and generates a corrected Raman-like spectrum that is equivalent to one extracted when the NRB is exactly known.

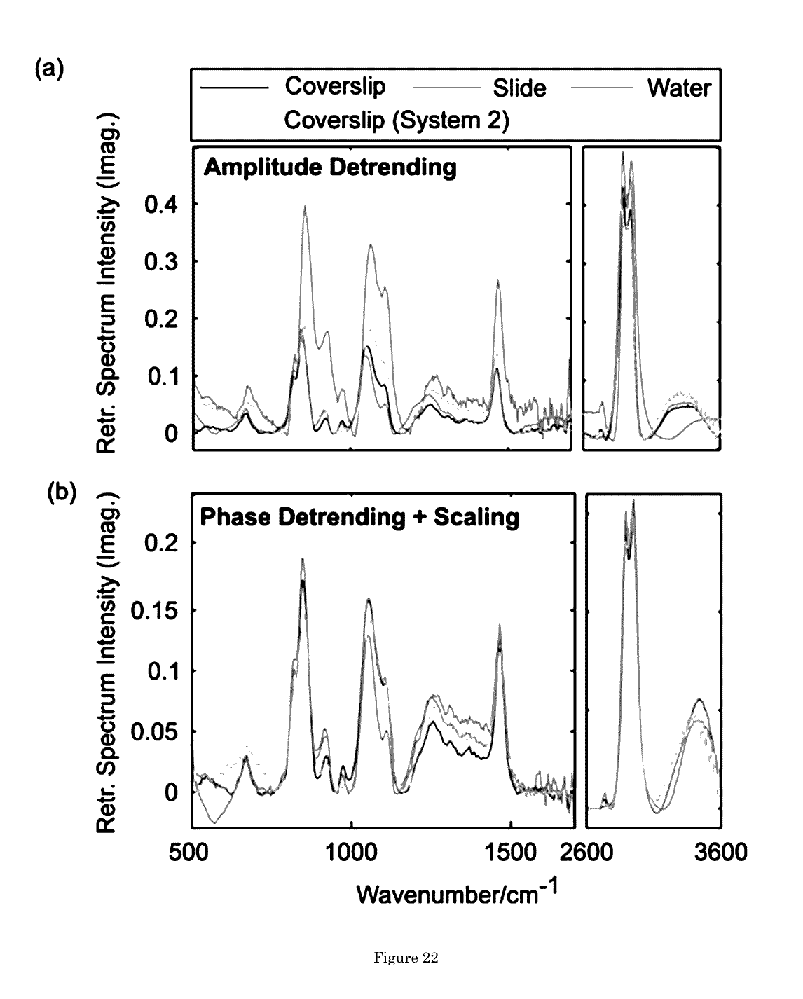

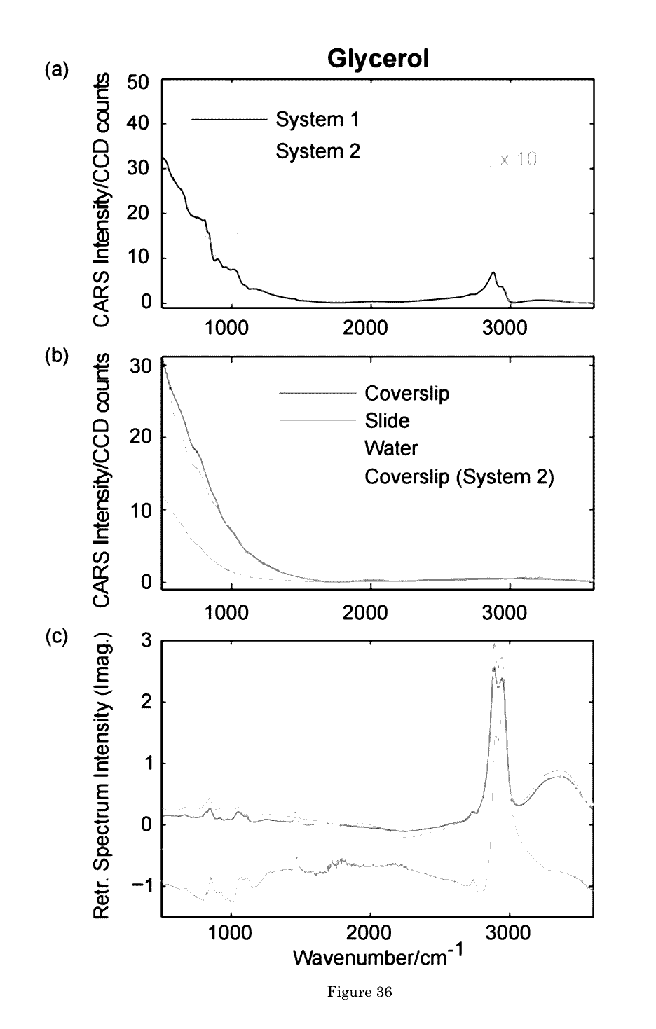

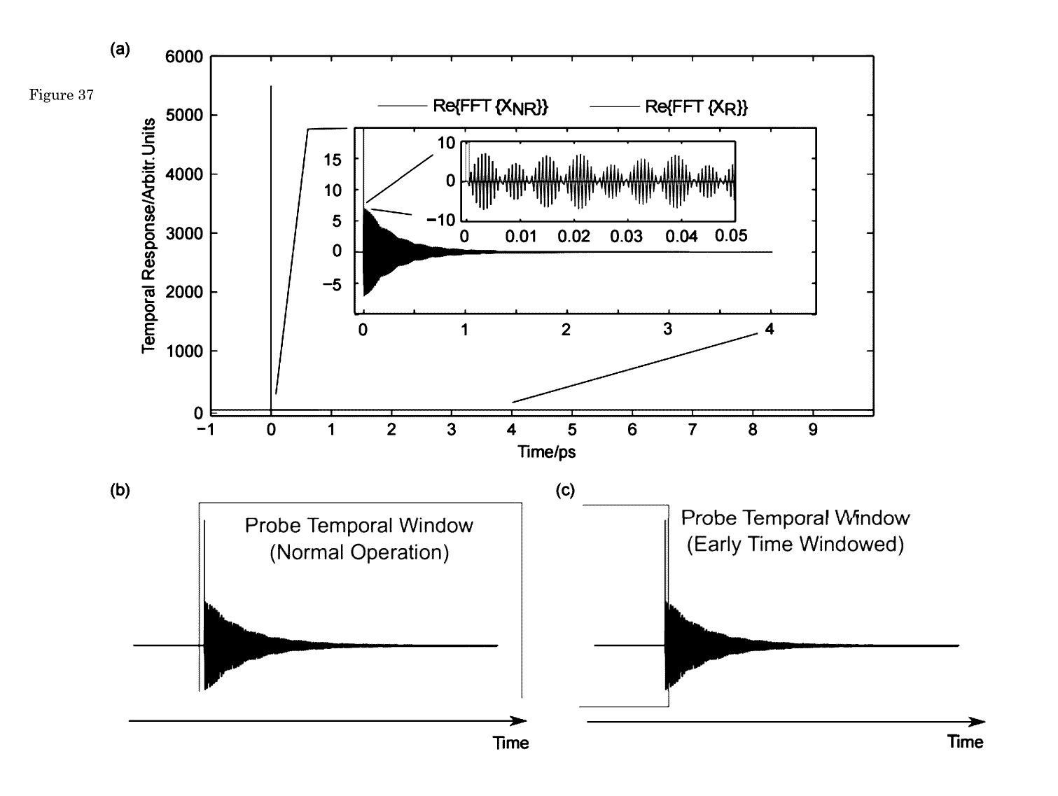

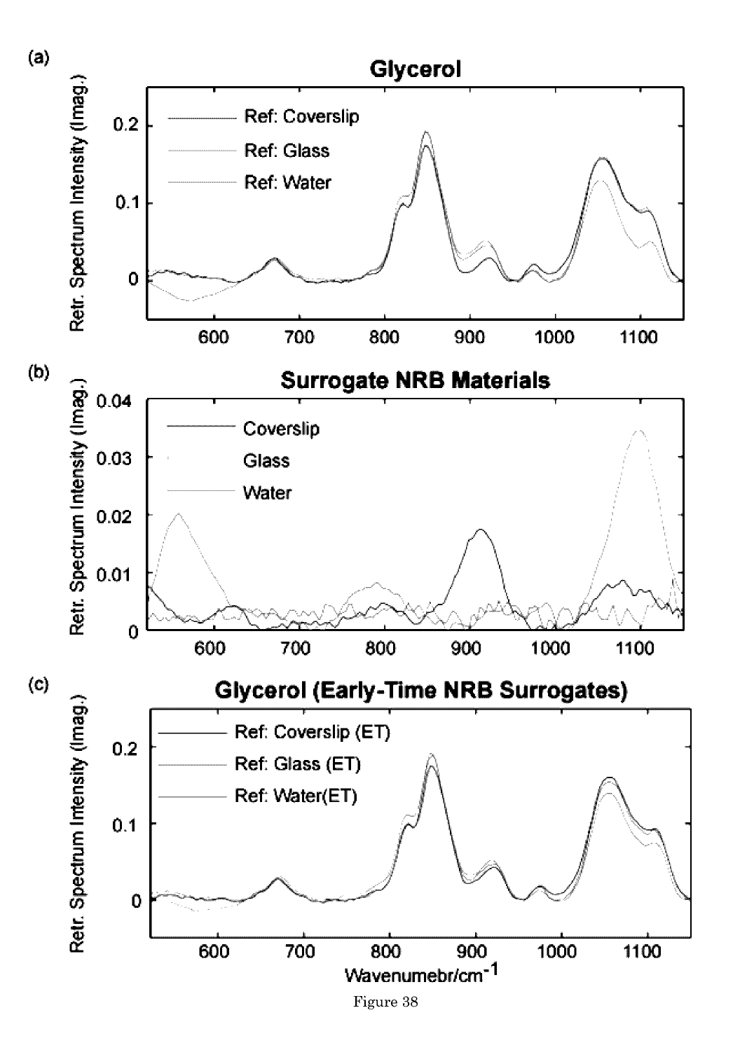

The developed error correction method can readily be applied to experimental results without modification. Additionally, this method provides spectra that are comparable between microscopy platforms. FIG. 36 (panel a) shows CARS spectra collected for neat glycerol on two BCARS systems (average of 100 acquisitions) (including plural color broadband CARS microscope 100), demonstrating widely different system responses for the same molecule. FIG. 36 (panel b) shows the recorded reference spectra for three different commonly used model materials. These reference spectra demonstrate not only a great variety of overall amplitude but also spectral features. As expected, retrieving the Raman-like spectra using these references produces amplitude and phase errors, resulting in distortions as shown in FIG. 36 (panel c). FIG. 22 (panel a) shows the Raman-like spectra with the slowly varying baseline removed. The spectrum retrieved using water demonstrates the most severe distortions. Even the spectra using glasses (slide and coverslip) demonstrate differences. In comparison, FIG. 22 (panel b) shows the same four spectra after full correction (Eqn 48). The four spectra are significantly more similar in amplitude and shape. Additionally, one should notice the partial recovery of the OH-stretch peaks (˜3300 cm⁻¹) for the spectrum retrieved using water. When a particular reference material is utilized, the retrieved spectra will have suppressed peaks wherever the model material contains Raman peaks. Within spectroscopic CARS literature, coverslip or slide glass has often served as a convenient reference. What was not apparent at the time, however, is that these glasses have nontrivial, glass-dependent Raman peaks. Unexpected and surprisingly, the primary cause of the spectral differences in FIG. 22 (panel b) are due to these reference material Raman peaks. FIG. 38 (panel b) shows the retrieved (and corrected) spectra of these reference materials, with their peaks exactly correlating with the deviations in the retrieved spectra (FIG. 38 (panel a)). These spectra were collected using a time-windowing, self-referencing method (see FIG. 37). This enables collecting an NRB-dominant spectrum directly from the sample, which can then be used as the reference. This also enables the use of reference material spectra with their Raman peaks suppressed. Panel c of FIG. 38 shows Raman-like (corrected) spectra of glycerol using different references with their peaks suppressed.

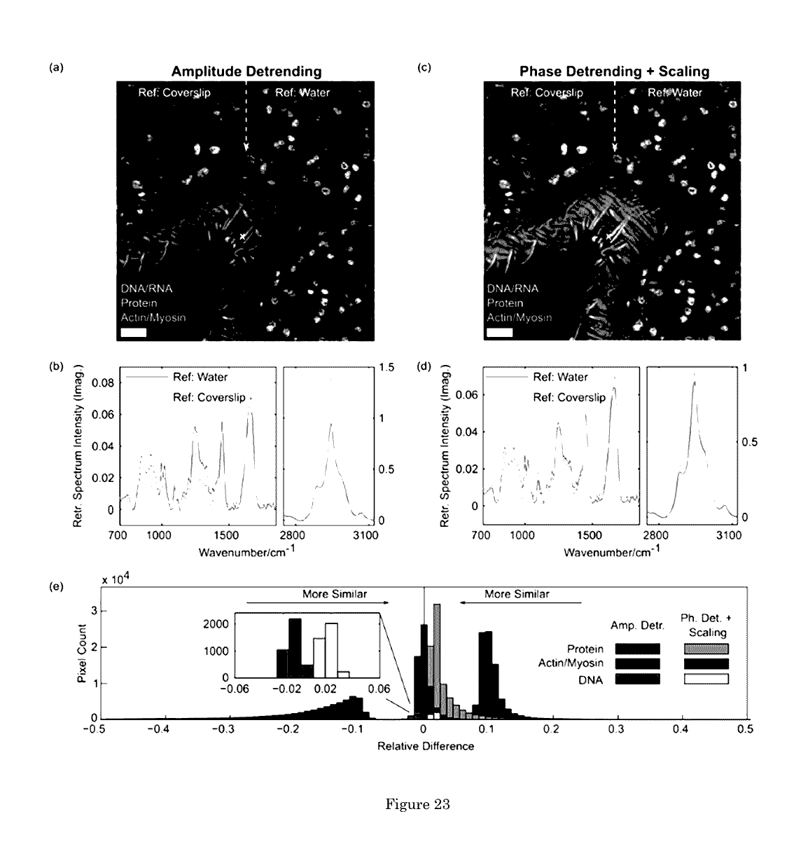

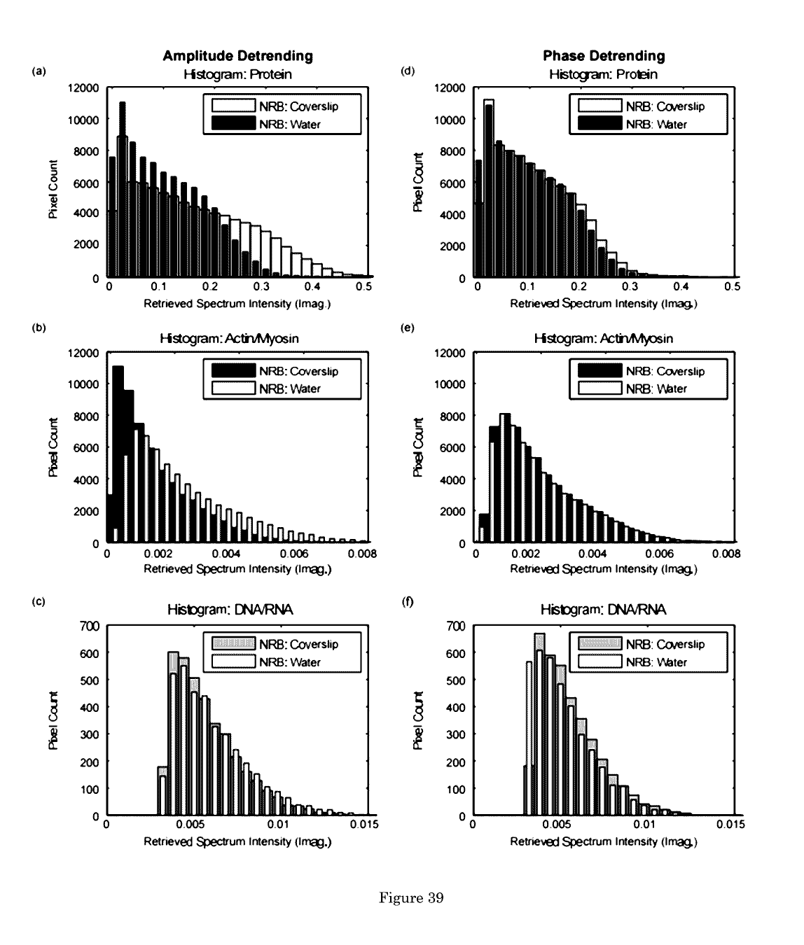

With regard to imaging tissue, plural color broadband CARS microscope 100 with phase retrieval also can be reliably applied to hyperspectral images acquired by plural color broadband CARS microscope 100. For this purpose, plural color broadband CARS microscope 100 was used to image a histological section of murine pancreatic artery. A 200×200 μm section (90 000 pixels total) was imaged with 3.5 ms dwell times. Reference spectra were collected from water and the sample coverslip. The raw BCARS image was de-noised using SVD on Anscombe-stabilized spectra, keeping 23 singular values. After this de-noising, the hyperspectral data were processed four times: twice with each reference spectrum and twice with amplitude or phase detrending methods. FIG. 23 (panels a and c) show pseudocolor images of the murine skin highlighting protein in blue (2937-2882 cm⁻¹), DNA in orange (785 cm⁻¹), and in red a shoulder peak that is dominant in the smooth muscle (1339 cm⁻¹) and is tentatively assigned to actin/myosin. The left halves of FIG. 23 (panels a and c) show the processing performed using the coverslip NRB reference and the right halves using water. The color intensity range of red, green, and blue channels is the same for both half-images within a single figure, although the range is different between FIG. 23 (panels a and c). With amplitude detrending (FIG. 23, panels a), the boundary between the half-images is obvious. Using the coverslip reference, the blue channel (protein) is more intense than when using water. Conversely, the red channel (actin/myosin) is suppressed when using coverslip. The DNA/RNA signature is nearly the same in both images. This highlights that distortions vary across the spectrum, and one cannot simply normalize out the errors. Using phase detrending (and scaling) in FIG. 23 (panel c), there is no obvious discontinuity between the two half-images. FIG. 23 (panel b) shows single-pixel spectra collected from a portion of the internal elastic lamina (marked by a white ‘x’ in FIG. 23 (panel a) and corrected using amplitude detrending. In these spectra, the coverslip-processed spectrum is ˜40% stronger at higher energies but ˜15% to 30% weaker within the fingerprint region. With phase detrending, shown in FIG. 23 (panel d), the peak differences are significantly less obvious, with the predominant cause of residual error being from Raman peaks inherent to the reference materials (in FIG. 23 (panels b and c)), significant perturbations induced by reference NRB Raman peaks in coverslip glass are denoted with an ‘*’ and dashed lines). FIG. 39 shows a histogram comparison of the Raman peak amplitudes whether performing amplitude detrending or phase detrending (and scaling), demonstrating significantly increased similarity when using the developed method. To quantify the improvement, we calculated on a pixel-by-pixel basis the relative difference (FIG. 23 (panel e) between the peaks used to construct FIG. 23 (panels a and c), i.e., the coverslip-processed intensity minus the water-processed intensity, over the mean. Table 1 demonstrates that using phase detrending and scaling provides significant similarity between pixel intensities (better than 3.6% relative difference), regardless of which surrogate material is used. This is a dramatic improvement over amplitude detrending with better than 17.5% relative difference. Table 1 provides a comparison of dissimilarity (relative difference) between images (pixel by pixel, FIG. 23 (panels a and c)) processed using glass or water as an NRB surrogate using traditional error correction (amplitude detrending) or the prescribed method (phase detrending and scaling).

TABLE 1

| | Amplitude detrending | | Phase detrending + scaling | |
|---|---|---|---|---|
| | Mean relative | | Mean relative | |
| Sample | difference (%) | σ (%) | difference (%) | σ (%) |
| Protein | 10.5 | 3.7 | 3.5 | 4.5 |
| Actin/myosin | −17.4 | 8.4 | 0.08 | 1.1 |
| DNA/RNA | −1.1 | 0.5 | 1.7 | 0.5 |

Plural color broadband CARS microscope 100 provides quantitative reliability and repeatability for acquisition of CARS spectra and quantitative analysis of hyperspectral data cubes. Advantageously, the processes and articles herein provides making CARS spectra reliable, repeatable, and universally comparable. Moreover, plural color broadband CARS microscopy performed with plural color broadband CARS microscope 100 provides a process for extracting Raman signal from fourth light 122 that corrects for amplitude and phase errors that are ubiquitous in traditional CARS microspectroscopy. Plural color broadband CARS microscopy can produce corrected spectra, as demonstrated with neat liquids and tissues images and significantly reduces intra-spectral distortions caused by the use of NRB reference spectra and facilitates direct, quantitative comparison between samples and microscopy systems. Further, plural color broadband CARS microscope 100 and plural color broadband CARS microscopy methods herein enable mass dissemination of coherent Raman hyperspectral data cubes for community data mining and analysis.

In the above description, the full Hilbert transform and the “windowed” Hilbert transform were related by an additive error term, ε, under the condition that the resonant component of the nonlinear susceptibility, χ_{R}, was fully captured and the nonresonant component, χ_{NR}, was not. That is:

$$\begin{matrix}\hat{H} \{ log \vert {χ}_{R} ( ω ) + {χ}_{NR} ( ω ) \vert \} = {\hat{H}}_{W} \{ log \vert {χ}_{R} ( ω ) + {χ}_{NR} ( ω ) \vert \} + ɛ ( ω ) & ( 52 ) \\ = ∠ [ {χ}_{R} ( ω ) + {χ}_{NR} ( ω ) ] , & ( 53 )\end{matrix}$$

where ∠ is the phase.

To demonstrate this relationship, we simulated a nonlinear susceptibility with two Raman peaks and an extremely broad (25,000 cm⁻¹ full-width half-max) nonresonant term as shown in FIG. 19 (panel a). The windowed Hilbert transform of the complex norm of the nonlinear susceptibility was performed over larger-and-larger windows and compared with the ideal solution (the phase). FIG. 19 (panel b) shows the retrieved phase via the windowed Hilbert transform with varying window widths. FIG. 19 (panel c) shows the numerically-calculated phase of the nonlinear susceptibility, which is the same regardless of window width. The difference between the retrieved phase and the exact phase is shown in FIG. 19 (panel d). As seen there are no remnants of Raman peaks; thus, this remainder is additive and represents the error term, ε.

With regard to the time-domain Kramers-Kronig transform (TDKK), the Fourier-transformed (time-domain) CARS spectrum is cut at t<0 and the time-domain NRB spectra is conversely cut at t≧0. Explicitly:

$$φ ( ω ) = - 2 Im \{ ψ \{ \frac{1}{2} ln [ {I}_{CARS} ( ω ) , {I}_{NRB} ( ω ) ] \} - \frac{\frac{1}{2} ln {I}_{CARS} ( ω )}{2} \} , \qquad ( 54 )$$

where ‘Im’ selects the imaginary component, and ψ is an operator defined as:

$$ψ \{ \frac{1}{2} ln [ {I}_{CARS} ( ω ) , {I}_{NRB} ( ω ) ] \} @ F \{ u ( t ) {F}^{- 1} \{ \frac{1}{2} ln {I}_{CARS} ( ω ) \} + u ( - t ) {F}^{- 1} \{ \frac{1}{2} ln {I}_{NRB} ( ω ) \} \} . \qquad ( 55 )$$

In eq 55, u(t) is a step-function defined as 1 for t≧0. The operator ψ selects the Fourier transform of the CARS signal for t≧0 and the Fourier transform of the NRB signal for t<0. Combining eqs 54 and 55 and noting that F{u(t)}=\sqrt{π/2}[P/(iπω)+δ(χ)], where P is the Cauchy principle value:

$$φ ( ω ) = - \frac{2}{\sqrt{2 π}} 𝒥 \{ [ \frac{P}{i \sqrt{2 π} ω} + \sqrt{\frac{π}{2}} δ ( ω ) ] * \frac{1}{2} ln {I}_{CARS} ( ω ) + [ \frac{P}{i \sqrt{2 π} ( - ω )} + \sqrt{\frac{π}{2}} δ ( - ω ) ] * \frac{1}{2} ln {I}_{NRB} ( ω ) - \frac{\frac{1}{2} ln {I}_{CARS} ( ω )}{2} \} = \frac{P}{πω} * \frac{1}{2} ln {I}_{CARS} ( ω ) - \frac{P}{πω} * \frac{1}{2} ln {I}_{NRB} ( ω ) , \qquad ( 56 )$$

where * is the convolution operation. Using the definition of the Hilbert transform for an arbitrary function ƒ(x):

$$\hat{H} \{ f ( x ) \} = \frac{P}{π} {\int }_{- ∞}^{∞} \frac{f ( {x}^{′} )}{x - {x}^{′}} d {x}^{′} = \frac{P}{π x} * f ( x ) , \qquad ( 57 )$$

and combining with eq S5:

$$φ ( ω ) = \hat{H} \{ \frac{1}{2} ln {I}_{CARS} ( ω ) \} - \hat{H} \{ \frac{1}{2} ln {I}_{NRB} ( ω ) \} = \hat{H} \{ \frac{1}{2} ln \frac{{I}_{CARS} ( ω )}{{I}_{NRB} ( ω )} \} = \hat{H} \{ ln \frac{\vert \begin{matrix}{□}^{( 3 )} \\ χ \end{matrix} ( ω ) \vert}{\vert \begin{matrix}□ \\ {χ}_{NR}\end{matrix} ( ω ) \vert} \} ; \qquad ( 58 )$$

With regard to a phase-corrected Kramers-Kronig (PCKK) relation, a phase retrieval method in which prior to the Kramers-Kronig transform the CARS signal is normalized by the NRB reference spectrum. Afterwards a step-function is applied in the time-domain and a Fourier-transform applied:

$$φ ( ω ) = - 2 𝒥 \{ F \{ u ( t ) {F}^{- 1} \{ \frac{1}{2} ln \frac{{I}_{CARS} ( ω )}{{I}_{NRB} ( ω )} \} \} \} = - \frac{2}{\sqrt{2 π}} 𝒥 \{ [ \frac{P}{i \sqrt{2 π} ω} + \sqrt{\frac{π}{2}} δ ( ω ) ] * \frac{1}{2} ln \frac{{I}_{CARS} ( ω )}{{I}_{NRB} ( ω )} \} \qquad ( 59 )$$

Applying the definition of the Hilbert transform, eq 57, to eq 59:

$$φ ( ω ) = \frac{P}{πω} * \frac{1}{2} ln \frac{{I}_{CARS} ( ω )}{{I}_{NRB} ( ω )} = \hat{H} \{ \frac{1}{2} ln \frac{{I}_{CARS} ( ω )}{{I}_{NRB} ( ω )} \} = \hat{H} \{ ln \frac{\vert \begin{matrix}{□}^{( 3 )} \\ χ \end{matrix} ( ω ) \vert}{\vert \begin{matrix}□ \\ {χ}_{NR}\end{matrix} ( ω ) \vert} \} . \qquad ( 60 )$$

From a phase-retrieval point-of-view, the results between the TDKK and the PCKK are identical (eqs 58 and 60) and with the Hilbert transform derivation presented within the main text. In application, there is a difference between the PCKK and the TDKK: amplitude normalization by the NRB. In the TDKK, the Raman-like spectrum is:

$${I}_{TDKK} ( ω ) = \sqrt{{I}_{CARS} ( ω )} sin φ = \vert {{C}^{•}}_{st} ( ω ) \vert \vert {{χ}^{•}}^{( 3 )} ( ω ) \vert sin φ , \qquad ( 61 )$$

where [symbol] ₛₜ is the effective stimulation profile. The TDKK manuscript Accounting for a shape of the excitation sources:

$${I}_{PCKK} ( ω ) = \sqrt{\frac{{I}_{CARS} ( ω )}{{I}_{NRB} ( ω )}} sin φ = \frac{\vert \begin{matrix}{□}^{( 3 )} \\ χ \end{matrix} ( ω ) \vert}{\vert \begin{matrix}□ \\ {χ}_{NR}\end{matrix} ( ω ) \vert} sin φ ; \qquad ( 62 )$$

Thus, the stimulation profile is removed but the output spectrum is now scaled with respect to the NRB.

Under an ideal circumstance, the stimulation profile would be directly measurable, removed, and the retrieved spectrum would follow that of the TDKK. In practice, however, this is not trivial. Normalization by the NRB signal, as presented in the PCKK and this manuscript, removes the stimulation profile and other static, spectral perturbations such as the optical filter passband oscillations. Thus, this practice is included for creating spectra that are directly comparable from system-to-system.

To extract the Raman features from BCARS spectra or images from fourth light 122 acquired by plural color broadband CARS microscope 100 are shown in FIG. 25.

Dark spectra (e.g., 100 to 1000 dark spectra) are collected with no sample illumination, averaged, and subtracted from the BCARS and reference NRB spectra. Due to detector operating conditions or stray light, the exact level of dark signal may vary (slightly) from pixel-to-pixel or image-to-image. To remove this residual dark signal, we take advantage of the several hundred spectral pixels that ideally do not receive anti-Stokes photons. As shown in FIG. 21 (panel a), :350 spectral pixels (:900 cm⁻¹) are not illuminated, from which we can evaluate the mean [see FIG. 21 (panel b)] and subtract. Deviations of the dark level can induce amplitude and phase errors within the extracted Raman-like spectra that are not straight-forward to remove.

With regard to denoising via the Anscombe transformation and singular value decomposition (SVD), SVD is a matrix factorization technique with many uses, including noise reduction. BCARS hyperspectral imagery from fourth light 122 is unfolded into a two-dimensional matrix, A, with rows representing the spectral axis and columns spatial content. The SVD algorithm factorizes this matrix into three components:

A=USV*, (63)

where in this context, U contains the spectral bases (orthonormal eigenfunctions), S is a diagonal matrix containing the “singular values” (SV) in descending order (descending average contribution), V describes the spatial distribution of the bases in U, and ‘*’ is the conjugate transpose. A process for de-noising is to analyze the normalized intensity of the singular values (S), select a cut-off (C), set all higher diagonal elements S to 0, and to construct a denoised hyperspectral data matrix, A_{denoise}, as:

A_{denose}=US{1:C}V*. (64)

This method assumes that the signal and noise in fourth light 122 are separable and that (a) the signal in fourth light 122 is entirely enveloped in the lowest SVs and (b) the signal in fourth light 122 will be contained in consecutive SVs below a certain cut-off. Whether these conditions are met is determined by the signal-to-noise ratio of the signal and the noise distribution statistics. SVD (and the related principle component analysis PCA) assumes the noise is additive and follows a normal distribution. In BCARS of plural color broadband CARS microscope 100, the noise is often of a mixed nature: containing (approximately) additive white Gaussian noise (AWGN) and Poisson noise. Plural color broadband CARS microscope 100 generates spectra covering a large intensity range and produces mixed-noise with the mixing ratio varying across each individual spectrum. There is, therefore, a process herein to “whiten” the noise as to be approximately constant (statistically) across each individual spectrum.

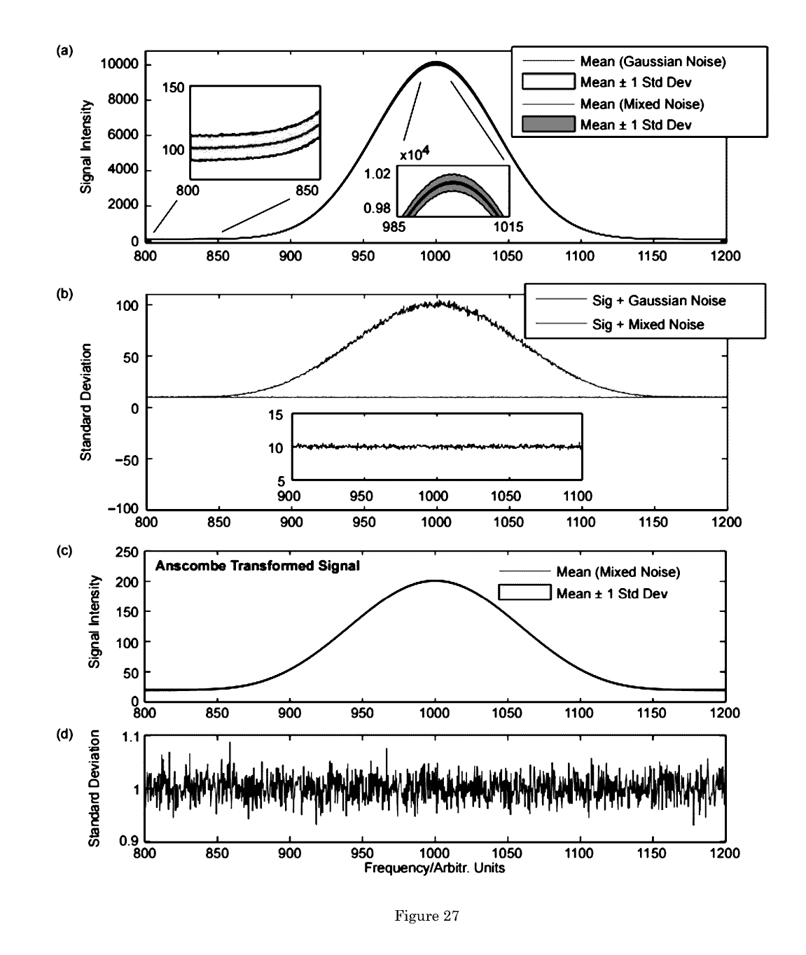

An embodiment of such a process includes performing variance-stabilization using an Anscombe transformation. FIG. 27 (panel a) shows the results of 1000 simulations of a broad spectral peak containing AWGN (standard deviation, σ, of 10) or mixed noise. The level of the signal and the AWGN approximates the intensities found with actual BCARS experiments. Within spectral regions with weak intensity, the AWGN is the dominant noise source. At higher intensities, however, the Poisson noise is up to 10× larger, as shown by the plots detailing standard deviation in FIG. 27 (panel b). Applying the generalized Anscombe transformation to the 1000 simulated spectra and re-evaluating the standard deviation, as shown in FIG. 27 (panel c), there is no noticeable variation of the noise across the spectra.

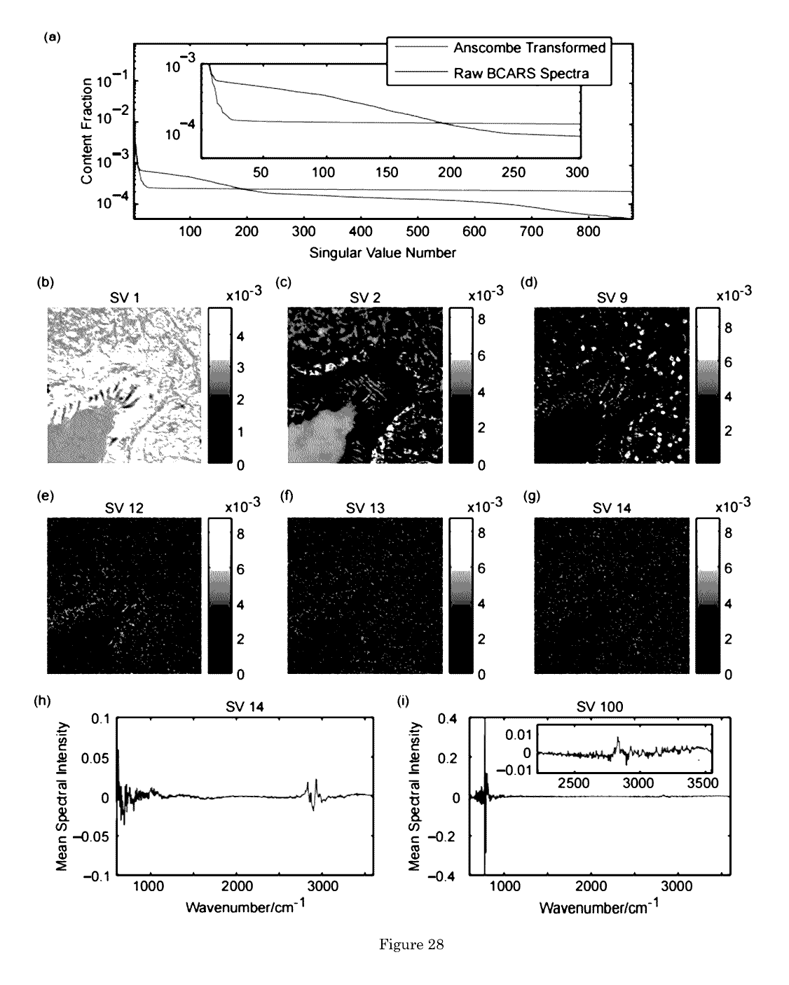

FIG. 28 (panel a) shows the normalized contribution of each spectral basis function (i.e., S_{m,m}/ΣₘS_{m,m}) during pre-processing of the murine pancreas tissue above-described. As previously described. FIG. 28 (panels b-g) show the spatial distribution of selected SVs (V-components). The spatial distributions of the lowest SVs clearly show features of the tissue, but by SV 13 or 14, it becomes less clear. Although there is no obvious spatial content of SV 14, the spectral basis function (see FIG. 28, panel h] shows Raman features. Additionally, the noise-like features below 1000 cm⁻¹ are due to the Poisson noise which is largest at the lowest wavenumbers in this particular BCARS system. FIG. 28 (panel i) shows the 100th spectral basis function and, as expected, the Poisson noise has moved to higher wavenumber regions as this contribution is smaller. Additionally, one can see remaining Raman features near:2900 cm⁻¹. In essence, with this system response profile (i.e., not spectrally flat), the noise and singular values are frequency-dependent. Thus, SVD does not properly separate signal and noise, which also results in hundreds of SVs necessary to capture the signal accurately.

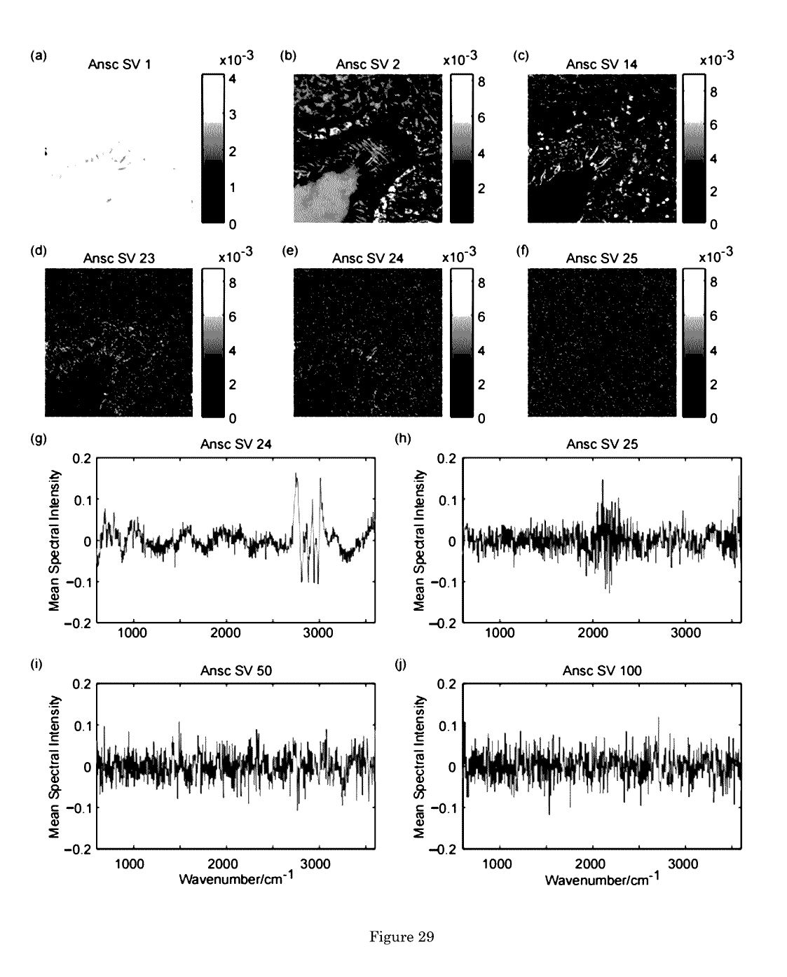

FIG. 29 (panels a-f) shows the spatial distribution of SVs when using the Anscombe transformation on the BCARS spectra prior to SVD. In this case, SV 24 shows small spatial content and SV 25 none obvious. The spectral bases for these SVs [FIG. 29 panels g and h] demonstrates that SV 24, which has spatial features, also contains spectral features, and SV 25 which has no spatial content also shows no obvious spectral content. Thus, there is correlation between the spatial and spectral features. Additionally, in both of these cases, there is no obvious noise variation across the spectrum [in contrast to FIG. 28 (panels h,i)]. FIG. 29 (panels i, j) show the spectral bases for the 50th and 100th SV. The non-variance stabilized SVD showed clear spectral features at the 100th SV, but using the Anscombe transformation, even the 50th SV appears to only contain noise.

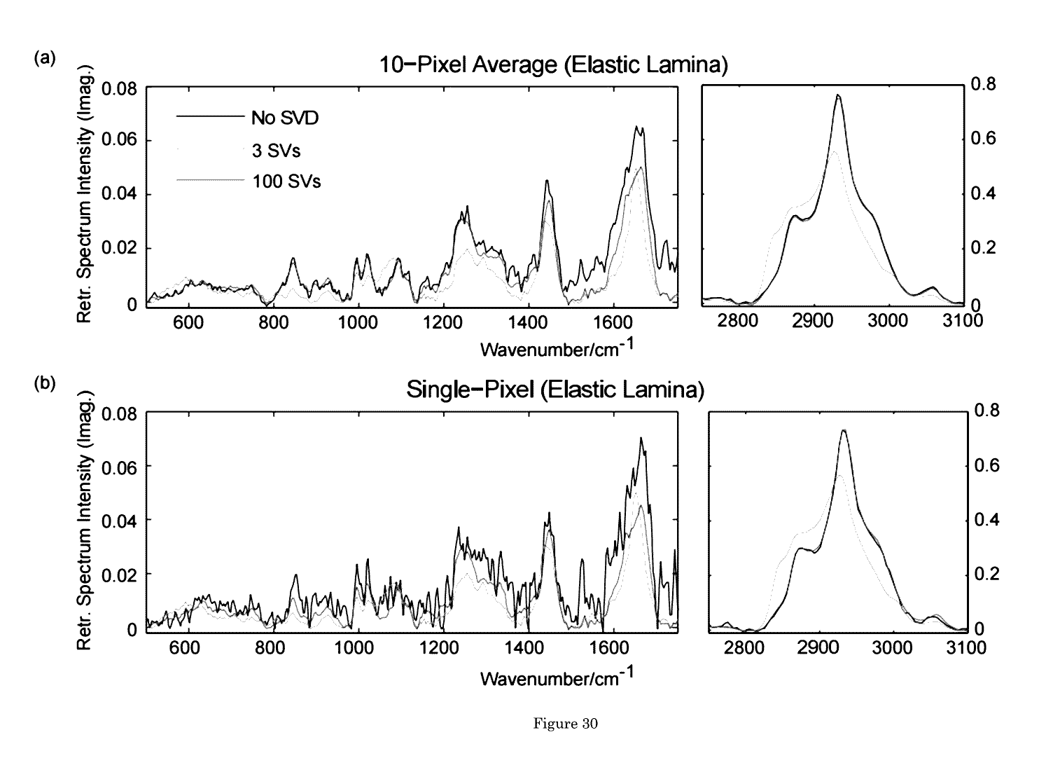

Selecting a proper combination of SVs to reconstruct the original Raman content is considered. Although the use of few SVs generates clear, attractive imagery, the underlying data may be distorted or completely erroneous. FIG. 30 (panel a) shows three spectra from within the internal elastic lamina of the artery (primarily composed of elastin) imaged within the main text of the manuscript. Each spectrum is the mean from the same 10 pixels but with varying number of SVs used in de-noising (or without SVD). The use of three SVs, shows significant spectral distortion. The spectral profile within the CH-stretch region would seem to indicate that the elastic lamina contains a significant lipid content (based on the pronounced 2850 cm⁻¹). Excluding baseline drift, the use of the first 100 SVs presents a significantly improved spectrum but with reduced efficacy of noise suppression [especially for a single pixel, as shown in FIG. 30 (panel b)]. The process can select enough SVs to maintain spectral integrity and few enough to provide significant noise reduction. Plural color broadband CARS microscopy herein can use both spectral and spatial features and the Fourier-domain noise statistics.

FIG. 31 (panels a, b) demonstrate the concept of spatial domain SV selection. The absolute value of the spatial components (mean-subtracted) for each SV (|V|) are transformed via a two-dimensional Fourier transform. A rectangular boundary is applied to separate the low-frequency components (assumed to contain primarily signal) and high-frequency components (assumed to be primarily noise). The “spatial signal ratio” is defined as the sum of pixel intensities (complex modulus of the Fourier transform components) within the boundary divided by those outside the boundary (scaled by the number of pixels within and outside of the boundary). FIG. 31 (panel c) plots the spatial signal ratio as a function of SV number. As expected the lowest SVs show the largest ratio. To develop a cut-off value, we assume that the highest SVs (>700) contain only noise. From the spatial signal ratio of these highest SVs, we calculate the standard deviation, σ. The cut-off value, for which all SVs below will be neglected, is heuristically determined as a multiple of σ. Based on visual inspection of V, we select a multiplier of 3.5. FIG. 31 (panel c) shows this cut-off value in red. Between SV 15 and 20 [see FIG. 31 (panel c), inset], the spatial ratio drops below the cut-off (SV 18) then returns above (SV 19). Images of the spatial distribution of SV 18 and 19 [FIG. 31 (panel c)] demonstrate that our method correctly categorized SV 18 as containing no obvious spatial components but SV 19 does. This demonstrates that there may be SVs with primarily noise components intermixed between SVs with primarily signal components.

As illustrated in FIG. 28 (panels g, h), the lack of spatial components may or may not indicate a lack of spectral components. Thus, we have also developed an automated spectral basis set analysis technique for plural color broadband CARS microscope 100. As pictographically described in FIG. 32 (panels a, b), the spectral component selection tool analyzes the statistics of the U components within the Fourier domain (time-domain). Again, a ratio is determined between the sum of the signal contribution within a low-frequency window and outside this window (scaled to number of pixels). The half-width of this window is set to correspond to the temporal duration of our probe source (3.4 ps). Again, we assume that the highest SV components contain primarily noise and calculate the standard deviation. The spectral components, however, show a mean-line drift, which we fit with a low-order polynomial (in this case, third-order). The cut-off is a multiple (4, in this case) of the standard deviations from this mean. FIG. 32 (panel c, inset) demonstrates qualitatively correct identification of SV 26 with no noticeable Raman components and SV 27 with signal features.

Table 2 lists the time of each pre-processing step in automatically processing the murine pancreas. The computer was a Dell Optiplex 9010 with quad-core Intel i7-3770 CPU at 3.4 GHz, with 16 GB of memory, and running MATLAB R2013a. The total processing time was approximately 28 minutes. At 95% of the computation time, the most intensive process was the automated detrending using asymmetric least squares (ALS). It should be noted that the ALS algorithm, as developed, uses the CHOLMOD implementation of fast sparse matrix inversion for optimal performance. Future work will investigate alternative means of automated detrending. Excluding the ALS step, the total processing time was approximately 90 seconds (<1 ms/spectrum).

TABLE 2

| | Total Computation | |
|---|---|---|
| Sub-Process | Time (s) | Time/Pixel (ms) |
| Dark Subtraction | 0.74 | 0.01 |
| Residual Baseline Subtraction | 1.14 | 0.01 |
| Anscombe Transform | 0.48 | 0.01 |
| SVD | 41.71 | 0.46 |
| Automated SV Selection | 3.67 | 0.04 |
| Inverse Anscombe Transform | 5.18 | 0.06 |
| Phase Retrieval (KK) | 17.66 | 0.20 |
| Phase Detrending (ALS) | 1564.91 | 17.44 |
| Spectral Scaling | 19.69 | 0.22 |
| Total | 1655.18 | 18.45 |

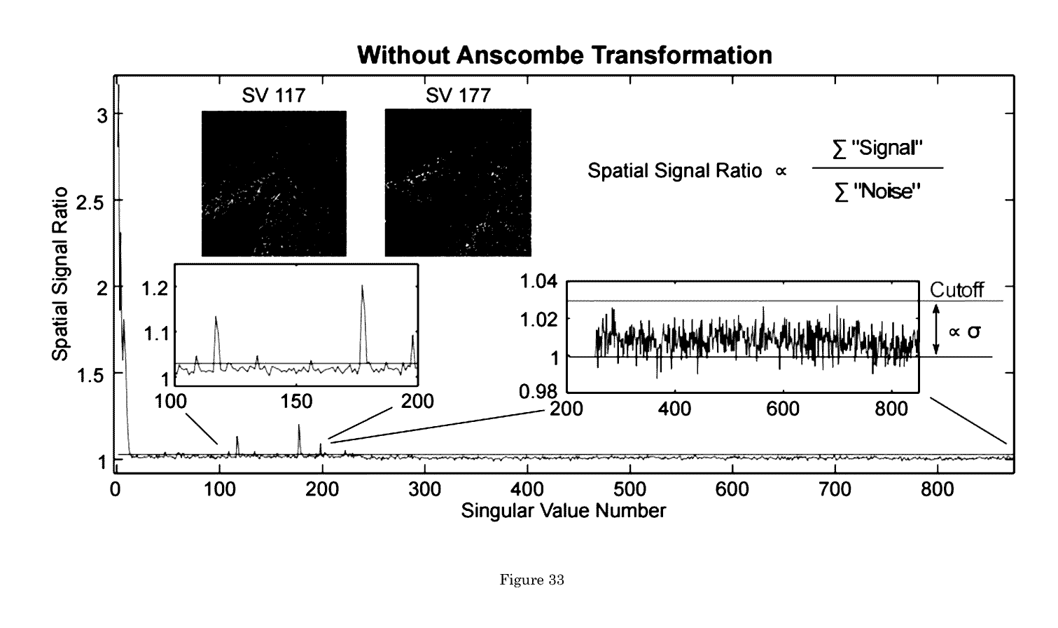

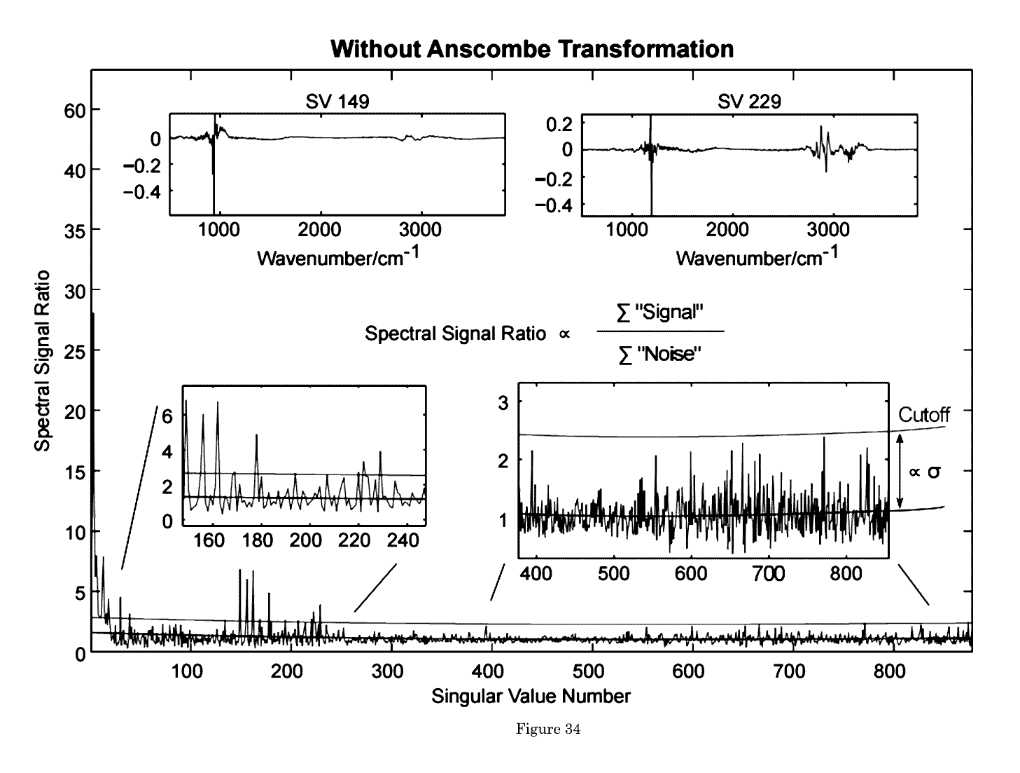

For comparison with the demonstrations above, FIG. 33 and FIG. 34 show the automated spatial and spectral analysis results for non-Anscombe transformed BCARS data.

In some embodiments for correcting spectra, the maximum entropy method (MEM) and phase error correction are applied to spectra. Here, MEM performs phase-retrieval based on information theory grounds. We performed phase retrieval via the MEM on simulated BCARS spectra containing two peaks under ideal (known NRB) conditions and with a surrogate reference NRB. As shown in FIG. 35 (panel a), the retrieved Raman spectra differ between the MEM and KK methods, with the MEM showing a slightly larger baseline drift. Upon phase detrending and scaling, the Raman-like spectra extracted using reference spectra agree with those with the known NRB. Differences in peak amplitudes between the MEM and KK (<5%) are due to the underlying algorithmic differences between the KK and MEM methods.

As previously described, plural color broadband CARS microscope 100 was used to acquire glycerol spectra. Comparative spectra for glycerol were collected on a comparative instrument. Both data sets were subjected to pre-processing with different reference NRB spectra. FIG. 36 (panel a) shows BCARS spectra of glycerol collected on plural color broadband CARS microscope 100 (“System 1”) and the comparative system (“System 2”). There is a clear difference in the system responses with plural color broadband CARS microscope 100 showing marked enhancement at the lowest wavenumbers. FIG. 36 (panel b) shows the BCARS spectra of 3 different reference materials (and coverslip glass acquired on System 2). These spectra show differences in amplitude and shape. FIG. 36 (panel c) shows the retrieved Raman spectra using the KK relation (no error correction performed). Inspection of the Raman peaks (such as the CH-stretch peaks) indicates there is substantial differences in retrieved amplitude and phase.

We used time-window self-referencing (TWSR) to capture a CARS spectrum from fourth light 122 that predominantly contains the NRB with reduced contributions of the Raman vibrational components. This process can be used to retrieve an approximate NRB spectrum on a pixel-by-pixel basis, with a second image to be acquired.

The “effective” nonlinear susceptibility, [symbol] , is related to the nonlinear susceptibility as:

[symbol]

(ω)=χ(ω)*Eₚᵣ(ω), (65)

where * is the convolution operation and Eₚᵣ is the electric field of the probe source (first light 104). The spectrally narrower the probe source, the higher the resolution of the CARS spectrum. From a time-domain perspective, this can be viewed as how much temporal information is acquired. One can describe the effective time response of the nonlinear susceptibility, [symbol] (t), as:

$${R}^{□} ( t ) = {F}^{- 1} \{ \begin{matrix}{□}^{( 3 )} \\ χ \end{matrix} ( ω ) \} = {{F}^{- 1} \{ {χ}^{( 3 )} ( ω ) \}}_{\begin{matrix}⏟ \\ R ( t )\end{matrix}} {F - 1 \{ {E}_{pr} ( ω ) \} ,}_{\begin{matrix}⏟ \\ {E}_{pr} ( t )\end{matrix}} \qquad ( 66 )$$

where F⁻¹ is the inverse Fourier transform, R(t) is the time response of the material nonlinear susceptibility, and Eₚᵣ(t) is the temporal field profile of the probe source. FIG. 37 (panel a) shows the time response of a simulated nonlinear susceptibility (resonant and nonresonant contributions) containing two Raman peaks and a broad (25,000 cm⁻¹ full-width half-max) nonresonant background [see FIG. 24 (panel a) for plots of the individual terms in the frequency-domain]. The nonresonant term only contributes a signal for a brief duration (femtoseconds), but the Raman contributions decays over several picoseconds. Under normal spectroscopic collection, as described in FIG. 37 (panel b), the temporal overlap of the material stimulation (via pump (first light 104 or second light 108, depending on 2C or 3C) and Stokes (second light 108) sources) and the probe (first light 104) source is set to maximize the total energy collection (i.e., from time 0, on); thus, maximizing the temporal duration captured and the spectral resolution. In the TWSR technique, the probe source is temporally offset as to only capture the earliest moments of signal creation [FIG. 37 (panel c)]; thus, acting as a femtosecond probe. The signal generation from the nonresonant component of the nonlinear susceptibility is the same as under normal operating conditions, but little of the Raman decay is acquired. The “early time” (ET) spectrum will serve as an approximate NRB measurement.

As an experimental demonstration of the effect of Raman peaks within common reference materials, FIG. 38 (panel a) shows the retrieved Raman-like spectra of glycerol within the lower wavenumber region using reference NRB (normal temporal probe settings). The spectra show distinct similarity, but there are certain regions of deviation at:560 cm⁻¹, :920 cm⁻¹, and: 1100 cm⁻¹. By using the spectra gathered from these reference materials and the TWSR technique to capture an approximate NRB spectrum, one can retrieve Raman-like spectra from the reference materials themselves as shown in FIG. 38 (panel b). Comparing FIG. 38 (panels a, b), it is apparent that the Raman peaks of coverslip and glass slide correspond to the same spectral regions of deviation. FIG. 38 (panel c) shows the retrieved Raman-like spectra of glycerol using TWSR with the reference materials, reducing their Raman spectral contribution. The use of TWSR in this manner reduces the deviation of spectral components by a factor of 2.

The pseudocolor imagery and analysis was performed on tissue with fourth light 122 collected by plural color broadband CARS microscope 100 to highlight general protein content, smooth muscle (predominantly actin/myosin), and DNA/RNA. For protein 2937 cm⁻¹−2882 cm⁻¹ was used, which effectively suppresses the lipid content. For smooth muscle, a peak at 1339 cm⁻¹ was used. As this particular peak is a portion of a shoulder that is spectrally broad, containing several neighboring peaks, a linear interpolant was calculated between 1288 cm⁻¹ and 1360 cm⁻¹, subtracted, and the peak amplitude at 1339 cm⁻¹ was calculated. For DNA/RNA, the peak at 785 cm⁻¹ was used. To mitigate the effect of residual baseline, this peak amplitude was calculated relative to a linear interpolant calculated between the neighboring troughs at 763 cm⁻¹ and 820 cm⁻¹.

Herein, phase detrending and scaling significantly reduce the effect of using reference NRB spectra. FIG. 39 (panels a-c) shows histograms of the calculated peak amplitudes relating to protein, smooth muscle, and DNA/RNA as a function of reference NRB material corrected with traditional amplitude detrending. For the case of general protein [FIG. 39 (panel a)], the use of glass coverslip as the surrogate NRB retrieves peak amplitudes with a larger mean and broader distribution than with water. The converse is true for smooth muscle (actin/myosin) for which retrieval increases the amplitude distribution to higher values [FIG. 39 (panel a)]. For DNA/RNA, the retrieved amplitudes are relatively similar. FIG. 39 (panels d-f) demonstrates that the use of phase detrending and scaling significantly improves the similarity of retrieved amplitudes regardless of reference material used.

Plural color broadband CARS microscope 100 has numerous beneficial properties. The anti-Stokes radiation in fourth light 122 provides a broadband CARS frequency from 500 cm⁻¹ to 4500 cm⁻¹ in relation to a frequency superposition of the narrowband radiation and the broadband radiation, and the broadband CARS frequency comprises an intensity such that a contribution to the intensity from a interpulse excitation of sample 118 by third light 112 is separated in frequency from a contribution from a intrapulse excitation of sample 118 by third light 112. Further, third light 112 further can include a interpulse peak excitation profile at a difference frequency of the narrowband radiation and the broadband radiation respectively from first light 104 and second light 108. Moreover, in plural color broadband CARS microscope 100, third light 112 can include a intrapulse peak excitation profile at 0 cm⁻¹, based on a degeneracy of a pump electric field and a probe electric field provided by the broadband radiation provided by second light 108.

Plural color broadband CARS microscope 100 is based on broadband coherent anti-Stokes Raman scattering and provides an advantageous combination of speed, sensitivity and spectral breadth. First light 104 and second light 108 probe an entire biologically relevant Raman window (500-3,500 cm⁻¹) with high resolution (<10 cm⁻¹). Plural color broadband CARS microscope 100 strongly and efficiently stimulates Raman transitions within a typically weak fingerprint region using intrapulse intrapulse excitation by third light 112, and uses non-resonant background to heterodyne-amplify weak Raman signals. Advantageously and unexpectedly, plural color broadband CARS microscope 100 provides high-speed chemical imaging in two- and three-dimensional views of biological samples such as tissue as well as interfaces between such tissue.

The articles and processes herein are illustrated further by the following Examples, which are non-limiting.

### EXAMPLES

### Example 1

### Construction of Plural Color Broadband CARS Microscope

We constructed a plural color broadband CARS microscope. Here, two co-seeded fiber lasers (commercially available from Toptica, model FemtoPro) provided attosecond-level synchronization with the narrowband probe laser (a first light source) generating ˜3.4 ps flat-top pulses of first light (ΔΩ<10 cm⁻¹) at 770 nm (40 MHz repetition rate) and a supercontinuum (SC) source (second light source) generating ˜16 fs pulses (on-sample) of second light spanning ˜900-1,350 nm (40 MHz repetition rate). The SC beam (second light) was directed into an SF10 prism pair pulse compressor to provide a degree of chirp control so as to maximize the spectral coherence window (additional laser tuning and higher-order chirp can move the two- and intrapulse excitation regions to excite, e.g., the Raman quiescent region when analyzing deuterated species or cyano groups). The probe beam (first light) was directed to a motorized optical delay line to provide temporal control between the two sources (first light and second light). The probe beam (first light) size was enlarged by a refractive telescope to closely match the back aperture of the objective lens. The two beams (first light and second light) were combined at a third light source (a dichroic filter (commercially available from Omega, model 910DCSPXR)) and coupled into an inverted microscope (commercially available from Olympus, model IX71). The excitation beams (first light and second combined as third light) were focused onto the sample using a water-immersion, ×60 (NA=1.2) objective lens (commercially available from Olympus, model UPlanSApo IR). The sample was mounted on a three-axis piezo stage (commercially available from Physik Instrumente, model P-545) that provided 200 μm×200 μm×200 μm movement with submicrometer precision. The excitation (third light) and generated photons (fourth light emitted from the sample) were collected and collimated with a ×60 objective lens (NA=0.7) (commercially available from Olympus, model LUCPlanFL N) and passed through two shortpass filters (commercially available from Semrock, model Brightline 770SP; Chroma, HHQ765SP). The remaining anti-Stokes light (fourth light) transmitted through the filters was focused with an achromatic lens onto the slit of a spectrograph (commercially available from Acton, model SpectroPro2300i) that was equipped with a CCD camera (commercially available from Andor, model DU970N-FI) for spectral recording. With typical settings, each spectrum of the fourth light was recorded between ˜470 cm⁻¹ and 3,800 cm⁻¹ (the full spectral range covers a larger region of ˜268 nm). The camera was directly synchronized with the piezo-stage motion controller to allow constant-velocity raster scanning. Each fast-axis line scan was recorded onto the CCD onboard memory and transferred during slow-axis movement. The camera control and acquisition software and the data storage software were developed in-house using Visual C++ and controlled through a custom LabView (National Instruments) interface. The data were processed in MATLAB (Mathworks) through an in-house-developed processing suite. Raw spectral data cubes were de-noised using singular value decomposition (SVD; it should be noted that the average spectrum (see, e.g., FIG. 18, panel i) was taken from data that were not de-noised with SVD, as averaging effectively reduced the noise level without additional processing), a time-domain TDKK for spectral phase retrieval and baseline detrended. For the TDKK the estimated NRB signal was collected from either water or glass (slide or coverslip) with the probe delayed to the earliest overlap with the SC, a region in which the NRB dominates the resonant signal, thus providing a good approximation to the pure NRB. Baseline detrending was performed by manually selecting local minima isolated from Raman peaks. In the event that a sample showed regions of mounting media (water or PBS), the fingerprint region below 1,600 cm⁻¹ within these areas could be used as a model for the residual background and subtracted. All pseudocolor images, vibrational images and spectra were generated in MATLAB, and the three-dimensional reconstructed image (see, e.g., FIG. 17, panel b) was generated in ImageJ (NIH).

As will be appreciated by one skilled in the art, embodiments herein may be embodied as a system, method or computer program product, e.g., an analyzer. Accordingly, embodiments may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, embodiments may take the form of a computer program product embodied in a computer readable medium having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments herein may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments are described herein with reference to figures processes, apparatus (systems), and computer program products according. It will be understood that each can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the function or act specified in the description.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The description illustrates an architecture, functionality, and operation of possible implementations of systems, methods, and computer program products according to various embodiments. Such product can be implemented by special purpose hardware-based systems that perform the specified functions or acts, or combinations of special purpose hardware and computer instructions.

Further, a data processing system suitable for storing or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

Reference throughout this specification to “one embodiment,” “particular embodiment,” “certain embodiment,” “an embodiment,” or the like means that a particular feature, structure, or characteristic described in connection with the embodiment is included in at least one embodiment. Thus, appearances of these phrases (e.g., “in one embodiment” or “in an embodiment”) throughout this specification are not necessarily all referring to the same embodiment, but may. Furthermore, particular features, structures, or characteristics may be combined in any suitable manner, as would be apparent to one of ordinary skill in the art from this disclosure, in one or more embodiments.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements, optionally together with one or more of the same class of constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” Further, the conjunction “or” is used to link objects of a list or alternatives and is not disjunctive; rather the elements can be used separately or can be combined together under appropriate circumstances. It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. A plural color broadband coherent anti-Stokes Raman scattering (CARS) microscope comprising:
a first light source to produce a first light comprising a narrowband radiation;
a second light source to produce a second light comprising a broadband radiation;
a third light source to:
receive the first light from the first light source;
receive the second light from the second light source; and
produce a third light comprising the narrowband radiation and the broadband radiation by combining the first light and the second light such that the first light and second light are spatially overlapped and temporally overlapped; and
a primary objective to:
receive the third light from the third light source;
communicate the third light to a sample; and
subject the sample to simultaneous interpulse CARS stimulation and intrapulse CARS stimulation by irradiation with the narrowband radiation and the broadband radiation in the third light.

2. The plural color broadband CARS microscope of claim 1, further comprising:
a spectrometer to receive a fourth light emitted from the sample in response to in response to being subjected to the simultaneous interpulse CARS stimulation and intrapulse CARS stimulation by irradiation with the narrowband radiation and the broadband radiation in the third light,
the fourth light comprising anti-Stokes radiation.

3. The plural color broadband CARS microscope of claim 2, further comprising:
an exit objective disposed opposing the primary objective and interposed between the primary objective and the spectrometer to receive the fourth light emitted from the sample and to communicate the fourth light to the spectrometer.

4. The plural color broadband CARS microscope of claim 1, wherein the first light source comprises a delay line to delay a time of arrival of the first light at the third light source.

5. The plural color broadband CARS microscope of claim 1, wherein the second light source comprises a pulse compressor to provide chirp control of the second light.

6. The plural color broadband CARS microscope of claim 1, further comprising a stage to receive the sample and to position the sample relative to the primary objective.

7. The plural color broadband CARS microscope of claim 6, wherein the stage positions and maintains a position of the sample in one dimension, two dimensions, or three dimensions with respect to the primary objective.

8. The plural color broadband CARS microscope of claim 1, wherein the narrowband radiation comprises a wavelength that is less than a wavelength of the broadband radiation.

9. The plural color broadband CARS microscope of claim 1, wherein the narrowband radiation comprises a wavelength from 400 nm to 2000 nm.

10. The plural color broadband CARS microscope of claim 1, wherein the broadband radiation comprises a wavelength from 400 nm to 2000 nm.

11. The plural color broadband CARS microscope of claim 1, wherein the fourth light further comprises a wavelength that is less than the narrowband radiation,
the anti-Stokes radiation provides a broadband CARS frequency from 0 cm⁻¹ to 4500 cm⁻¹ in relation to a frequency superposition of the narrowband radiation and the broadband radiation, and
the broadband CARS frequency comprises an intensity such that a contribution to the intensity from a interpulse excitation of the sample by the third light is separated in frequency from a contribution from a intrapulse excitation of the sample by the third light.

12. The plural color broadband CARS microscope of claim 1, wherein the third light further comprises a interpulse peak excitation profile at a difference frequency of the narrowband radiation and the broadband radiation.

13. The plural color broadband CARS microscope of claim 1, wherein the third light further comprises a intrapulse peak excitation profile at 0 cm⁻¹, based on a degeneracy of a pump electric field and a Stokes electric field provided by the broadband radiation.

14. The plural color broadband CARS microscope of claim 2, wherein the spectrometer produces spectroscopy data from conversion of the fourth light, and
the plural color broadband CARS microscope further comprises an analyzer to:
receive pre-process data comprising the spectroscopy data, a frequency of the broadband radiation, and a frequency of the narrowband radiation;
subject the pre-process data to a time-domain transform to acquire a Raman spectrum of the sample; and
acquire a coherent Raman image from the pre-process data.

15. The plural color broadband CARS microscope of claim 2, wherein the spectrometer comprises:
a one-dimensional detector array or
a two-dimensional detector array.

16. The plural color broadband CARS microscope of claim 14, wherein the time-domain transform comprises phase retrieval.

17. A process for performing plural color broadband coherent anti-Stokes Raman scattering (CARS) microscopy, the process comprising:
producing, by a first light source, a first light comprising a narrowband radiation;
producing, by a second light source, a second light comprising a broadband radiation;
receiving, by a third light source:
the first light from the first light source; and
the second light from the second light source;
combining, by a third light source, the first light and the second light such that the first light and second light are spatially overlapped and temporally overlapped to produce a third light comprising the narrowband radiation and the broadband radiation; and
communicating the third light to a sample;
subjecting the sample to the third light;
producing, by the sample, a fourth light in response to simultaneous interpulse CARS stimulation and intrapulse CARS stimulation by irradiation with the narrowband radiation and the broadband radiation in the third light; and
acquiring the fourth light to perform plural color broadband CARS microscopy.

18. The process for performing plural color broadband coherent anti-Stokes Raman scattering (CARS) microscopy of claim 17, further comprising:
producing spectroscopy data from conversion of the fourth light;
producing microscopy data by repeated spectroscopic acquisition over an imaging area of the sample;
receiving pre-process data comprising the spectroscopy data, a frequency of the broadband radiation, and a frequency of the narrowband radiation;
subjecting the pre-process data to a time-domain transform to acquire a Raman spectrum of the sample; and
acquiring a coherent Raman image from the pre-process data.

19. The process for performing plural color broadband coherent anti-Stokes Raman scattering (CARS) microscopy of claim 18, wherein the time-domain transform comprises phase retrieval.

20. The process for performing plural color broadband coherent anti-Stokes Raman scattering (CARS) microscopy of claim 17, wherein phase retrieval comprises a Kramers-Kronig analysis or a maximum entropy analysis, and
the process further comprises:
correcting phase error; and
performing spectral scaling.
